(19) United States
(12) Patent Application Publication
(10) Pub. No.: US 2013/0254308 A1
(43) Pub. Date: Sep. 26, 2013

(54) CONTENT PROVISION SYSTEM

(71) Applicants: Anthony Rose, London (GB); James Hewines, London (GB); David Blackall, London (GB); Fabian Birgfeld, London (GB); Marcus Box, London (GB); Alex Nunes, London (GB); Lars Eilebrecht, London (GB)

(72) Inventors: Anthony Rose, London (GB); James Hewines, London (GB); David Blackall, London (GB); Fabian Birgfeld, London (GB); Marcus Box, London (GB); Alex Nunes, London (GB); Lars Eilebrecht, London (GB)

(73) Assignee: BRITISH BROADCASTING CORPORATION, London (GB)

(21) Appl. No.: 13/695,265

(22) PCT Filed: Apr. 28, 2011
(86) PCT No.: PCT/GB2011/000654

§ 371 Date: Jun. 13, 2013

(30) Foreign Application Priority Data
Apr. 29, 2010 (GB) 1007191.8
May 25, 2010 (GB) 1008734.4

(51) Int. Cl. H04L 29/08

(52) U.S. Cl. CPC H04L 67/22
USPC 709/206

(57) ABSTRACT

This present invention relates to a system for providing users access to audio/visual content. The system comprises means for enabling a plurality of users to connect to the system, means for enabling users to browse available content items; means for receiving a message from at least one user connected to the system, and means for transmitting said message to at least one further user connected to the system. The system also provides means for enabling connected users to synchronise consumption of available content items.

The present invention relates to a system for providing users access to content. The invention also relates to a method of providing users access to content and to a graphical user interface. This invention also relates to a system for determining whether a content item should be provided to user equipment, and an associated method.

### Favourites

According to one aspect of the invention, there is provided system for providing users access to audio/visual content, the system comprising means for enabling a user to browse available content items; and means for enabling a user to add particular content items to a user defined content item list, wherein content items that are added to the user defined content item list are subsequently accessible by the user via said user content item list.

Preferably, the system further comprises means for adding a series of related content items to the content item list, whereby future content items in said series are available via the content item list. More preferably, the series adding means is adapted to add all content items in a group of related series items to the content item list. In this way, a user may be provided with access to all episodes in a current programme series, as well as episodes in any future series of the programme, and/or any one-off special editions of the programme.

Preferably, at least some of the available content items are in the form of on-demand content items.

Preferably, at least some of the on-demand content items are based on previously broadcast content items available for access within a fixed time period following the broadcast of said content items.

Preferably, at least some of the available content items are in the form of live broadcast content items.

Preferably, the system further comprises a streaming media system for streaming live and/or on-demand content to users.

Preferably, the system further comprises means for adding a series of related content items to the content item list, whereby future content items in said series are available via the content item list.

Preferably, the series adding means is adapted to add all content items in a group of related series items to the content item list.

Preferably, the system further comprises means for generating a graphic indicium representative of each content item provided in the list, whereby said content items are accessed by selecting said graphic indicium.

Preferably, the system further comprises means for accessing the content items directly from the content item list.

Preferably, the access means is adapted to enable a user to play the selected content item in a streamed fashion, and/or download the content item for later playing.

Preferably, the adding means is adapted to create a link to the content item when the content item is added to the content item list.

Preferably, the link is an active link that enables a user to access the content item directly from the content item list.

Preferably, the system further comprises means for removing content items from the content item list.

Preferably, the system further comprises means for generating a graphic indicium representative of a series of related content items contained within the content item list.

Preferably, the selection of said graphic indicium relating to a series of related content items provides access to all available content items within the series, and/or access to a latest content item in the series.

Preferably, the system is connectable to a communication network, and comprises a plurality of remote terminals thereby to enable users to browse available content items from a plurality of remote locations.

Preferably, the system comprises a website accessible via a communication network, such as the Internet, and wherein the website provides a user interface to enable users to browse available content items.

Preferably, the system further comprises means for storing the content item lists for each user centrally, thereby to enable each user to access their respective content item lists from different remote locations.

Preferably, the system further comprises means for storing, for each available content item, the identity of a user that has added that particular content item to that user's content item list. Preferably, the user identity is stored together with a content item. Preferably, the user identity is stored together with information relating to the content item. Preferably, the user identity is based on a user login and/or personalisation information relating to a user's terminal and/or PC, such as the user's IP address or an HTTP cookie.

Preferably, the system further comprises means for reconstituting a particular user's content item list by identifying those content items having the particular user's identity associated therewith.

Preferably, the system further comprises means for generating a graphical representation of the content item list for display to a user. Preferably, the generating means is adapted to display the content items in the form of a carousel.

Preferably, the means for enabling a user to browse available content items comprises a graphical user interface, and wherein the system further comprises means for generating a signal for displaying content items added to a user content item list within a specified location within the graphical user interface. Preferably, the location is in the form of window that is preferably accessible from all screens and/or pages provided by the graphical user interface. More preferably, the window is collapsible, and provided in the form of a toolbar widget in its collapsed state.

Preferably, the means for enabling a user to add content items to the content item list is adapted to add any available content items that are provided on the graphical user interface to the content item list.

Preferably, the system further comprises means for notifying a user that a particular content item within the list is about to expire.

Preferably, further comprising means for managing the content item list.

Preferably, the system further comprises means for notifying a user that new content items are available, for example, a latest episode in a series.

Preferably, the system further comprises means for adding recently played content items to the content item list.

Preferably, the system further comprises means for automatically arranging the content items in the content item list.

Preferably, the system further comprises means for removing unavailable and/or expired content items from the content item list without intervention from a user.

### Recommendations

According to another aspect of the invention, there is provided a system for providing users access to audio/visual content, the system comprising means for enabling a user to sign in to the system, means for receiving information relating to an available content item from a signed-in user, and means for storing the information relating to the content item for transmission to at least one other signed-in user.

According to a further aspect of the invention, there is provided a system as herein described, further comprising means for enabling a user to sign in to the system, means for receiving information relating to an available content item from a signed-in user, and means for storing the information relating to the content item for transmission to at least one other signed-in user.

Preferably, the system further comprises means for transmitting said information to at least one other signed-in user.

Preferably, the receiving means is adapted to receive a recommendation relating to a content item from a user. More preferably, the receiving means is adapted to receive a user comment relating to a content item from a user.

Preferably, the system further comprises means for prompting the user to input a comment relating to a content item upon receipt of a user recommendation for said content item.

Preferably, the system further comprises means for displaying a content indicium in respect of each available content item, together with a control indicium which provides a user with an option to recommend said content item.

### Social Recommendations

Preferably, the system is connectable to a communication network, such as the Internet, and further comprises an interface for connecting the system to at least one social networking site.

Preferably, the system further comprises means for identifying a signed-in user's user connections on a social networking site that are themselves also signed-in users thereby to create a social network on the system for the signed-in user.

Preferably, the system further comprises means for broadcasting information relating to content items received from a signed-in user to all other users in said user's system social network.

Preferably, the social networking site includes at least one or more of the following social networking sites: Facebook; Bebo; and twitter.

### Display of Recommendations

Preferably, the system further comprises means for displaying to a signed-in user information relating to content items received from other signed-in users. Preferably, the information is displayed adjacent to an available content item. Preferably, the information is displayed together with an identity of the user from which said information was received.

Preferably, the system comprises a graphical user interface, and wherein the display means is adapted to display the information relating to content items received from other signed-in users within a predefined location within the graphical user interface.

### Messaging

According to another aspect of the invention, there is provided a system as herein described, further comprising means for enabling a plurality of users to connect to the system, means for receiving a message from at least one user connected to the system, and means for transmitting said message to at least one further user connected to the system.

According to a further aspect of the invention, there is provided a system for providing users access to audio/visual content, the system comprising means for enabling a plurality of users to connect to the system, (optionally) means for enabling users to browse available content items; means for receiving a message from at least one user connected to the system; and means for transmitting said message to at least one further user connected to the system.

According to another aspect of the invention, there is provided a system as herein described, further comprising means for enabling users to synchronise consumption of available content items.

According to a further aspect of the invention, there is provided a system for providing users access to audio/visual content, the system comprising means for enabling a plurality of users to connect to the system; (optionally) means for enabling users to browse available content items; and means for enabling connected users to synchronise consumption of available content items.

Preferably, the system further comprises means for enabling users to consume at least certain of the available content items in an on-demand fashion. In this way a synchronised video-on-demand (VOD) system can be provided.

Preferably, the system further comprises means for enabling a connected user to send a synchronisation invitation to one or more other connected users to consume a particular content item.

Preferably, the system further comprises means for enabling a user to request access to a particular content item, and more preferably a particular location within said content item.

Preferably, the system is connectable to a communications network, such as the Internet, and wherein each of the users are connectable to the system via user terminal equipment connectable to said communications network.

Preferably, the terminal equipment is in the form of at least one of the following devices: a personal computer; an Internet television; a laptop; a PDA; a tablet computing device; and a mobile telephone.

Preferably, the means for enabling users to browse available content items includes a website accessible via the Internet.

Preferably, the system further comprises a signing in module, thereby to enable users to sign in to the system.

Preferably, the system further comprises means for connecting at least two users to one another thereby to form at least one user group.

Preferably, the connecting means is adapted to connect a new user to one or more existing user groups.

Preferably, the system further comprises means for enabling a user to connect to at least one other user thereby to form a user group.

Preferably, the system further comprises means for enabling a user to invite other users to sign in to the system.

Preferably, the system further comprises means for enabling a user to transmit a message to a particular user and/or to all the users within one or more user groups.

Preferably, the system further comprises means for enabling a user to broadcast a message to a plurality of users.

Preferably, the receiving means is adapted to receive text-based messages.

Preferably, the system comprises an instant messaging module, preferably in the form of MSN Messenger or Windows Live Messenger, which is adapted to handle the receipt and transmission of instant messages between users.

Preferably, the system further comprises a media player for enabling users to consume audio/visual content items.

Preferably, the system further comprises means for publishing information relating to a content item that has been consumed and/or accessed by a user to one or more other users.

Preferably, the publishing means is adapted to publish information relating to a content item that is presently being consumed by a user to one or more other users. In this way a user may be able to see what content items are currently being watched by other users in the user's user group.

Preferably, said information is only made available to a restricted set of users.

Preferably, said information is only made available to other users within a user's user group or groups, and preferably only to selected users within said group or groups.

Preferably, said information includes the title of the content item.

Preferably, said information provides an indication of a user's progress though said content item.

Preferably, said information provides a link to said content item. More preferably, the information includes an index to a user's present location within the content item. In this way a user may be able to access more easily the content items being consumed by other users within the user's user groups.

Preferably, the system further comprises means for streaming available content items to users. More preferably, the streaming means is adapted to stream on demand and/or live-broadcast content.

In the case of an on demand content item the system provides a link to each user's current position within the content item being consumed by that user, so as to enable another user to join the user at that same point within the content item. In the case of live-broadcast content items, the system switches the joining user's media player to the live-broadcast content item currently being watched by the user.

Preferably, the system further comprises means for enabling one or more other users to access said content item being consumed by said user via said link. In this way users may be able to synchronise their consumption of a particular content item.

Preferably, the system further comprises means for streaming a particular content item to at least two users at a time specified by those users, thereby to enable synchronised viewing of a particular content item.

Preferably, the system further comprises means for transmitting, together with each user message, information relating a content item currently being consumed by that user. In this way a user may be able to invite one or more other users to consume content items together with said user.

Preferably, the information includes a link to said content item.

Preferably, the information includes an index to a user's present location within the content item.

Preferably, the system further comprises a graphical user interface for displaying available content items, and means for generating a display window for displaying to a user one or more user groups to which said user is connected.

Preferably, the generating means is adapted to display the window on all screens or pages of the graphical user interface, and preferably alongside a media player window.

Preferably, the generating means is adapted to generate a display which includes a list, preferably in graphical form, of all the users within a user's user group.

Preferably, the generating means is adapted to generate a display which includes information relating to the content item currently being consumed by each user.

Preferably, the information includes at least one of the following: the title of the content item; a programme identifier for the content item; a link to the content item; user comments relating to the content item; and a progress bar indicating a user's progress though the content item.

Preferably, the generating means is adapted to generate a graphical indication, preferably in the form of a selectable button, which provides a link to the content item currently being consumed. More preferably, the selectable button provides an index to a user's present location within the content item.

Preferably, the generating means is adapted to generate a display which includes the messages transmitted by each user in the displayed user group.

### Category Module

According to a further aspect of the invention, there is provided a system for providing users access to audio/visual content, the system comprising means for enabling a user to browse available content items, means for generating an output representing a display window for displaying a set of categories thereby enabling a user to access said content items via said categories, and means for enabling a user to select one or more categories from the set of categories for inclusion in a user defined category display window, thereby to create a customised category display.

According to a further aspect of the invention, there is provided a system herein described, further comprising means for enabling a user to browse available content items, means for generating an output representing a display window for displaying a set of categories thereby enabling a user to access said content items via said categories, and means for enabling a user to select one or more categories from the set of categories for inclusion in a user defined category display window, thereby to create a customised category display.

### Console

Preferably, the system further comprises a satellite or pop-out media player for playing media content items, and means for providing a user access to at least some of the functionality of the system directly from the satellite media player.

Preferably, the system further comprises means for generating on the satellite player a set of graphic indicia for enabling a user to access said system functionality, and wherein the size and placement of said graphic indicia is optimised to take up as little display area as is possible.

Live and on-Demand TV/Radio Channels

According to a further aspect of the invention, there is provided a system for providing a user with access to content items, the system comprising: means for generating a graphical element, preferably associated with a content provider; means for generating an array of graphical elements, preferably associated with content items provided by the content provider; means for receiving input from the user representing selection of a graphical element; and means for updating the array of graphical elements in dependence on the selection of a graphical element; wherein at least one position within the array represents an available content item first available in the past, and at least one position within the array represents an available content item not first available in the past.

According to a yet further aspect of the invention, there is provided a graphical user interface for providing a user with access to content items, the interface comprising: means for generating a graphical element, preferably associated with a content provider; means for generating an array of graphical elements, preferably associated with content items provided by the content provider; means for receiving input from the user representing selection of a graphical element; and means for updating the array of graphical elements in dependence on the selection of a graphical element; wherein at least one position within the array represents an available content item first available in the past, and at least one position within the array represents an available content item not first available in the past.

Preferably, the means for generating the array of graphical elements is further adapted to arrange the array of graphical elements such that the position of a graphical element within the array represents the time of first availability of the associated content item.

Preferably, the means for generating the array of graphical elements is adapted to generate a subset of the array of graphical elements.

Preferably, the subset of the array of graphical elements comprises graphical elements associated with content items first available today.

Preferably, the subset of the array of graphical elements comprises graphical elements associated with content items first available on a day preceding today.

Preferably, the subset of the array of graphical elements comprises graphical elements associated with content items first available on a day following today.

Preferably, the subset of the array of graphical elements comprises graphical elements associated with content items first available during part of a day.

Preferably, the system further comprises means for generating a further graphical element associated with a presently available content item in dependence on the selection of a graphical element.

Preferably, the system further comprises means for providing access to a content item in dependence on the selection of a graphical element.

### Customisable EPG

Preferably, this system further comprises: means for receiving input from the user representing a customisation request; means for generating a content provider identifier in dependence on the customisation request received from the user; and wherein the means for generating a graphical element is adapted to generate a graphical element in dependence on a content provider identifier.

According to a yet further aspect of the invention, there is provided a graphical user interface implementing the system as herein described, further comprising: means for receiving input from the user representing a customisation request; means for generating a content provider identifier in dependence on the customisation request received from the user; and wherein the means for generating a graphical element is adapted to generate a graphical element in dependence on a content provider identifier.

Preferably, the customisation request received from the user comprises a geographical location identifier.

Preferably, the means for generating a content provider identifier is adapted to delete a content provider identifier set in dependence on the customisation request received from the user.

Preferably, the means for generating a graphical element is adapted to arrange the generated graphical element in dependence on the customisation request received from the user.

### Channel Changer

According to a further aspect of the invention, there is provided a system for providing a user with access to a media content stream, the system comprising: means for streaming media content to the user; means for generating a plurality of graphical elements, each graphical element associated with a media content stream; and means for receiving input from the user representing first and second selection modes of the graphical elements; wherein i) for a first selection mode, the generating means is adapted to generate information relating to the media content stream associated with said selected graphical element; and ii) for a second selection mode, the streaming means is adapted to stream the media content associated with said selected graphical element to the user.

Preferably, the information further includes information relating to a subsequent media content stream associated with said selected graphical element. Preferably, the first selection mode comprises the user indicating a graphical element. Preferably, the second selection mode comprises the user activating a graphical element.

According to a further aspect of the present invention, there is provided a graphical user interface for providing a user with access to content items, the interface comprising: means for generating a graphical element, preferably associated with a content provider; means for generating an array of graphical elements, preferably associated with content items provided by the content provider; means for receiving input from the user representing selection of a graphical element; and means for updating the array of graphical elements in dependence on the selection of a graphical element; wherein at least one position within the array represents an available content item first available in the past, and at least one position within the array represents an available content item not first available in the past.

### Drawers 1

According to another aspect of the invention, there is provided a graphical user interface for providing a user with access to content, the interface comprising: means for generating output representing a content selection region comprising a plurality of content panes (e.g. so called ‘drawers’), each content pane being configured for displaying at least one content indicium representing a respective item of content; means for detecting selection of a content pane by a user; and means for expanding or contracting the selected content pane, in response to the selection, whilst respectively contracting or expanding at least one other content pane, whereby when the selected content pane expands it expands into an area of the content selection region made available by contraction of the at least one other content pane, and when the selected content pane contracts the at least one other content pane expands into an area of the content selection region made available by contraction of the selected content pane.

Beneficially, this harmonious contraction and expansion of the different content panes, potentially allows a greater number of content items to be represented in a smaller area of screen real estate than would otherwise be the case. The harmonious contraction and expansion also allows a greater number of content panes (each possibly representing content items selected based on a different respective content selection criteria) to be represented in a smaller area of screen real estate than would otherwise be the case. Advantageously, therefore, the content selection region occupies substantially the same size area of a display after the expansion or contraction as before the expansion or contraction.

Each content pane may be provided with an open state in which the content pane is maximally expanded, a closed state in which the content pane is maximally contracted, and possibly an intermediate state in which the content pane is partially expanded. In accordance with this, the means for expanding or contracting the selected content pane may be operable to expand the selected content pane to the open state when the selected content pane is selected in the closed state or the intermediate state and/or may be operable to contract the selected content pane to the intermediate state when the selected content pane is selected in the open state. Similarly, means for expanding or contracting the selected content pane may be operable to contract the at least one other content pane to the closed state when the selected content pane is selected in the closed state or the intermediate state and/or may be operable to expand the at least one other content pane to the intermediate state from the closed state when the selected content pane is selected in the open state.

Advantageously, the provision of the intermediate state (or states) potentially allows a user to have a ‘snapshot’ of the content in an associated drawer without it being fully open (e.g. in an analogous manner to a physical chest of draws in which a draw can be opened partially to see the type of things that are in it before the draw is fully opened to reveal more).

Each content pane may be configured for displaying content indicia representing items of content from an associated content subset. The output generating means may be operable to generate output representing a navigation indicium for each content pane for use by the user to navigate the items of content in the associated content subset. The graphical user interface may further comprise means for detecting utilisation of the navigation indicium, by the user, and for navigating the items of content accordingly.

Each content pane may be configured for displaying the content indicia in a sequence of pages. The navigation indicium may be configured for use by the user to navigate to an undisplayed page in the sequence of pages and/or may be configured for use by a user to navigate to the next page in the sequence of the pages or to the previous page in the sequence of the pages and/or may be configured for use by a user to navigate directly to a page which is not the next page or the previous page in the sequence of the pages.

The output generating means may by operable to generate output representing the navigation indicium for a content pane when the content subset associated with that content pane includes at least one item of content for which a content indicium is not already being displayed. The output generating means may be operable not to generate output representing the navigation indicium for a content pane when content indicia for every item of content (or possibly a predetermined proportion of all the content items) in the content subset associated with that content pane is already being displayed. The output generating means may be operable to generate output representing the navigation indicium for a content pane when that content pane is in the open state. The output generating means may be operable not to generate output representing the navigation indicium for a content pane when that content pane is in the intermediate state or the closed state.

The provision of the navigation indicium, as appropriate, according to circumstances, potentially allows a user to be able to see substantially instantaneously whether or not there are additional content items in the content subset to which the content pane being viewed relates. Where the navigation indicium is only displayed when the pane is open this helps to avoid the potential confusion that might arise if the navigation indicium was simultaneously displayed for different drawers.

The output generating means may be operable to attempt to generate output representing a first of the content panes substantially independently of an attempt to generate output representing another of the content panes, whereby, for example, if the attempt to generate output representing the first of the content panes is unsuccessful, the attempt to generate output representing the other of the content panes may be substantially unaffected.

The output generating means may be operable to attempt to generate output representing a first of the content panes in harmony with an attempt to generate output representing another of the content panes, whereby, for example, if the attempt to generate output representing the first of the content panes is unsuccessful and the attempt to generate output representing the other of the content panes is successful, the output generating means may be operable to initiate expansion of the other of the content panes into an area of the content selection region which would otherwise be occupied by the first of the content panes.

The output generating means may be operable to generate output representing content indicia in each content pane, which content indicia represent items of content from a content subset associated with the content pane. Each content item in a respective content subset may be selected expressly for the user, a group of users, and/or all users, based on a popularity of the content item with other users, based on a recommendation of the content item by at least one other user, based on a usage history associated with the user, or with apparatus being used by the user to access the graphical user interface, and/or based on a decision to promote the item to all users (or a predefined group of users) of the graphical user interface.

### Overall UI Configuration 1

The output generating means may be further operable to generate output representing one or more of the following: a content guide region comprising, for example, at least one channel indicium representing a respective channel associated with a particular content subset for use by the user to browse to at least one content indicium representing an item of content associated with the respective channel; and/or a content browser region comprising, for example, at least one category indicium representing a respective category of content for use by the user to browse to at least one content indicium representing an item of content in the respective category.

### Drawers 2

The graphical user interface may further comprise: means for determining if predetermined information relating to the user is available; wherein the output generating means may be operable: (i) to generate output representing a first content pane arrangement comprising at least one content pane when the predetermined information relating to the user is determined to be unavailable; and (ii) to generate output representing a second content pane arrangement comprising a plurality of content panes when the predetermined information relating to the user is determined to be available; wherein the second arrangement may include each content pane of the first arrangement and at least one further content pane.

According to an aspect of the invention there is provided a graphical user interface for providing a user with access to content, the interface comprising: means for generating output representing a content selection region comprising a plurality of content panes to the user, each content pane being configured for displaying at least one content indicium representing a respective item of content; and means for determining if predetermined information relating to the user is available; wherein the output generating means is operable: (i) to generate output representing a first content pane arrangement comprising at least one content pane when the predetermined information relating to the user is determined to be unavailable; and (ii) to generate output representing a second content pane arrangement comprising a plurality of content panes when the predetermined information relating to the user is determined to be available; wherein the second arrangement includes each content pane of the first arrangement and at least one further content pane.

Providing additional drawers of content to a user who has previously used the user interface beneficially has the potential to allow a tailored content selection to be provided to the user (e.g. based on their prior use or on recommendations made by their friends) in a relatively clear manner, without significantly compromising the clarity with which general content items selected for all users are presented.

The predetermined information relating to the user may comprise information stored in a file (for example a cookie) stored on a storage device of apparatus used by the user to access the graphical user interface. The predetermined information relating to the user may comprise registration information for the user.

The graphical user interface may comprise means for receiving log-in information from the user and the determining means may be operable to determine if the registration information is available based on the log-in information entered by the user.

The at least one further content pane may comprise a content pane for displaying at least one content indicium representing an item of content from a user related content subset, which user related content subset may comprise content items selected in dependence on the user to which the predetermined information relates.

The user related content subset may comprise content items selected in dependence on a content history, which content history may identify content items previously accessed by the user to which the predetermined information relates. The content items selected in dependence on a content history may comprise at least one content item selected in dependence on at least one of: a content category (for example, children's, comedy, drama, entertainment, factual, films, lifestyle, music, news, religion/ethics, sport, special interest or the like) associated with a content item previously accessed by the user; a genre associated with a content item previously accessed by the user; a media channel associated with a content item previously accessed by the user; a content series (for example, a series of episodes) associated with a content item (for example, an episode from the series) previously accessed by the user; and/or a content type (for example, film, television, radio, music, or the like) associated with a content item previously accessed by the user.

The user related content subset may comprise content items selected in dependence on a geographical location associated with the user to which the predetermined information relates. The user related content subset may comprise content items selected in dependence on an interest area or genre chosen by the user to which the predetermined information relates.

The at least one further content pane may comprise a content pane for displaying at least one content indicium representing an item of content from a user recommended content subset, which user recommended content subset may comprise content items recommended by other users of the graphical user interface.

The first content pane arrangement may comprise a content pane for displaying at least one content indicium representing an item of content from a popular content subset, which popular content subset may comprise content items selected in dependence on their popularity with other users.

The first content pane arrangement may comprise a content pane comprising at least one content indicium representing an item of content from a featured content subset, which featured content subset may comprise content items selected for promotion to users of the graphical user interface.

### Overlays

The graphical user interface may further comprise: means for detecting movement of a pointer, relative to the graphical user interface, over the at least one content indicium; wherein the output generating means may be operable to generate output, potentially in response to detecting the movement of a pointer over the at least one content indicium, representing a plurality of control indicia, each control indicium potentially representing a respective option for handling the item of content represented by the content indicium over which the pointer has moved.

According to an aspect of the invention there is provided a graphical user interface for providing a user with access to content, the interface comprising: means for generating output representing at least one content indicium representing an item of content; and means for detecting movement of a pointer, relative to the graphical user interface, over the at least one content indicium; wherein the output generating means is operable to generate output, in response to detecting the movement of a pointer over the at least one content indicium, representing a plurality of control indicia, each control indicium representing a respective option for handling the item of content represented by the content indicium over which the pointer has moved.

Providing options (e.g. play, download, recommend, favourite) when a user ‘hovers’ over a content indicium beneficially allows users the possibility of navigating to a desired control option for any of the potentially many content items represented in their display relatively easily and without an over-proliferation of control options for the many items of content potentially being represented in a relatively small area of screen real estate.

The options may include at least one of: an option for playing the content; an option for adding the content to a list of favourites; on option for recommending the content; and/or an option for downloading the content.

The output generating means may be configured for modifying the control indicium displayed for at least one of the options, preferably in dependence on whether the at least one option has previously been used by the user for handling the item of content represented by the content indicium over which the pointer has moved.

The output generating means may be configured for modifying the control indicium displayed for at least one of the options, preferably in dependence on whether the at least one option is available for the item of content represented by the content indicium over which the pointer has moved.

The output generating means may be configured for modifying the control indicium displayed for at least one of the options, preferably in dependence on the size of the content indicium over which the pointer has moved.

The detecting means may be operable to detect movement of the pointer, relative to the graphical user interface, over the at least one control indicium.

The output generating means may be configured for modifying the control indicium displayed for the at least one option, preferably on the detection of movement of the pointer over the control indicium for the at least one option.

### Overall UI Configuration 2

The means for generating output representing at least one content indicium representing an item of content may be operable to generate output representing at least one of the following: a content selection region preferably comprising a plurality of content panes, each content pane preferably being configured for displaying at least one content indicium representing a respective item of content expressly selected for recommendation/promotion to the user, a group of users and/or all users; a content guide region preferably comprising at least one channel indicium preferably representing a respective channel associated with a particular content subset for use by the user to browse to at least one content indicium representing an item of content associated with the respective channel; and/or a content browser region preferably comprising at least one category indicium preferably representing a respective category of content for use by the user to browse to at least one content indicium representing an item of content in the respective category.

### Other Related Aspects

According to an aspect of the invention there is provided a method for providing a user with access to content, the method comprising: generating output representing a content selection region comprising a plurality of content panes, each content pane being configured for displaying at least one content indicium representing a respective item of content; detecting selection of a content pane by a user; and expanding or contracting the selected content pane, in response to the selection, whilst respectively contracting or expanding at least one other content pane, whereby when the selected content pane expands it expands into an area of the content selection region made available by contraction of the at least one other content pane, and when the selected content pane contracts the at least one other content pane expands into an area of the content selection region made available by contraction of the selected content pane.

According to an aspect of the invention there is provided a system for providing a user with access to content, the interface comprising: means for generating output representing a content selection region comprising a plurality of content panes, each content pane being configured for displaying at least one content indicium representing a respective item of content; means for detecting selection of a content pane by a user; and means for expanding or contracting the selected content pane, in response to the selection, whilst respectively contracting or expanding at least one other content pane, whereby when the selected content pane expands it expands into an area of the content selection region made available by contraction of the at least one other content pane, and when the selected content pane contracts the at least one other content pane expands into an area of the content selection region made available by contraction of the selected content pane.

A system for providing a user with access to content, the system comprising: means for generating output representing a content selection region comprising a plurality of content panes to the user, each content pane being configured for displaying at least one content indicium representing a respective item of content; and means for determining if predetermined information relating to the user is available; wherein the output generating means is operable: (i) to generate output representing a first content pane arrangement comprising at least one content pane when said predetermined information relating to the user is determined to be unavailable; and (ii) to generate output representing a second content pane arrangement comprising a plurality of content panes when said predetermined information relating to the user is determined to be available; wherein the second arrangement includes each content pane of the first arrangement and at least one further content pane.

A method of providing a user with access to content, the method comprising: generating output representing a content selection region comprising a plurality of content panes to the user, each content pane being configured for displaying at least one content indicium representing a respective item of content; and determining if predetermined information relating to the user is available; wherein the output generating step comprises: (i) generating output representing a first content pane arrangement comprising at least one content pane when said predetermined information relating to the user is determined to be unavailable; and (ii) generating output representing a second content pane arrangement comprising a plurality of content panes when said predetermined information relating to the user is determined to be available; wherein the second arrangement includes each content pane of the first arrangement and at least one further content pane.

According to another aspect of the invention, there is provided a system for providing a user with access to content, the system comprising: means for generating output representing at least one content indicium representing an item of content; and means for detecting movement of a pointer, relative to said graphical user interface, over said at least one content indicium; wherein the output generating means is operable to generate output, in response to detecting said movement of a pointer over said at least one content indicium, representing a plurality of control indicia, each control indicium representing a respective option for handling the item of content represented by the content indicium over which said pointer has moved.

According to a further aspect of the invention, there is provided a method of providing a user with access to content, the method comprising: generating output representing at least one content indicium representing an item of content; and detecting movement of a pointer, relative to said graphical user interface, over said at least one content indicium; wherein the output generating step comprises generating output, in response to detecting said movement of a pointer over said at least one content indicium, representing a plurality of control indicia, each control indicium representing a respective option for handling the item of content represented by the content indicium over which said pointer has moved.

### Pre-Booking Traffic Management

According to yet a further aspect of the invention, there is provided a system for determining whether a content item should be provided to user equipment, the system comprising: means for receiving, at a time and/or date, a download request from the user equipment to download the content item; means for determining if the download request is to be allowed or denied in dependence on a traffic management requirement for the time and/or date at which the download request is received; and means for providing, to the user equipment, information identifying a download location of the content item when it is determined that the download request is to be allowed.

The determining means may be operable to determine a transmission time and/or date for the content item at which the content item is to be (or has been) transmitted.

The providing means may be operable to provide, to the user equipment, information identifying a download location of the content item preferably if the time and/or date at which the download request is received is within a predetermined time period (for example, a ‘grace’ period) prior to the transmission time and/or date.

The predetermined time period may be reconfigurable and, may be stored in at least one of a key-value store, a database, and/or the like, and may be configured with a default value (e.g. three hours).

The providing means may be operable to provide, to the user equipment, information identifying a download location of the content item preferably if the time and/or date at which the download request is received is at or after the transmission time and/or date.

The system may further comprise means for receiving a request to play the content item (which may be a request for an appropriate licence to allow the item to be played) from the user equipment, and may comprise means for issuing a licence for playing the content item, to the user equipment, preferably if the time and/or date at which the request to play the content item is received is after (for example a predetermined period such as a duration of the content item after) the transmission time and/or date.

The providing means may be operable to provide information indicating that the download request has been denied preferably when it is determined that the download request is to be denied. The information indicating that the download request has been denied may comprise an indicator that the download request has been denied as the result of limited bandwidth availability. The information indicating that the download request has been denied may comprise information indicating a time and/or date for the user equipment to retry requesting download of the content item. The information indicating a time and/or date for the user equipment to retry requesting download of the content item may comprise a time stamp (for example, an ISO 8601 timestamp). The time stamp may indicate a standardised time and/or date (for example, a standardised time and/or date based on Universal Coordinated Time (UTC)). The time and/or date for the user equipment to retry requesting download of the content item may be at a pre-determined minimum time period (or time ‘offset’) after the time and/or date of the download request. The pre-determined minimum time period may be stored in at least one of a key-value store, a database, and/or the like, and may be configured with a default value (e.g. 60 minutes), and may be limited to a minimum value (e.g. 5 minutes). The time and/or date for the user equipment to retry requesting download of the content item may be a time at which download is potentially allowable based on the traffic management requirement for the time and/or date for the user equipment to retry requesting download.

The traffic management requirement may be determined for a predetermined granularity period including the time and/or date at which the download request is received. The predetermined granularity period may remain substantially the same period (e.g. 15 minutes) regardless of the time and/or date at which the download request is received. The predetermined granularity period may vary (e.g. between 5 minutes and 30 minutes) in dependence on the time and/or date at which the download request is received.

The traffic management requirement for the time and/or date may be represented by a weighting factor for the time and/or date at which the download request is received. The weighting factors for various time and/or dates may be stored in at least one of a dedicated document, a value in a key-value store, a database, and/or the like. The weighting factors for various time and/or dates may be calculated using a predetermined algorithm for determining them in dependence on demand at a particular time and/or date to which the respective weighting factor relates. The determining means may be operable to determine that the download request should be denied if the weighting factor is equal to a predetermined number (for example zero, a number greater than 100, any number not in a predetermined range representing a traffic management requirement at which the download is potentially allowable, or the like).

The determining means may be operable to generate a random (or pseudo-random) number (for example, between 1 and 100), may be operable to determine that the download request should be allowed if the random (or pseudo-random) number does not exceed the weighting factor, and/may be operable to determine that the download request should be denied if the random (or pseudo-random) number exceeds the weighting factor.

The weighting factor may comprise a percentage value, which value may indicate a likelihood that a download request will succeed. The determining means may be operable to determine if the download request is to be allowed or denied based on a traffic management formula.

The determining means may be operable to determine if the download request is valid or invalid, and the providing means may be operable to provide information to the user equipment indicating that an error condition has arisen if the download request is determined to be invalid.

The determining means may be operable to determine if the requested content item is available or unavailable, and the providing means may be operable to provide information to the user equipment indicating that an error condition has arisen if the requested content item is determined to be unavailable.

According to a further aspect of the invention, there is provided a method of determining whether a content item should be provided to user equipment, the method comprising: receiving, at a time and/or date, a download request from the user equipment to download the content item; determining if the download request is to be allowed or denied in dependence on a traffic management requirement for the time and/or date at which the download request is received; and providing, to the user equipment, information identifying a download location of the content item when it is determined that the download request is to be allowed.

Further features of the invention are characterised by the dependent claims.

The invention extends to methods and/or apparatus substantially as herein described with reference to the accompanying drawings.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

Furthermore, features implemented in hardware may generally be implemented in software, and vice versa. Any reference to software and hardware features herein should be construed accordingly.

These and other aspects of the present invention will become apparent from the following exemplary embodiments that are described with reference to the following figures in which:

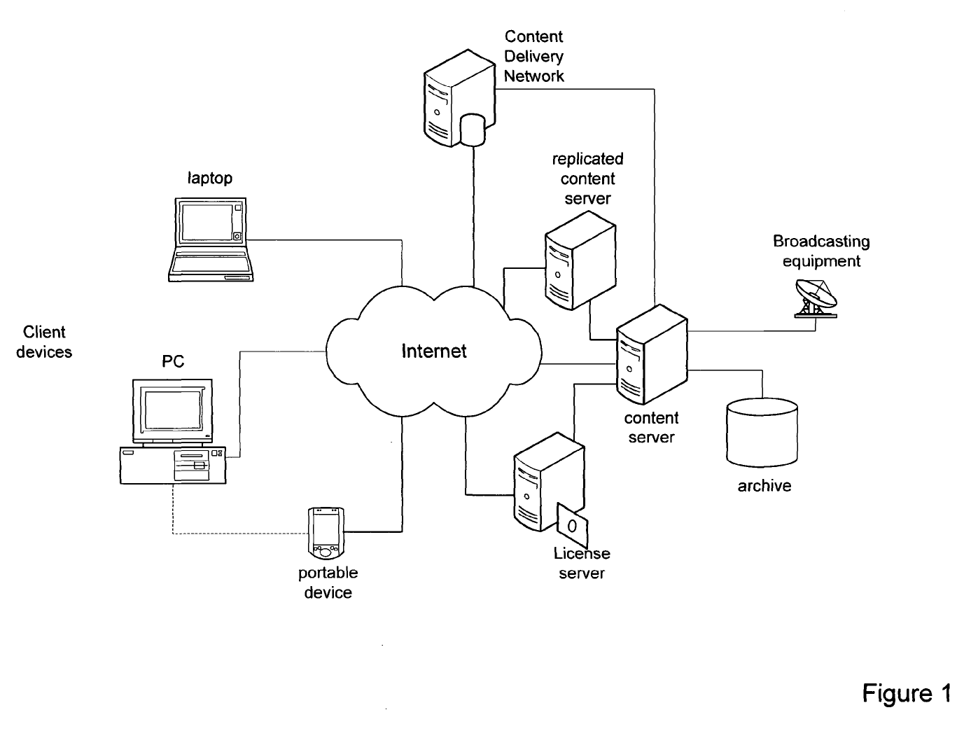

FIG. 1 shows a general overview of a content provision system in the form of an interactive media player system;

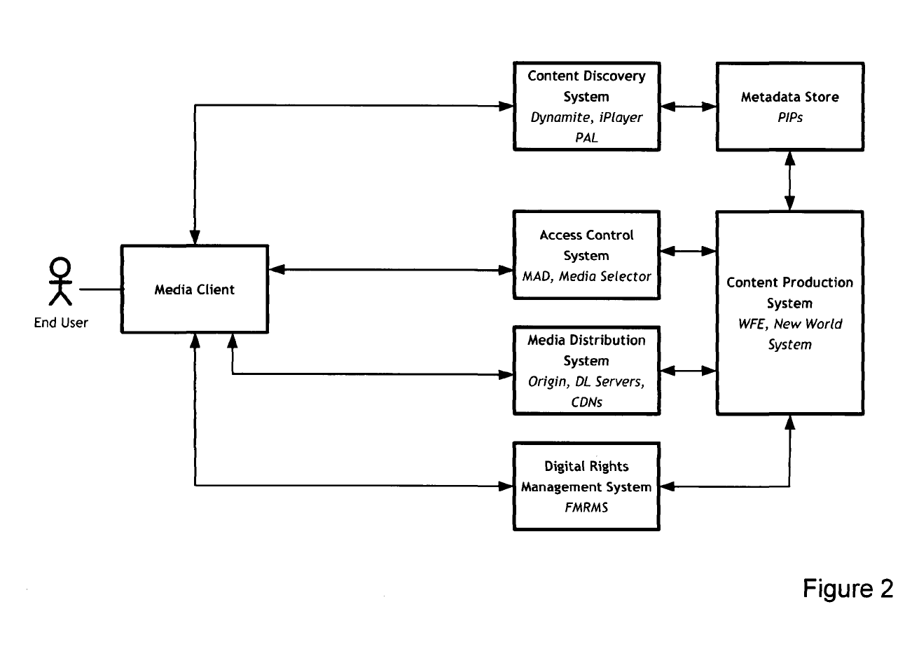

FIG. 2 shows an overview of a user interacting with the media player system;

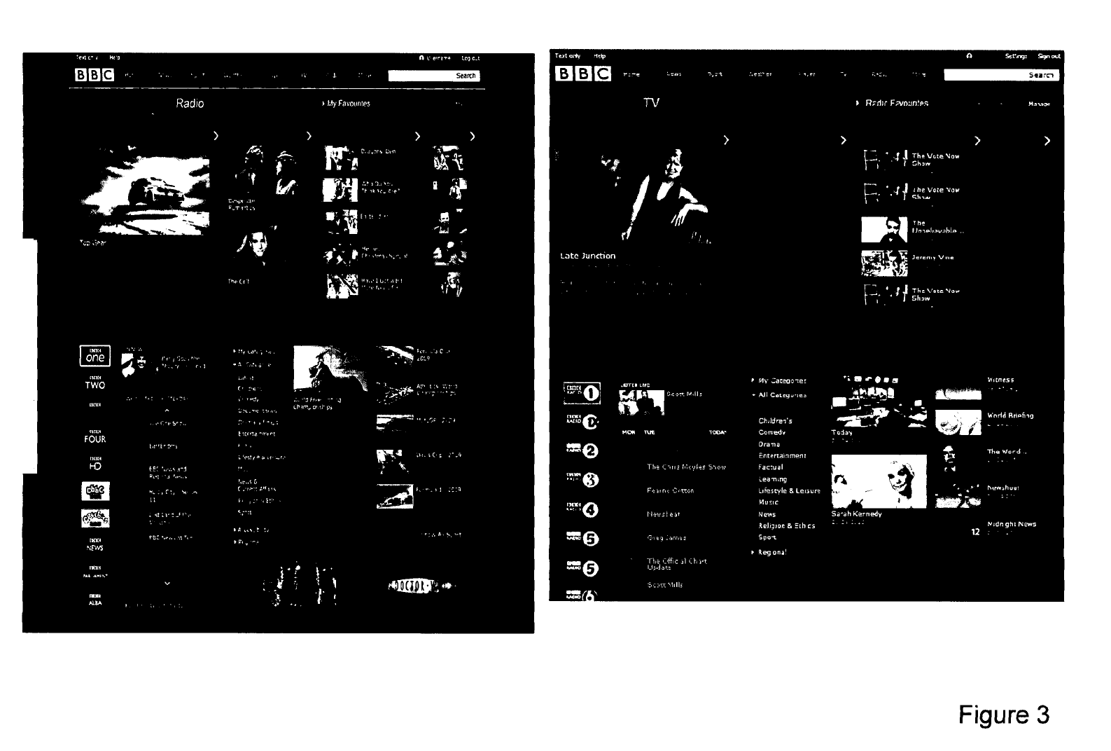

FIG. 3 shows the main user interface of the media player system;

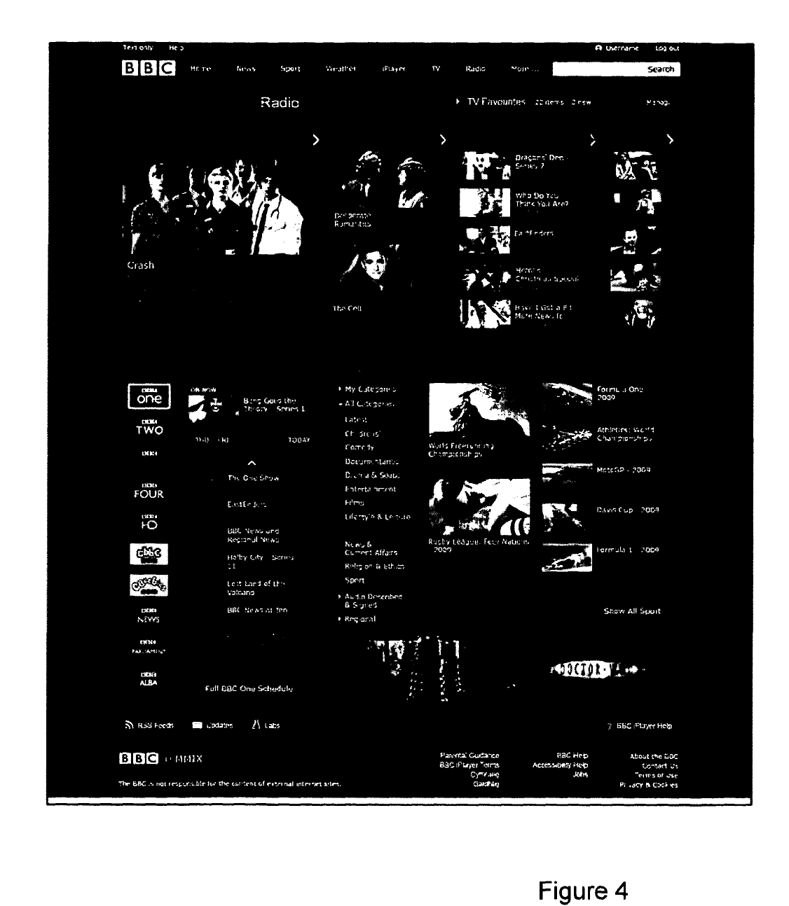

FIG. 4 shows another view of the main user interface;

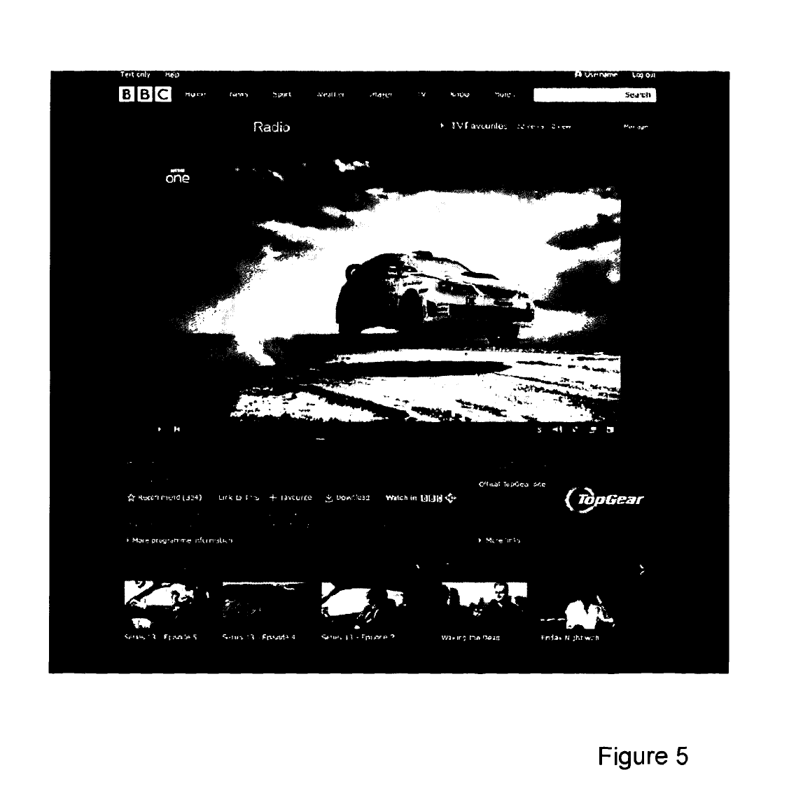

FIG. 5 shows the item page of the user interface;

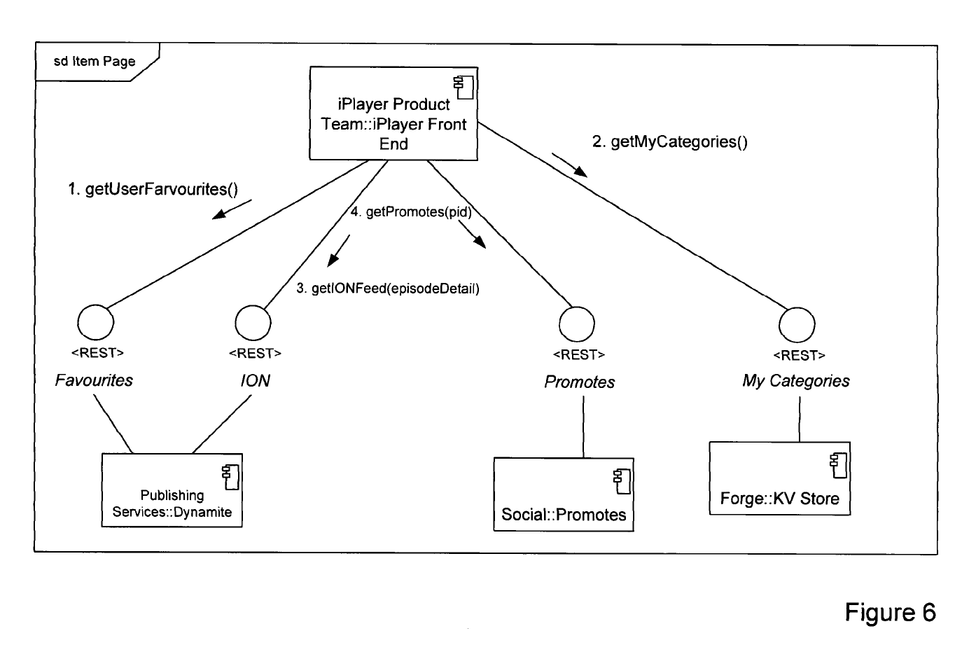

FIG. 6 shows the components involved in generating the item page;

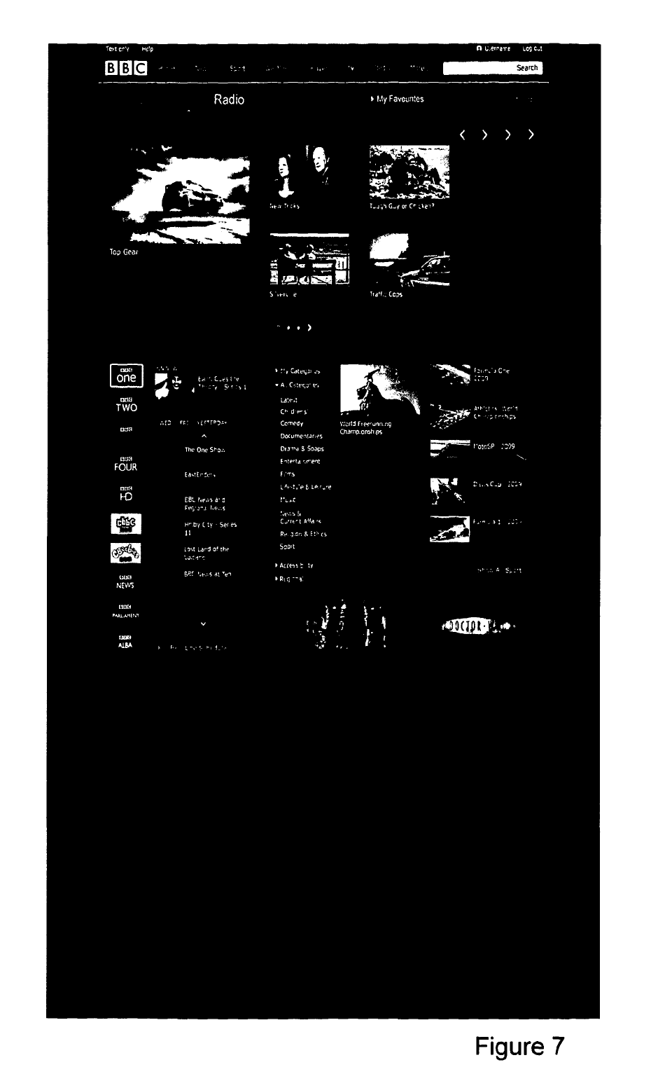

FIG. 7 shows the drawer elements (and specifically the ‘Featured’ drawer) of the user interface;

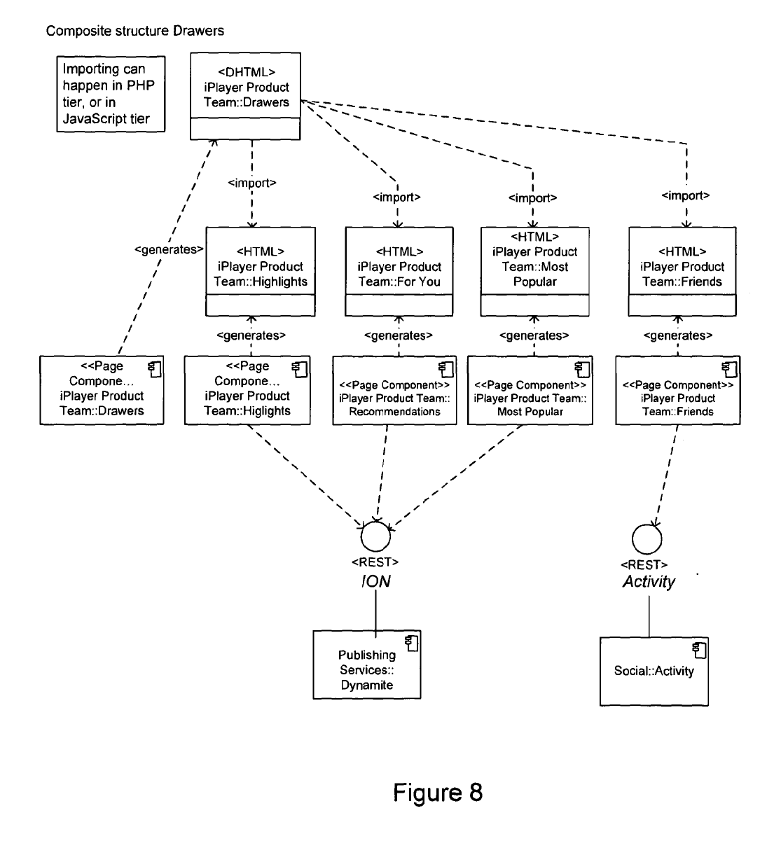

FIG. 8 shows the components involved in generating the drawer elements;

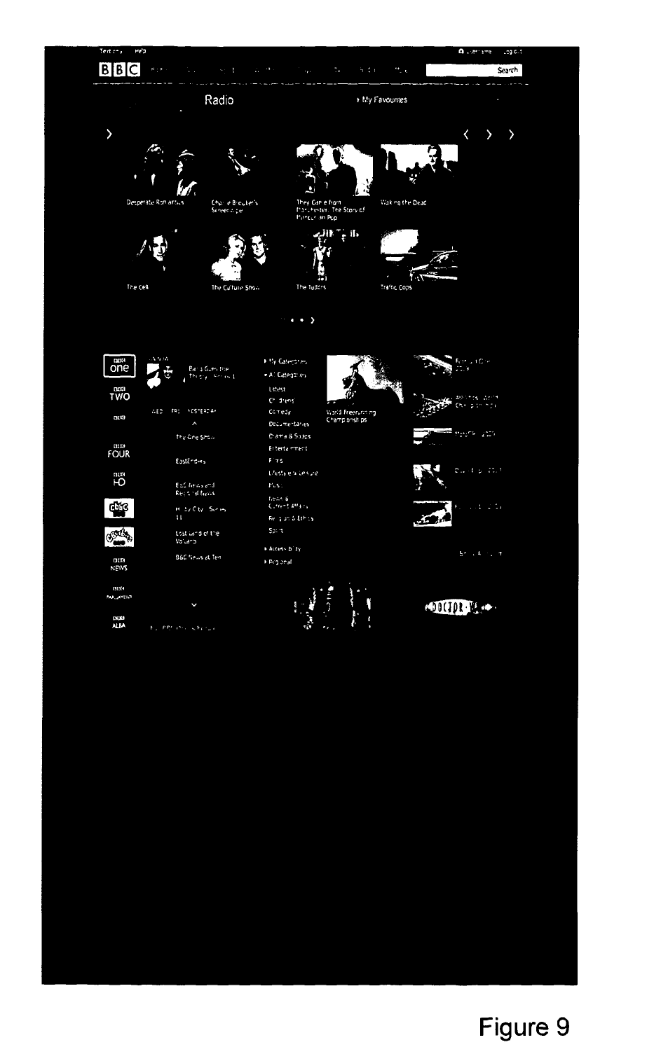

FIG. 9 shows the ‘For You’ drawer of the user interface;

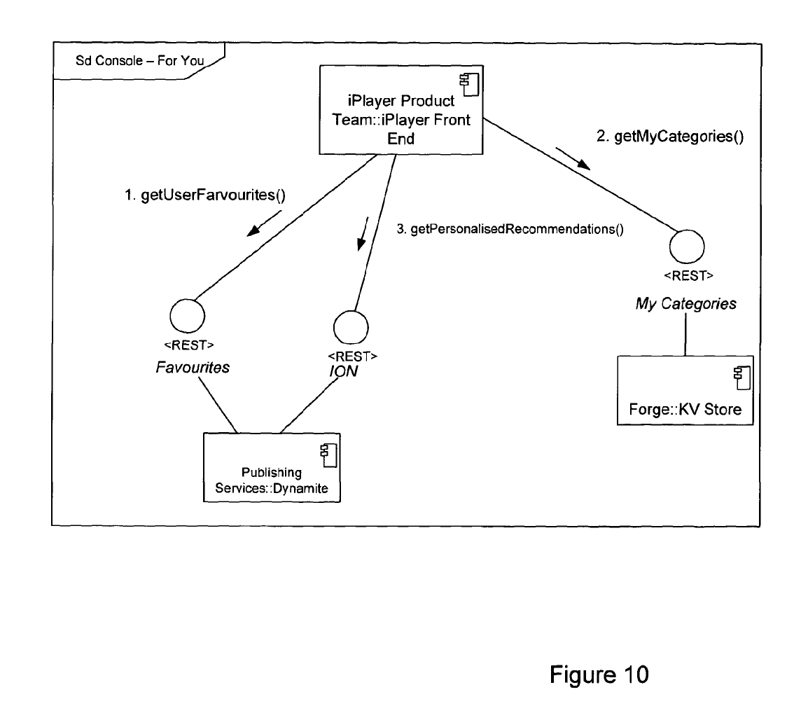

FIG. 10 shows the components involved in generating the ‘For You’ drawer;

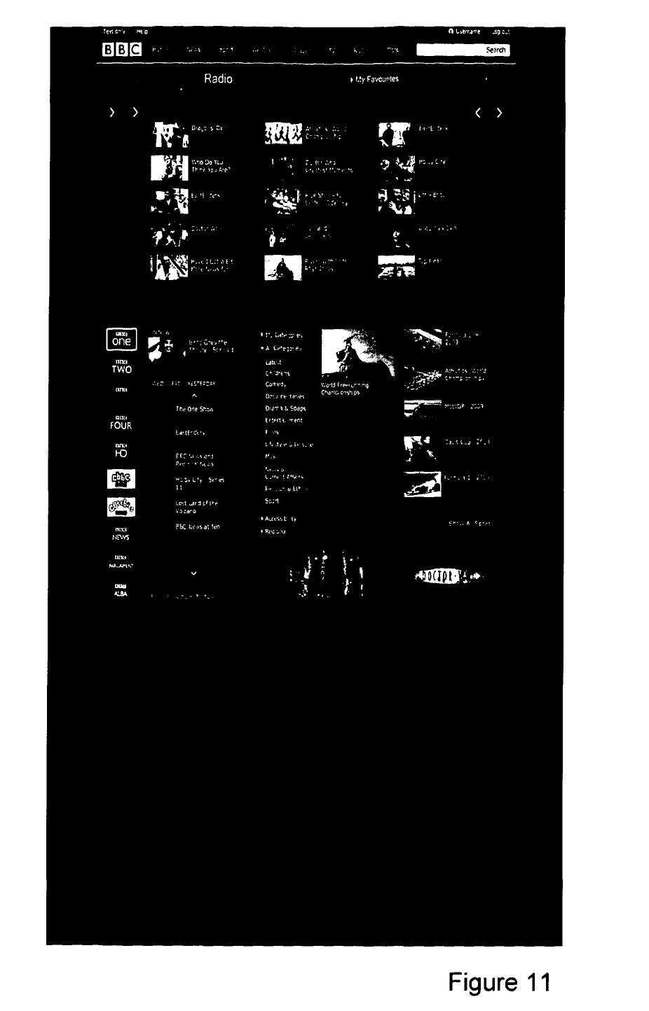

FIG. 11 shows the ‘Most Popular’ drawer of the user interface;

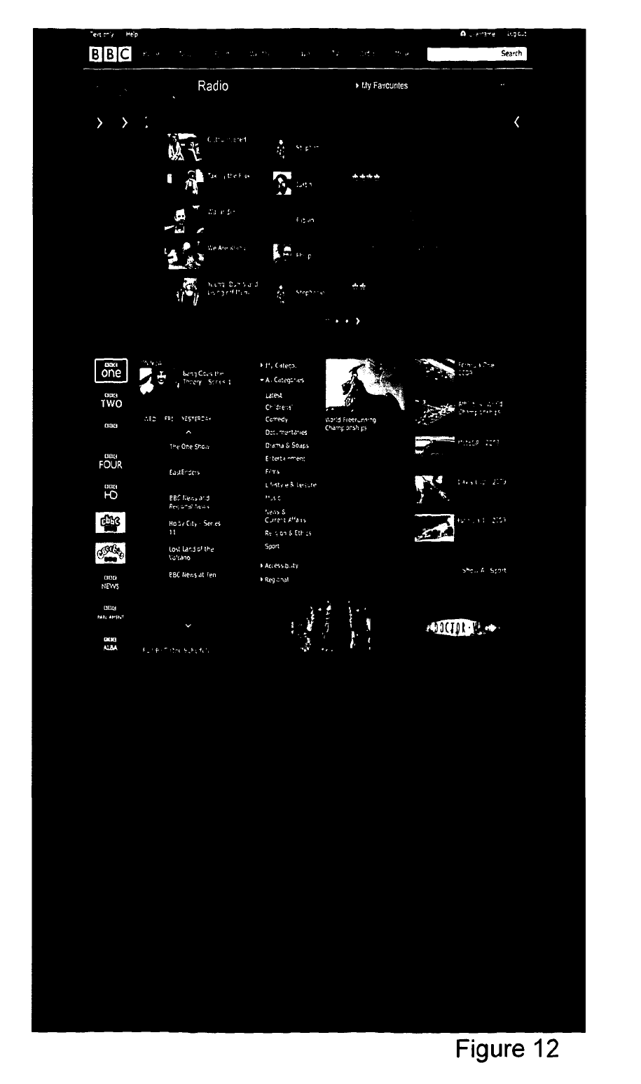

FIG. 12 shows the ‘Friends’ or ‘People’ drawer of the user interface;

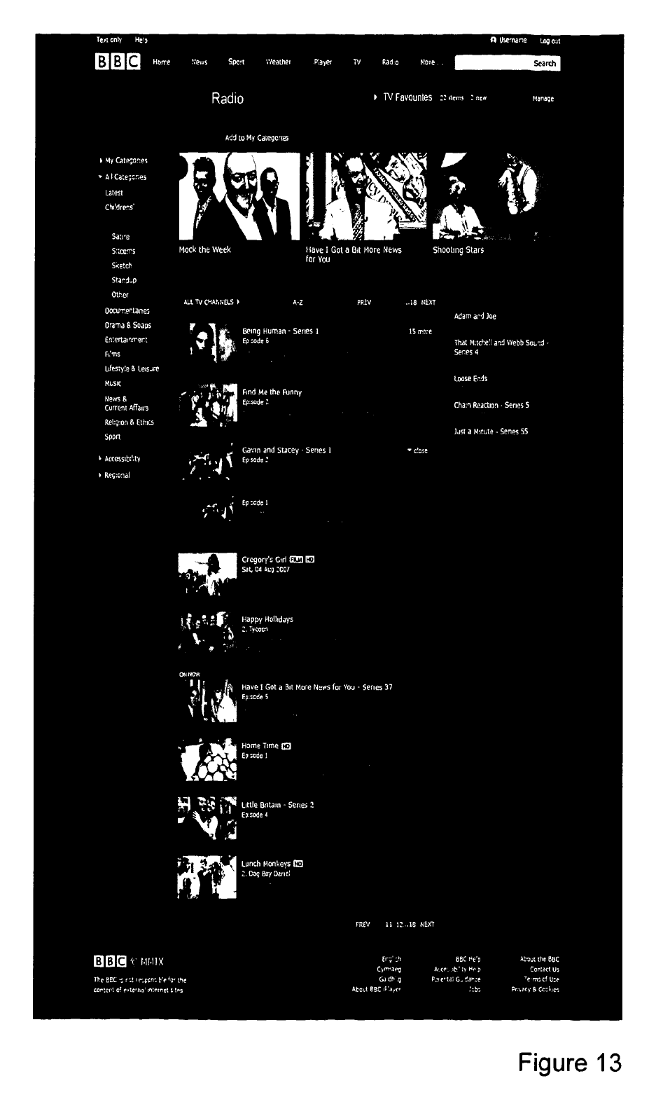

FIG. 13 shows the ‘Categories’ interface;

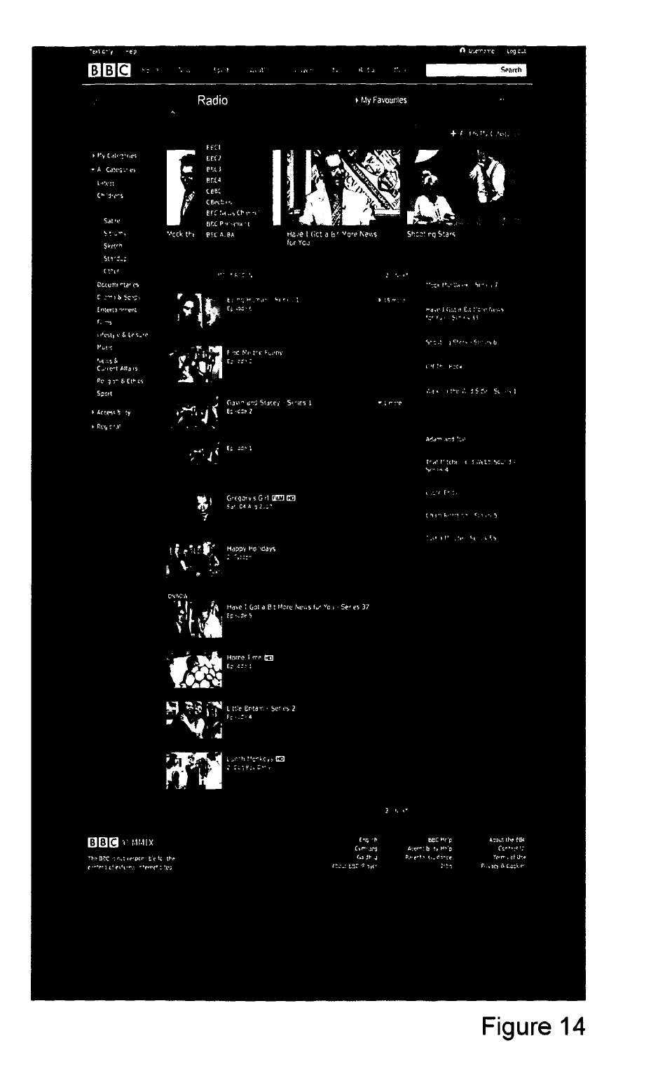

FIG. 14 shows a further view of the ‘Categories’ interface;

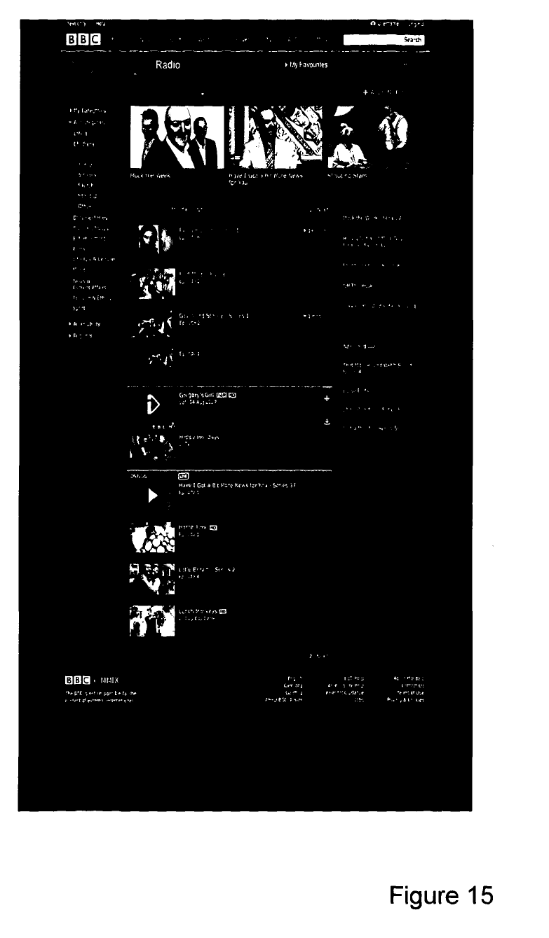

FIG. 15 shows another view of the ‘Categories’ interface;

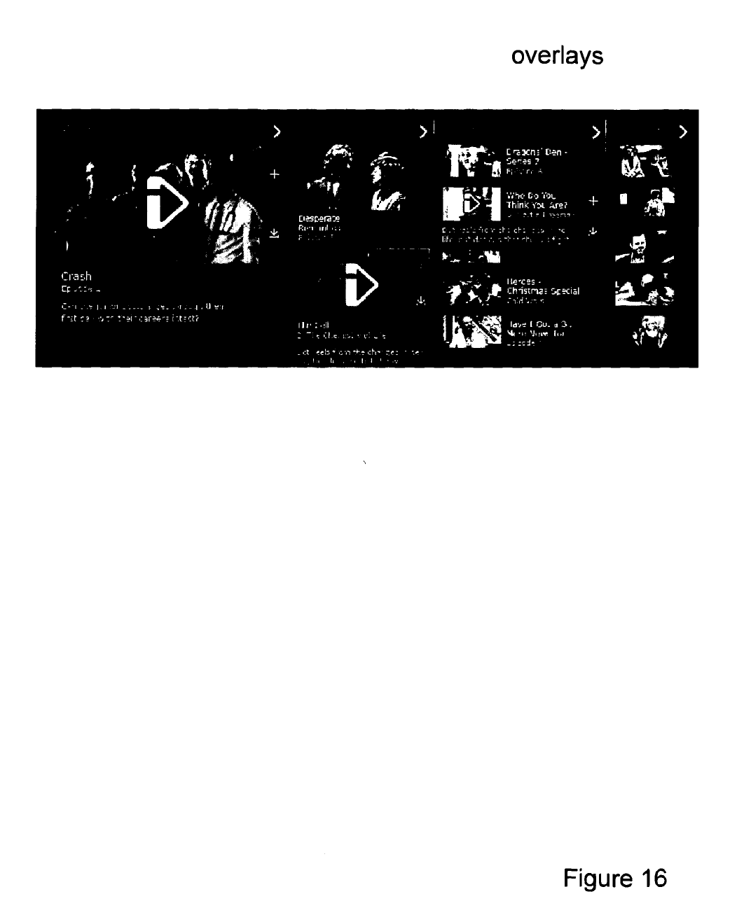

FIG. 16 shows the overlay elements of the user interface;

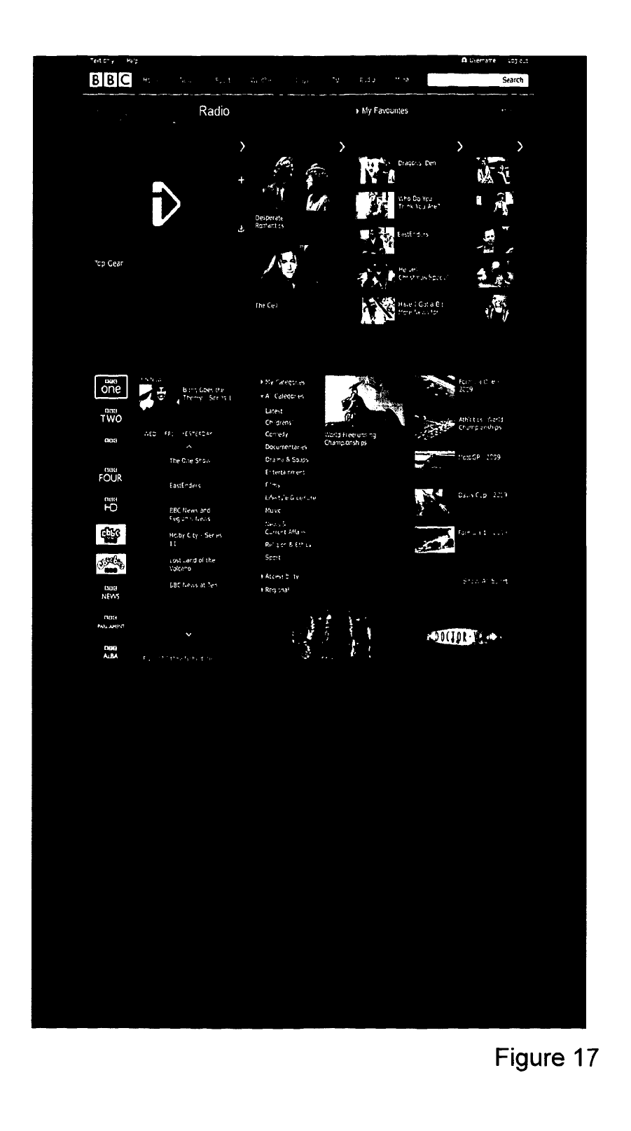

FIG. 17 shows the overlay elements in the ‘Featured’ drawer;

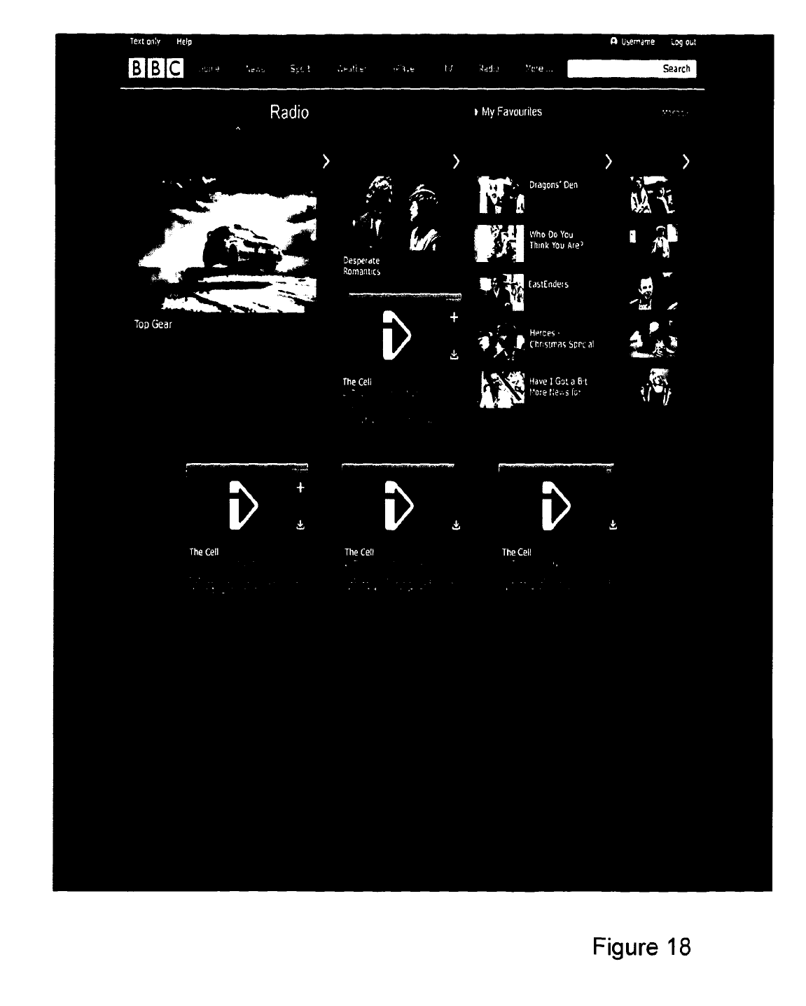

FIG. 18 shows the overlay elements in the ‘For You’ drawer;

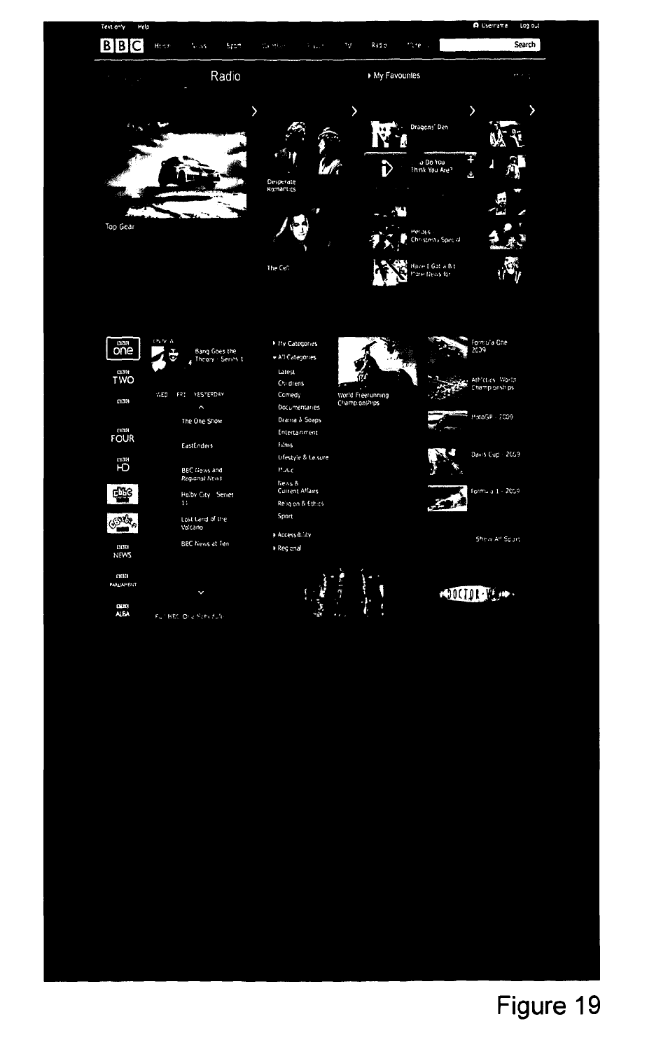

FIG. 19 shows the overlay elements in the ‘Most Popular’ drawer;

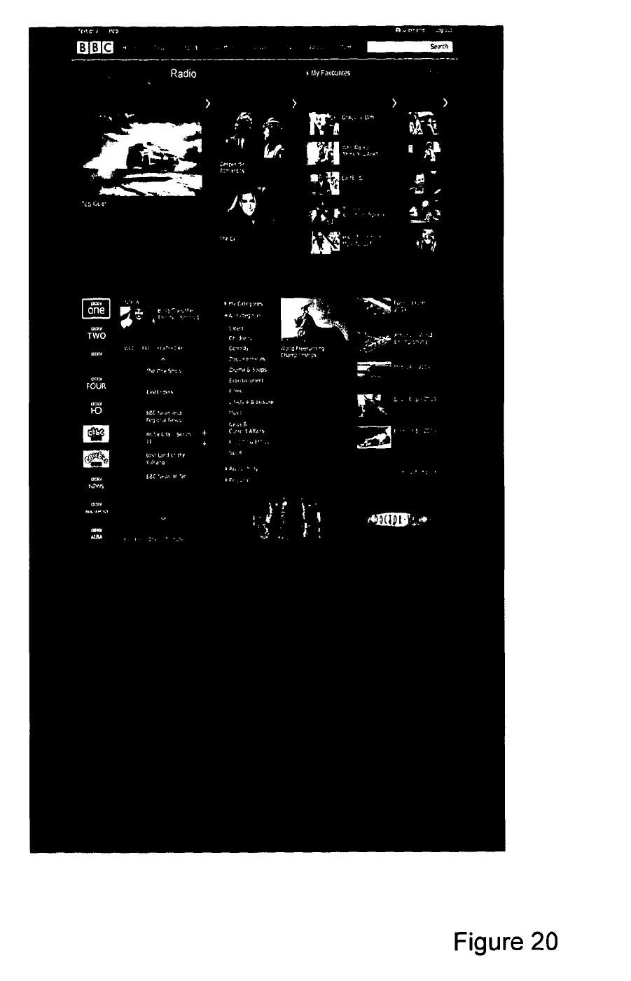

FIG. 20 shows the overlay elements in the ‘TV Channels’ component;

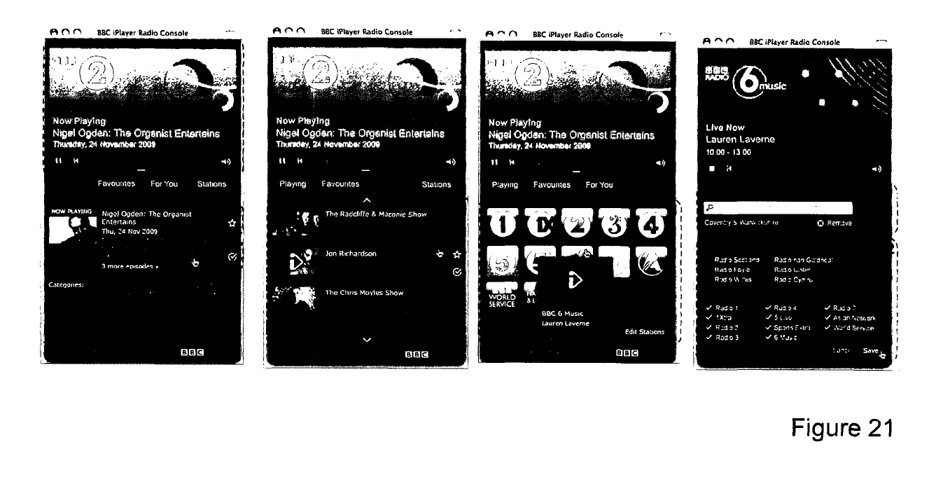

FIG. 21 shows the Pop-out media player (radio console);

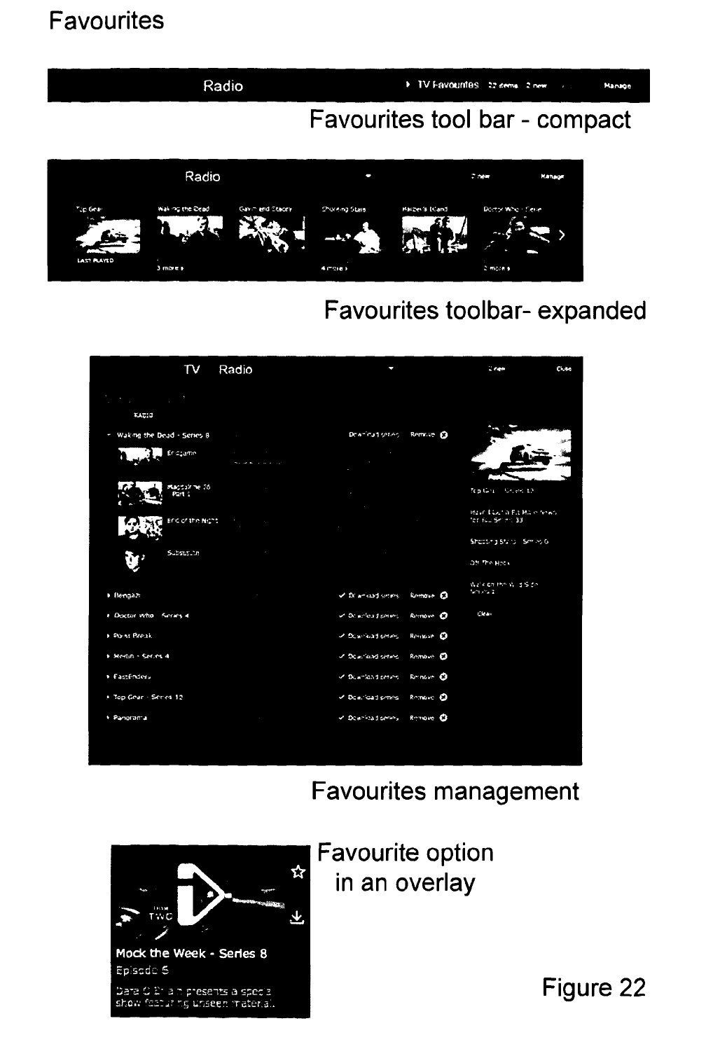

FIG. 22 shows various aspects of the ‘Favourites’ user interface;

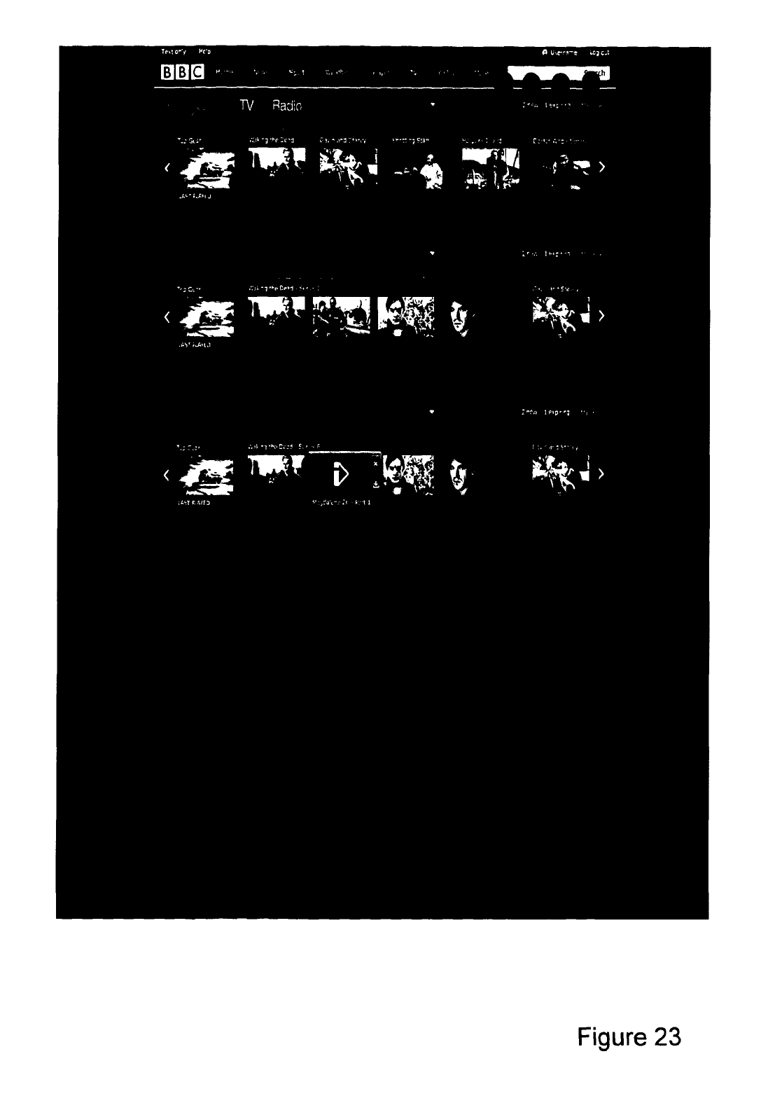

FIG. 23 shows the ‘Favourites’ toolbar in its expanded state;

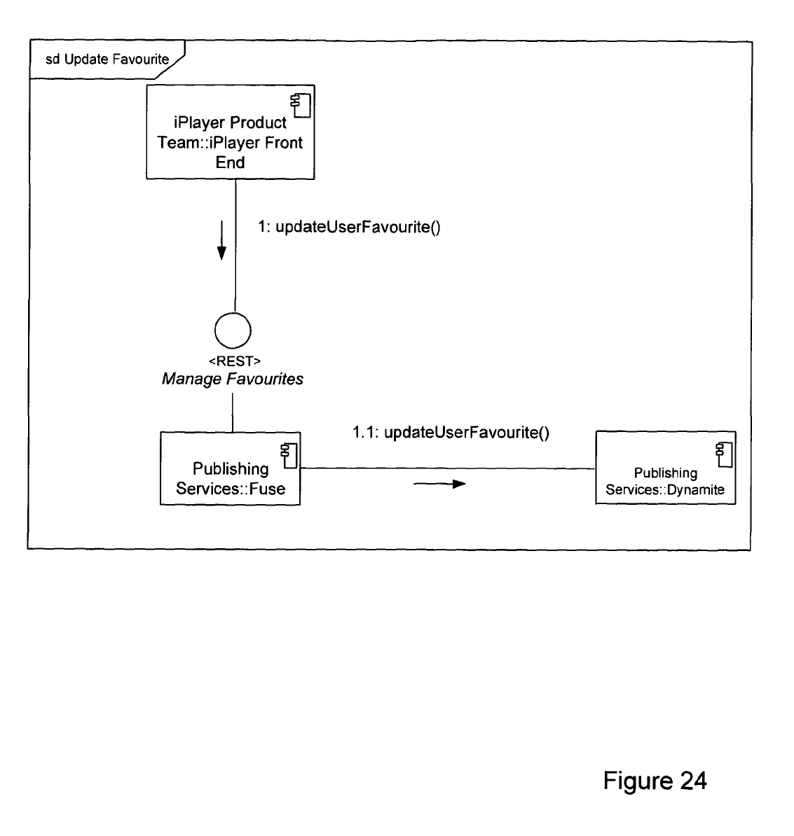

FIG. 24 shows the components involved in updating the user ‘Favourites’;

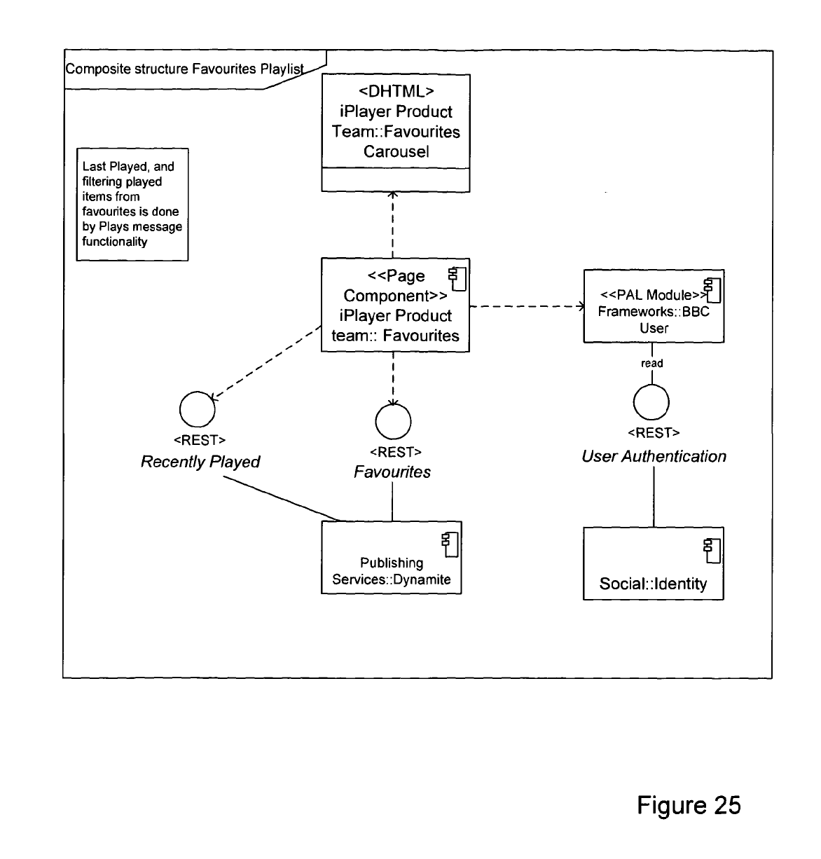

FIG. 25 shows the components involved in generating the ‘Favourites’ user interface;

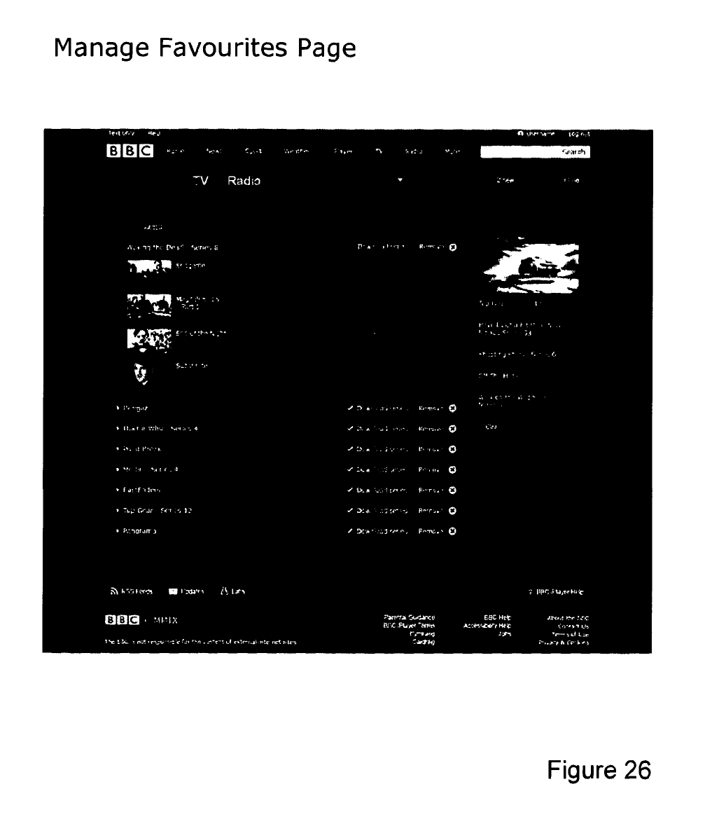

FIG. 26 shows the ‘Manage Favourites’ user interface;

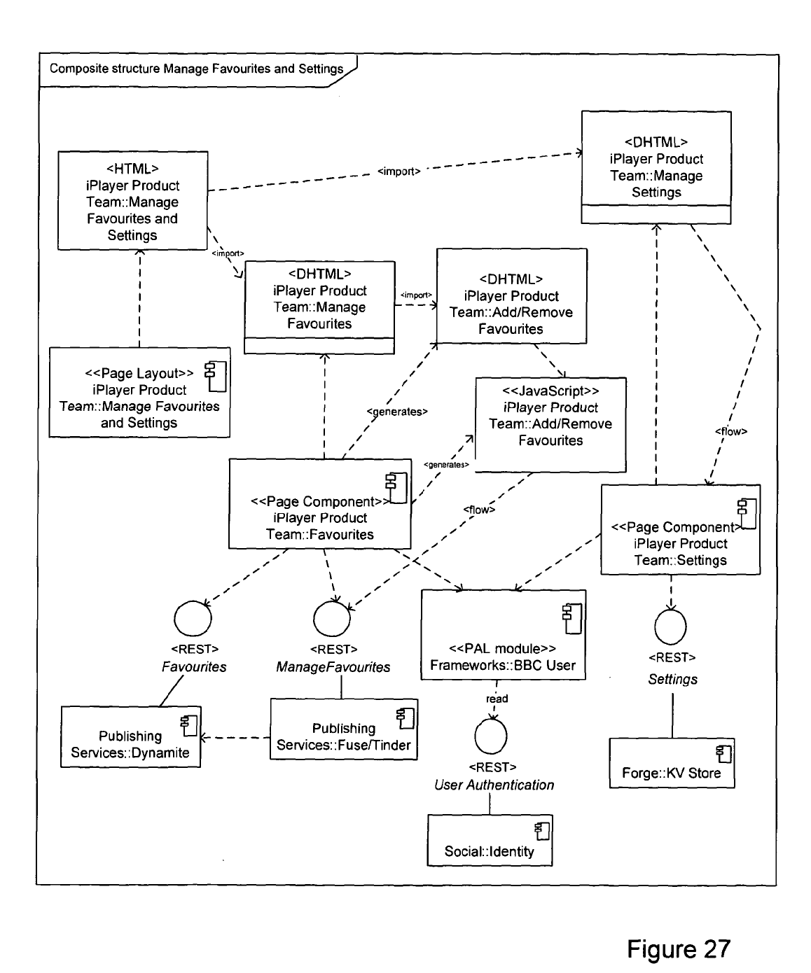

FIG. 27 shows the components involved in generating the ‘Manage Favourites’ user interface;

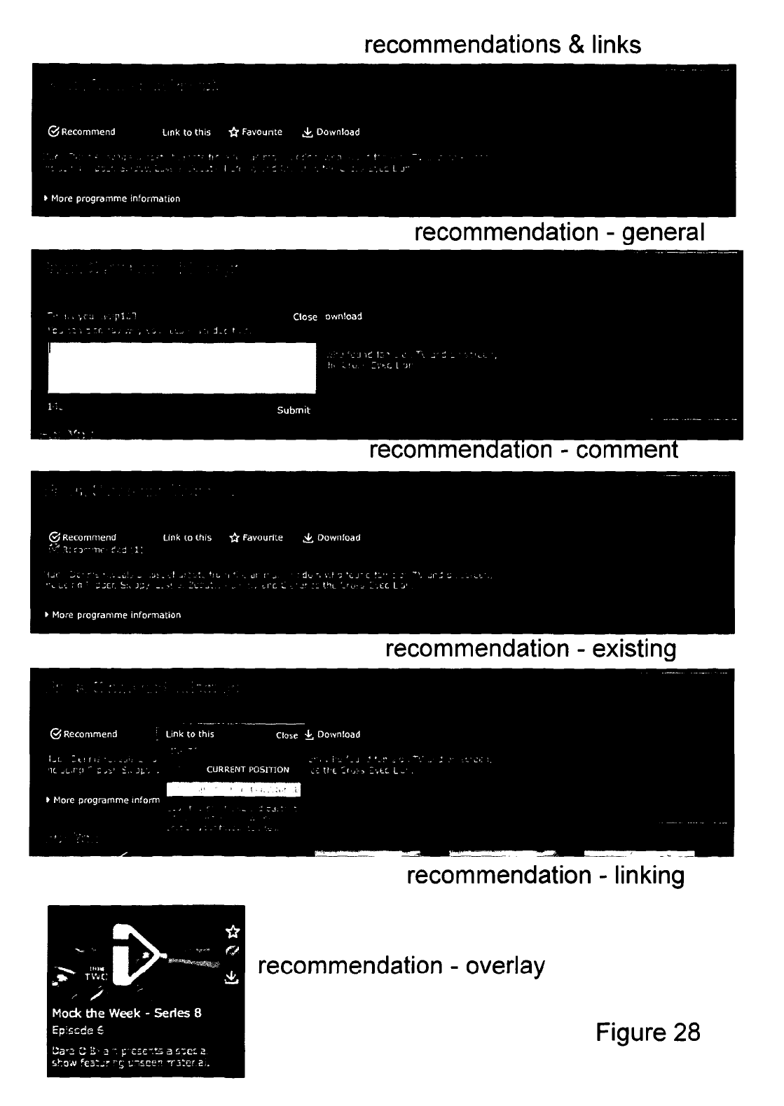

FIG. 28 shows examples of social recommendation generation interfaces;

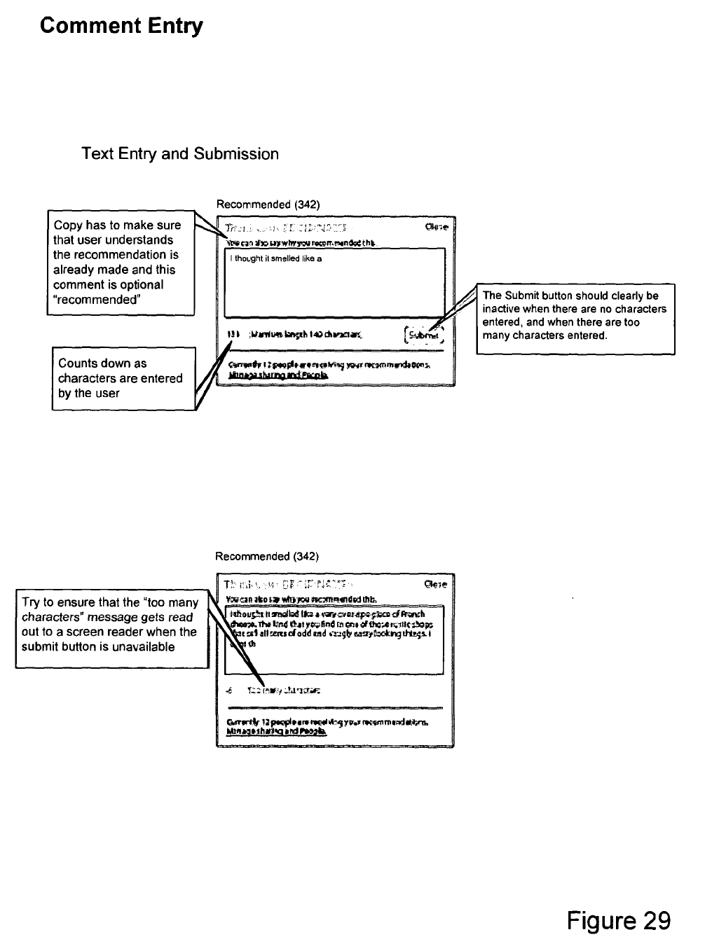

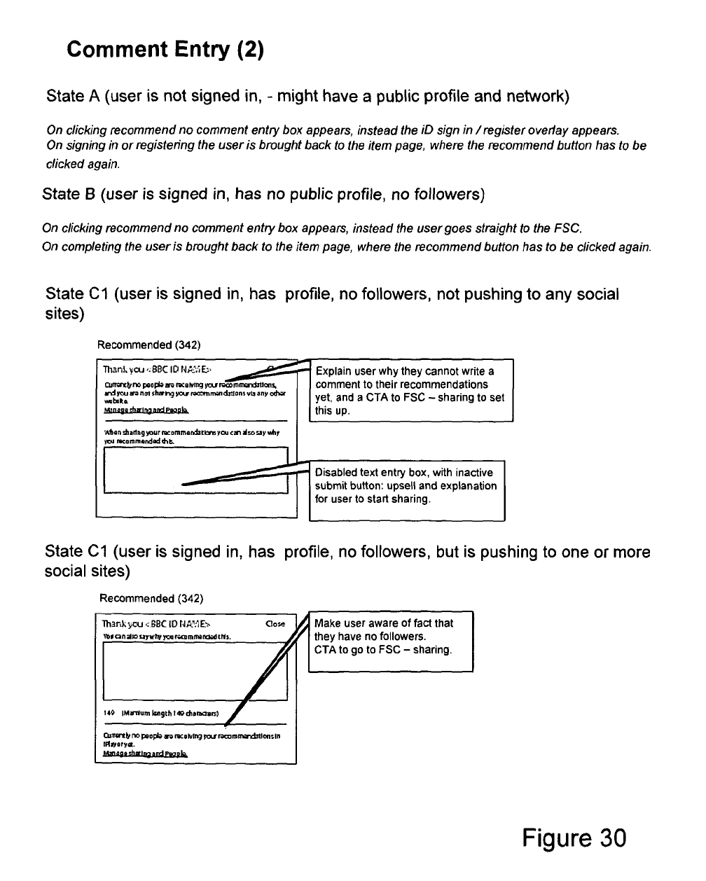

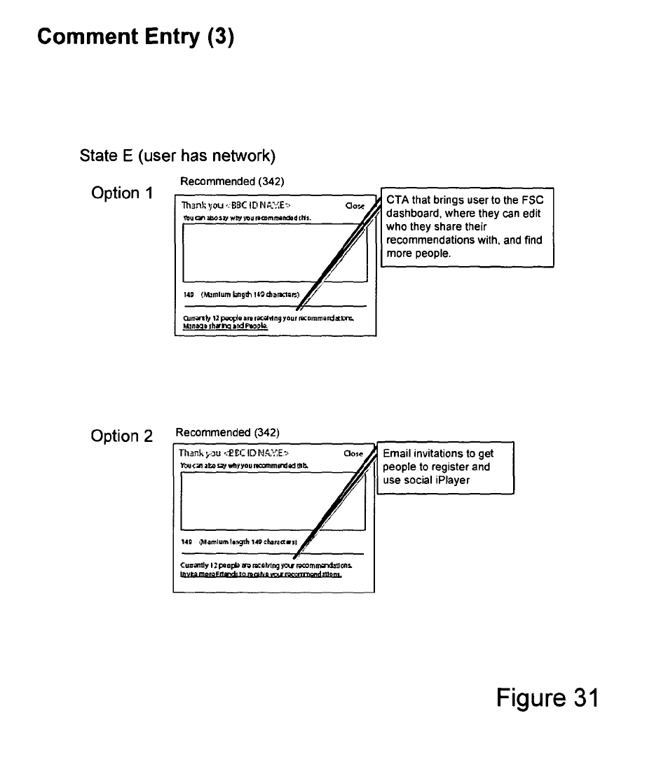

FIGS. 29 to 31 shows various aspects of the Comment Entry user interface;

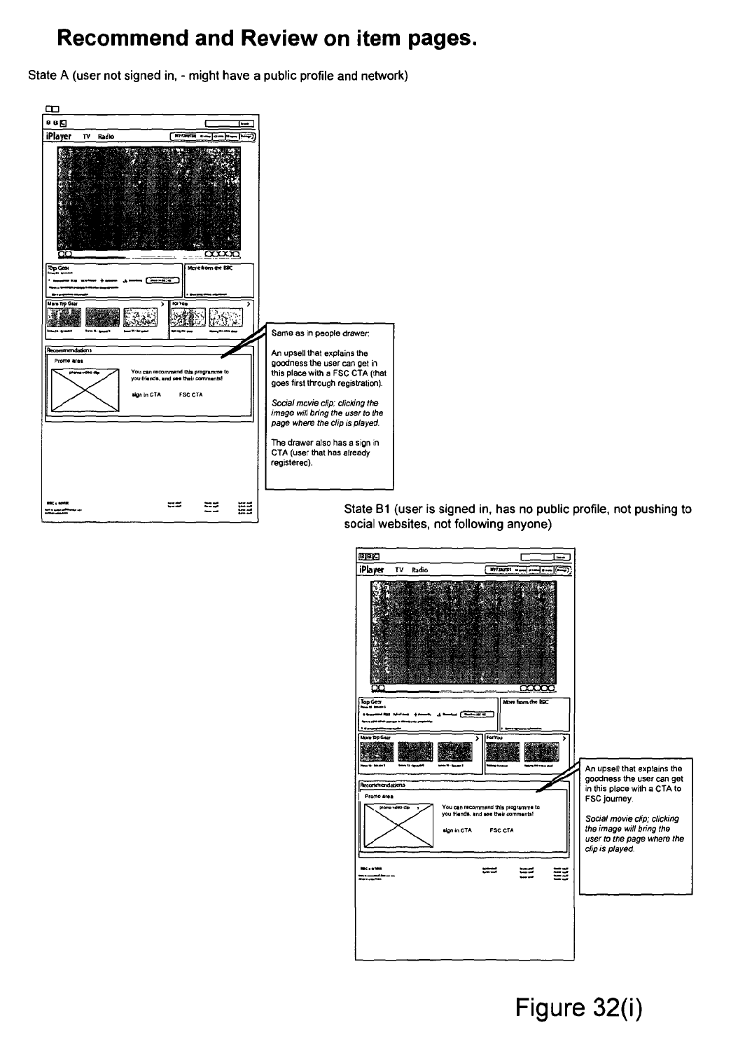

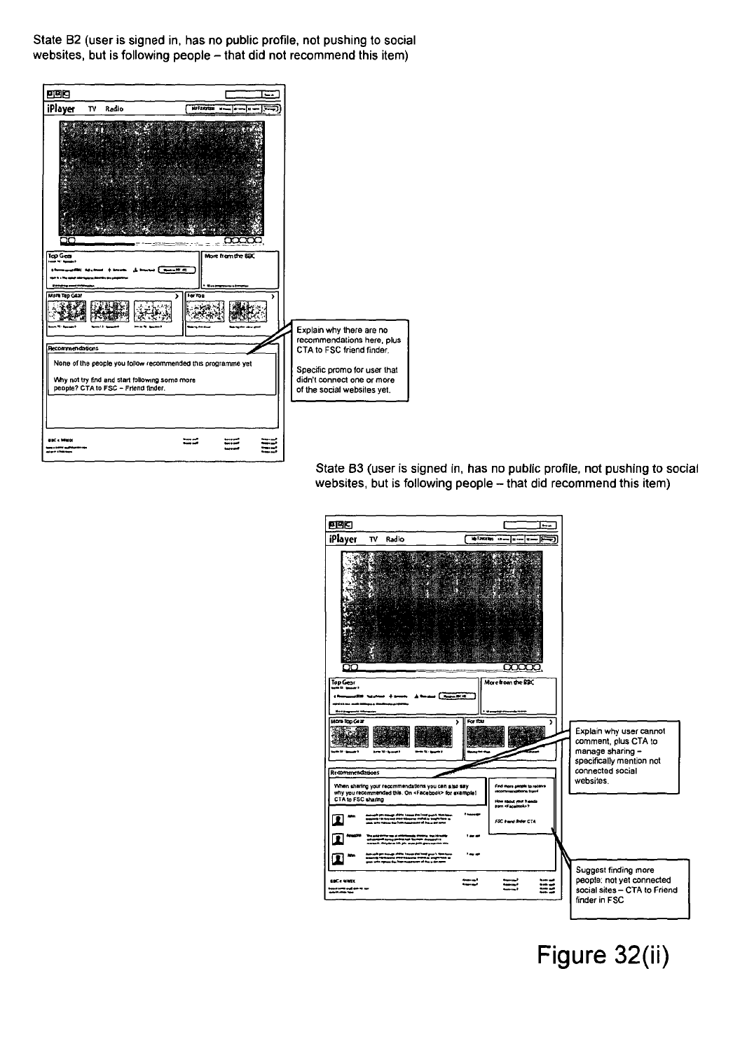

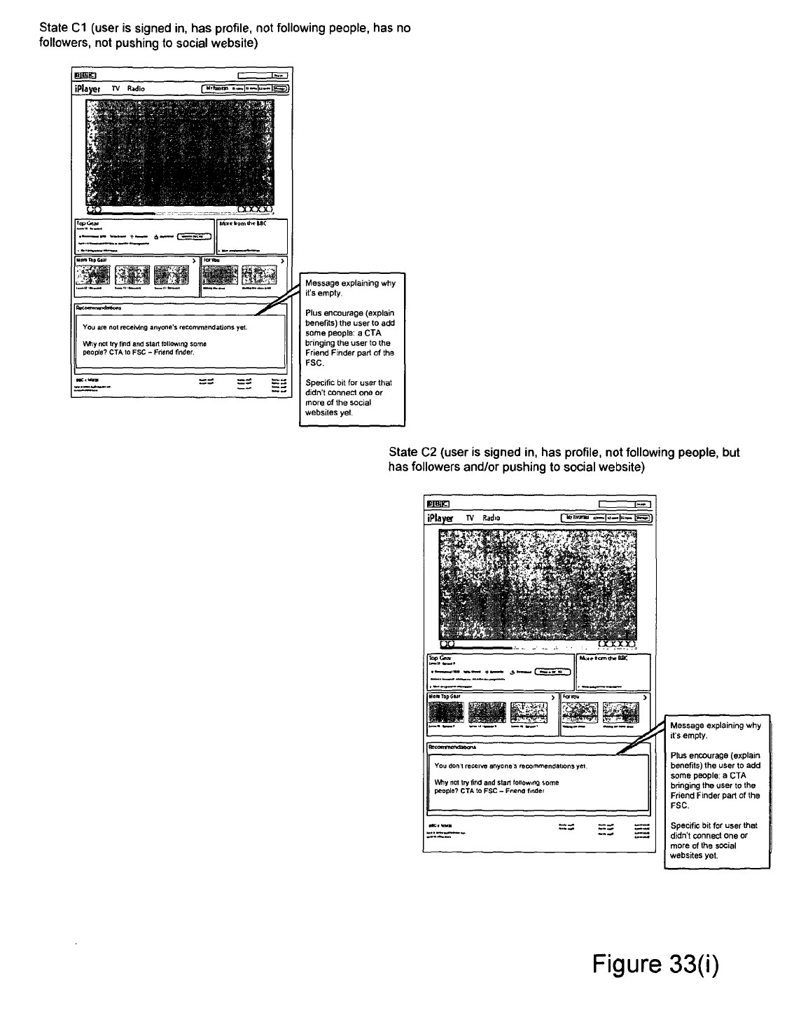

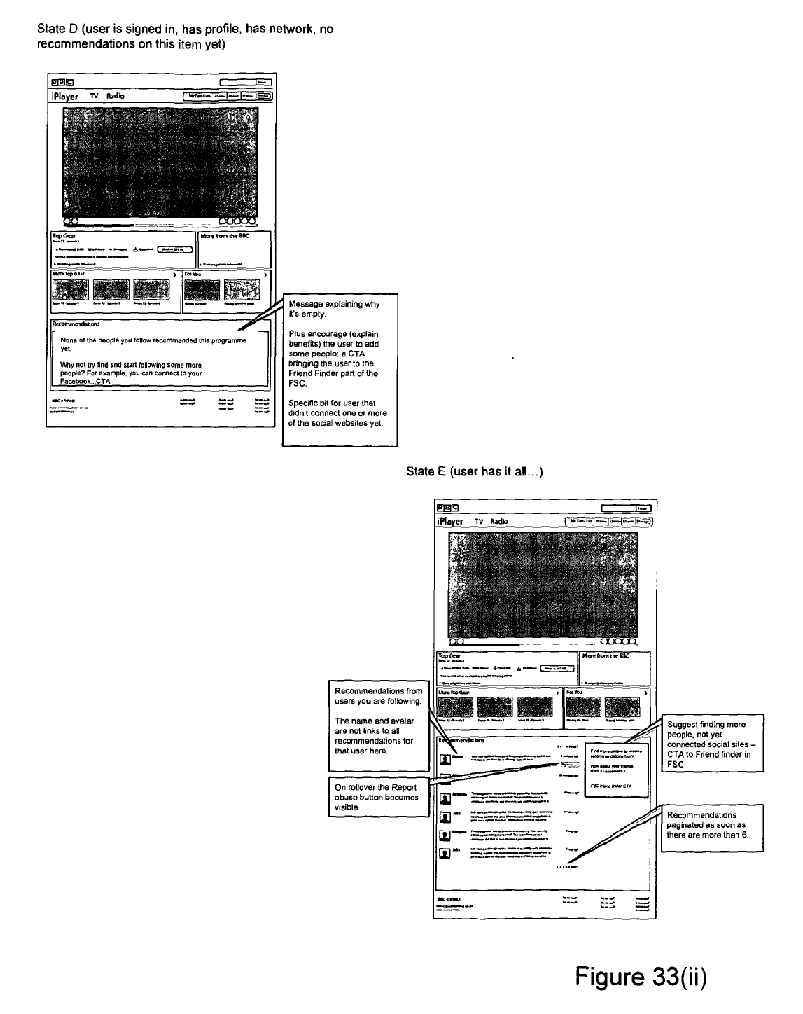

FIGS. 32 and 33 show various aspects of the Recommend and Review interface in stages of a user signing-in and then connecting to their social network;

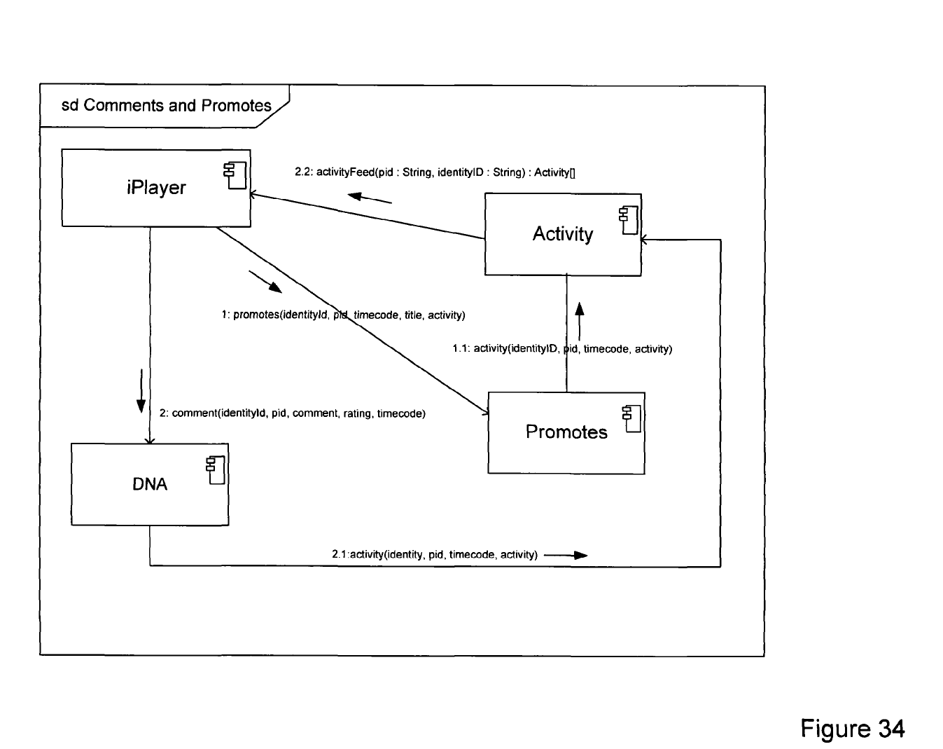

FIG. 34 shows the components involved in generating user recommendations and comments;

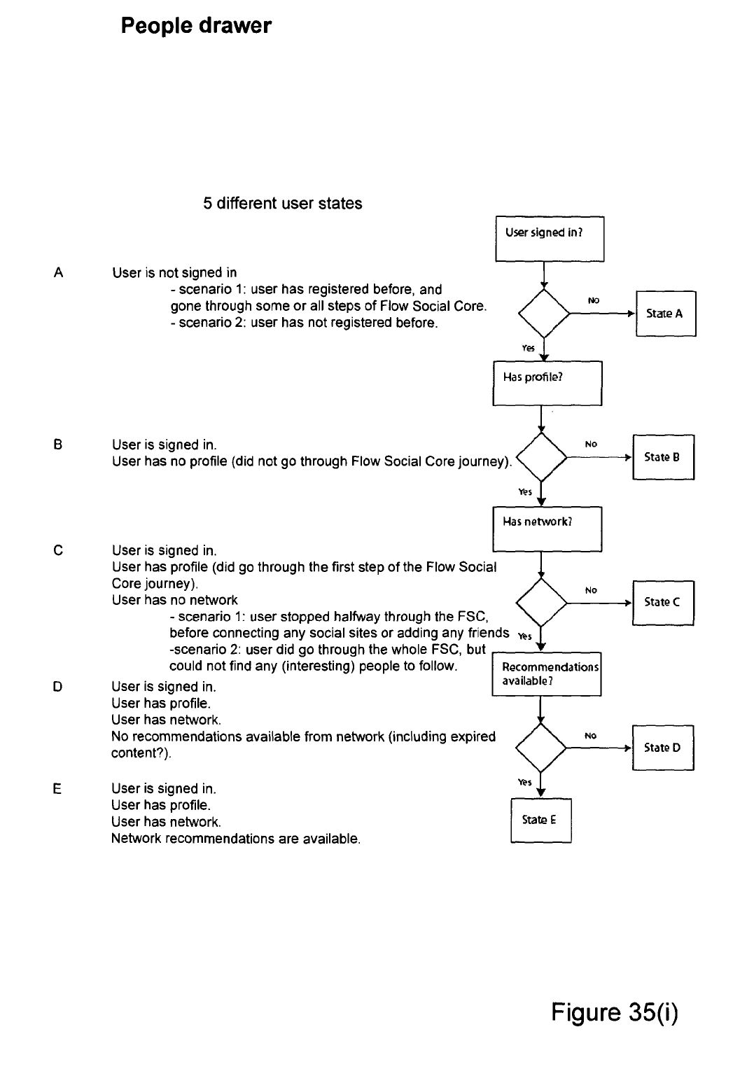

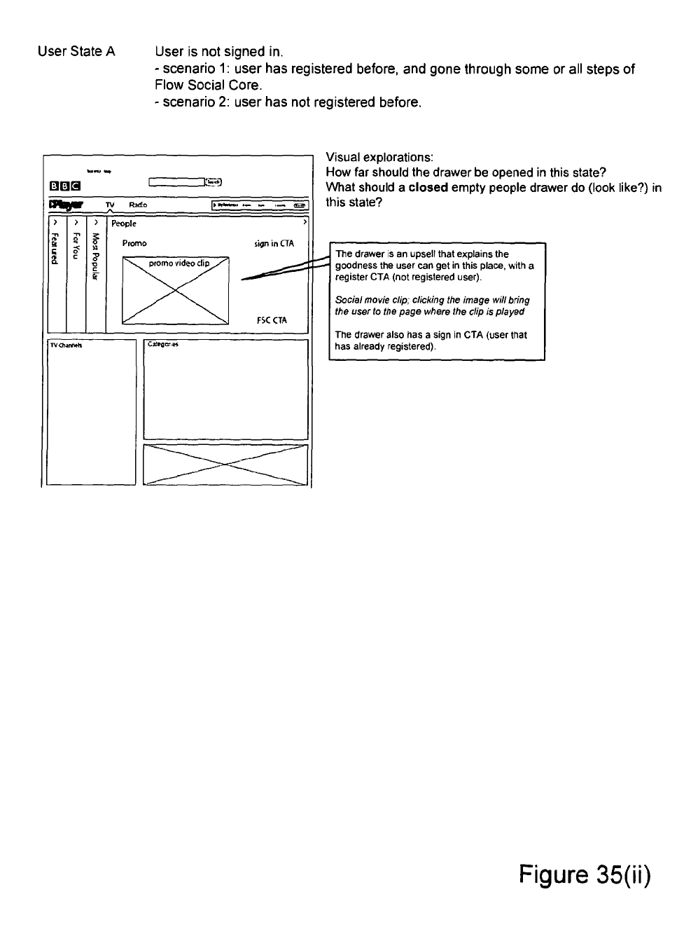

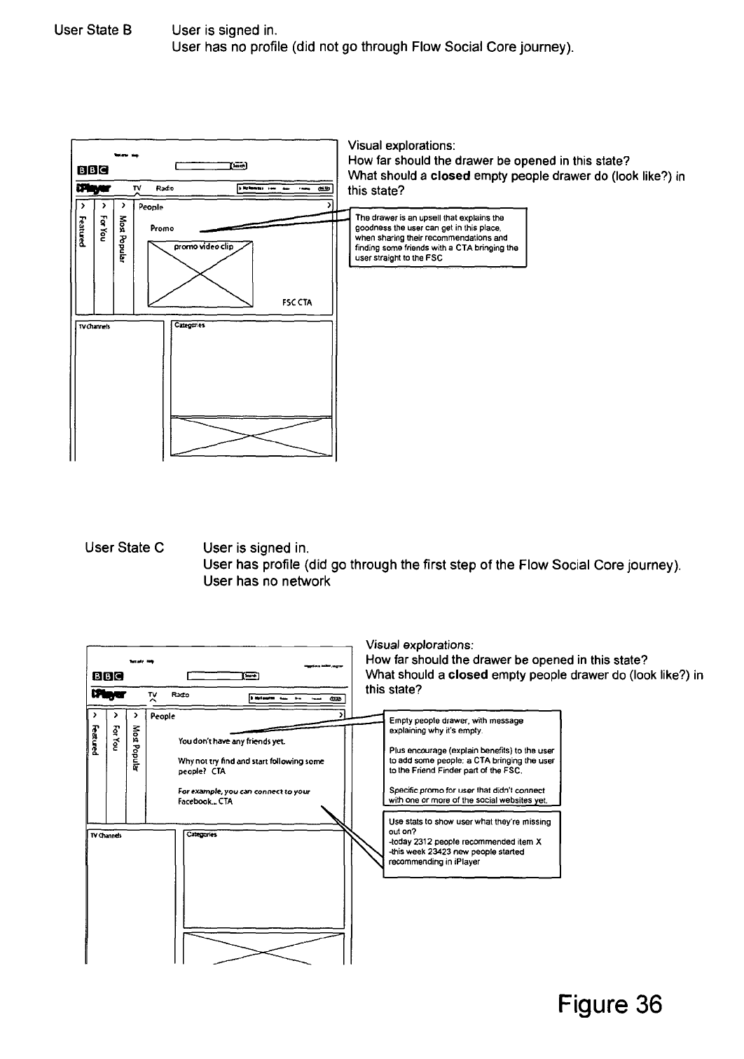

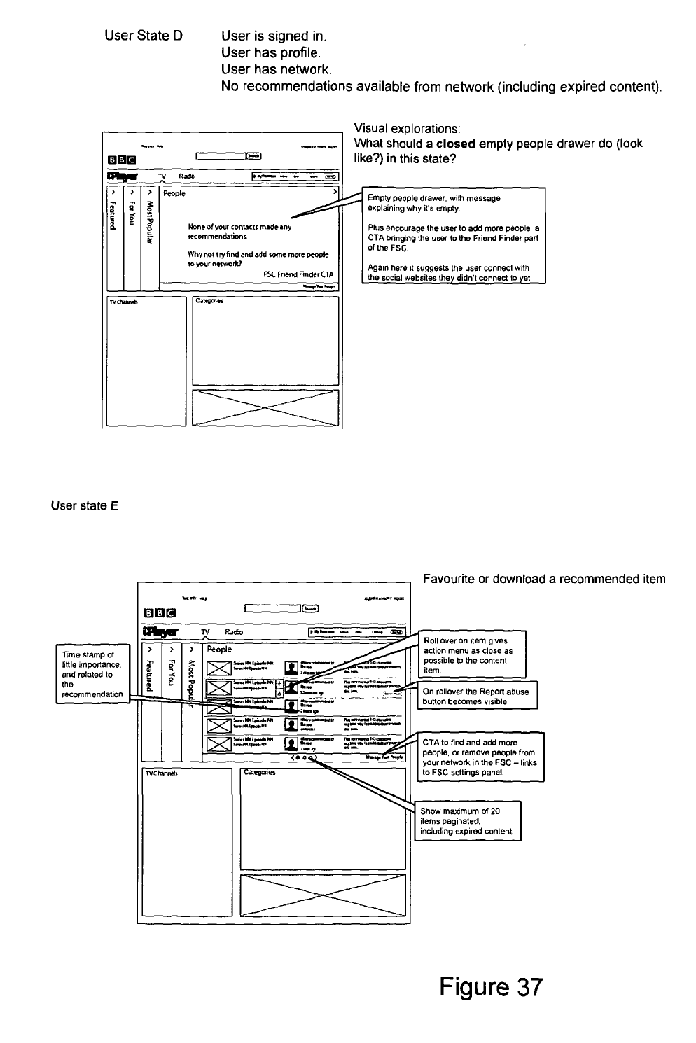

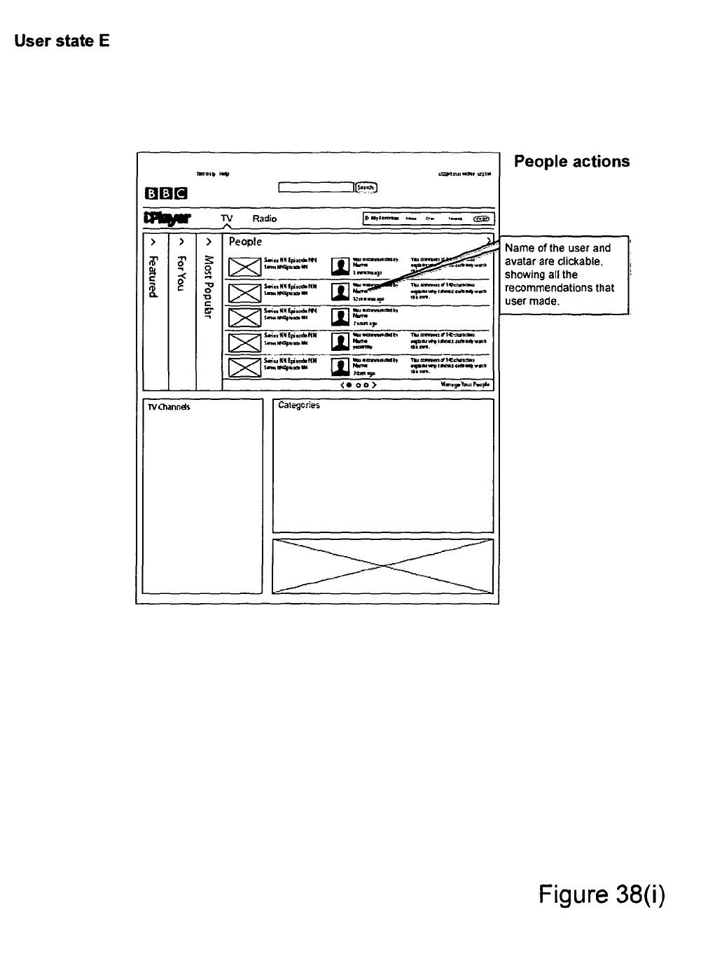

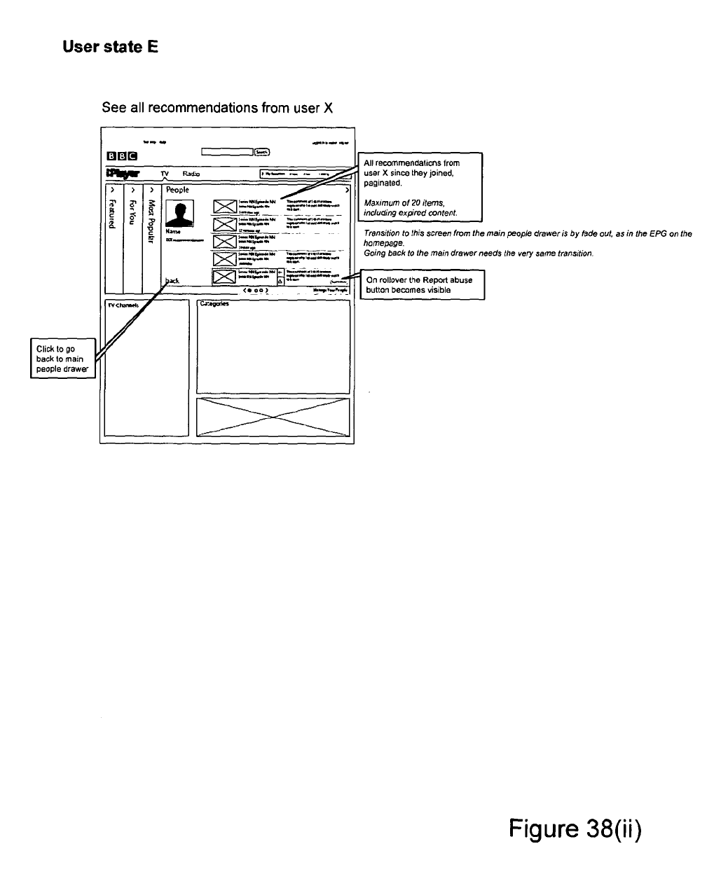

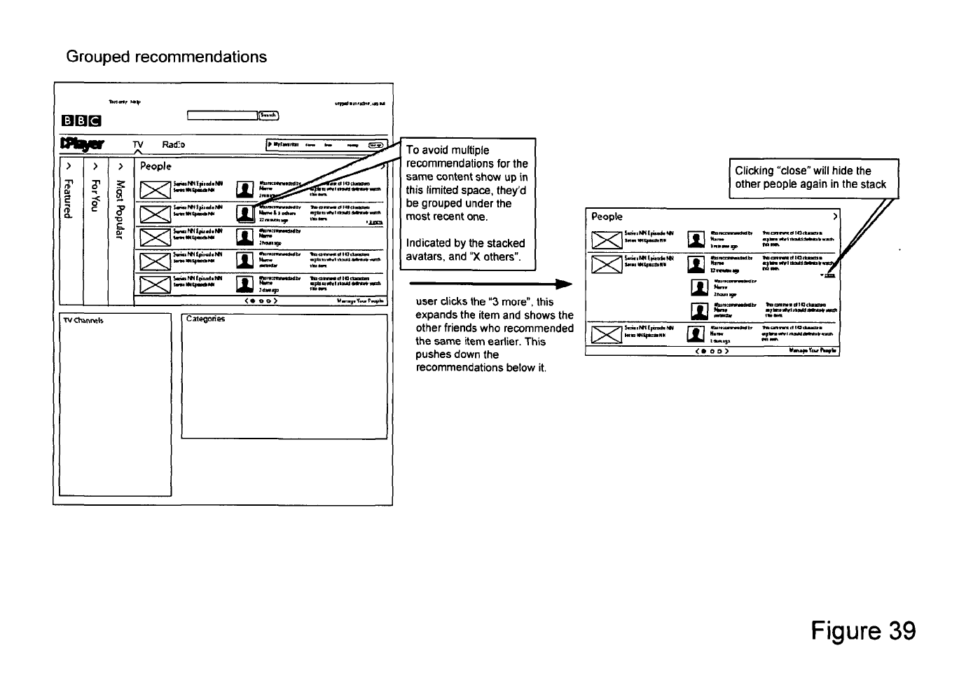

FIGS. 35 to 39 show various aspects associated with the ‘People’ drawer

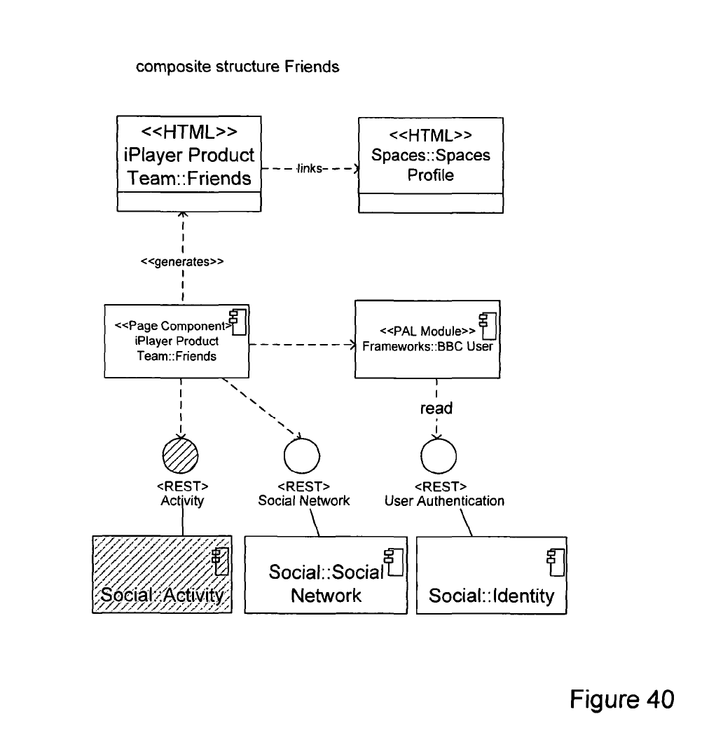

FIG. 40 shows the components involved in generating the ‘Friends’/‘People’ drawer;

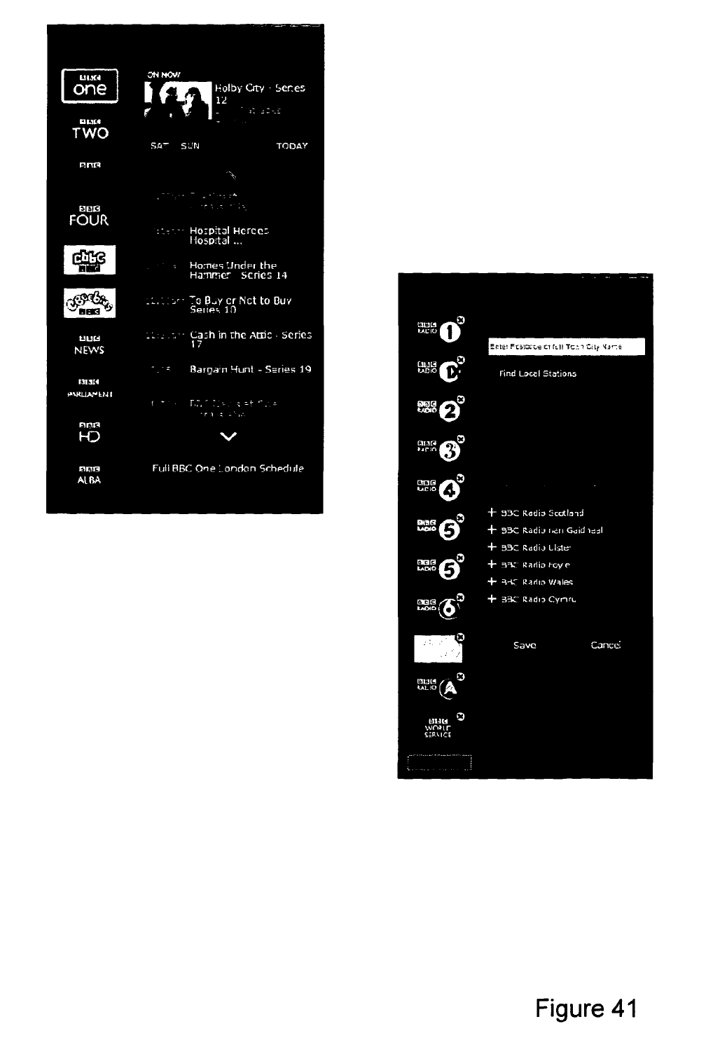

FIG. 41 shows the ‘TV/Radio Channels’ module;

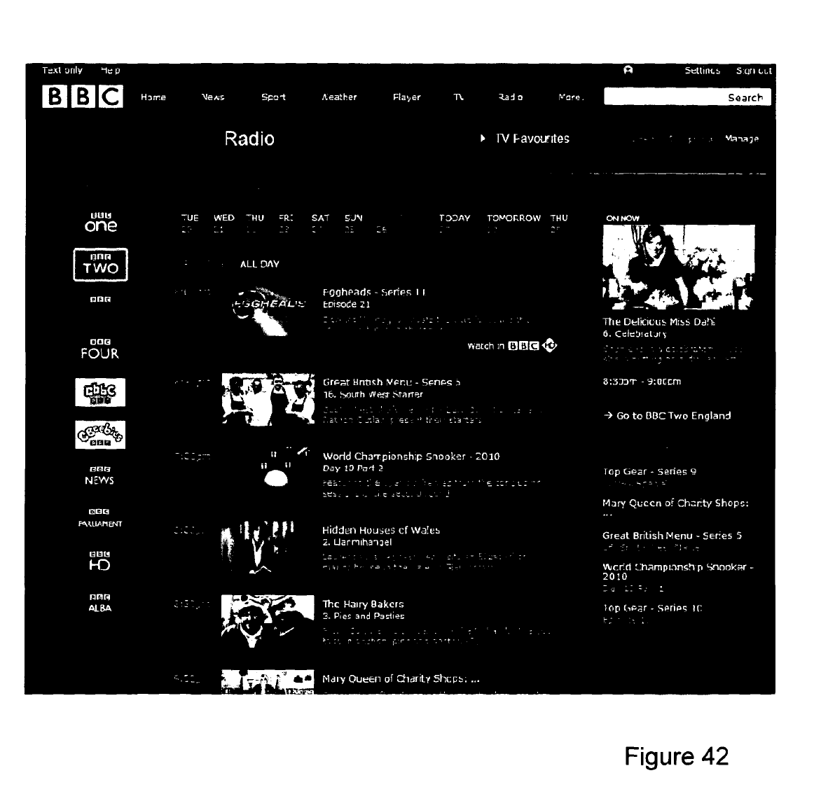

FIG. 42 shows the Electronic Programme Guide;

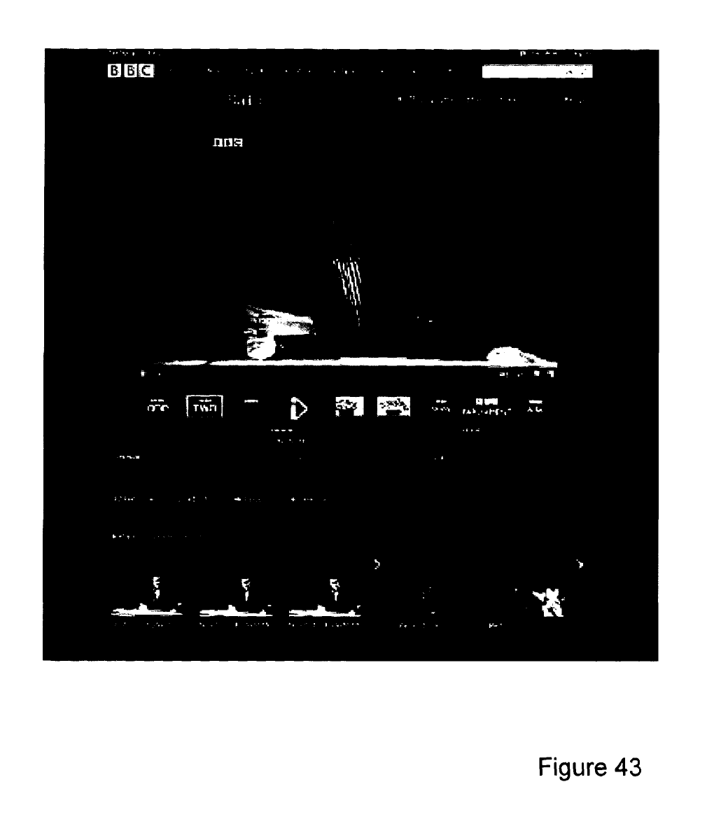

FIG. 43 shows the ‘Watch Live’ page;

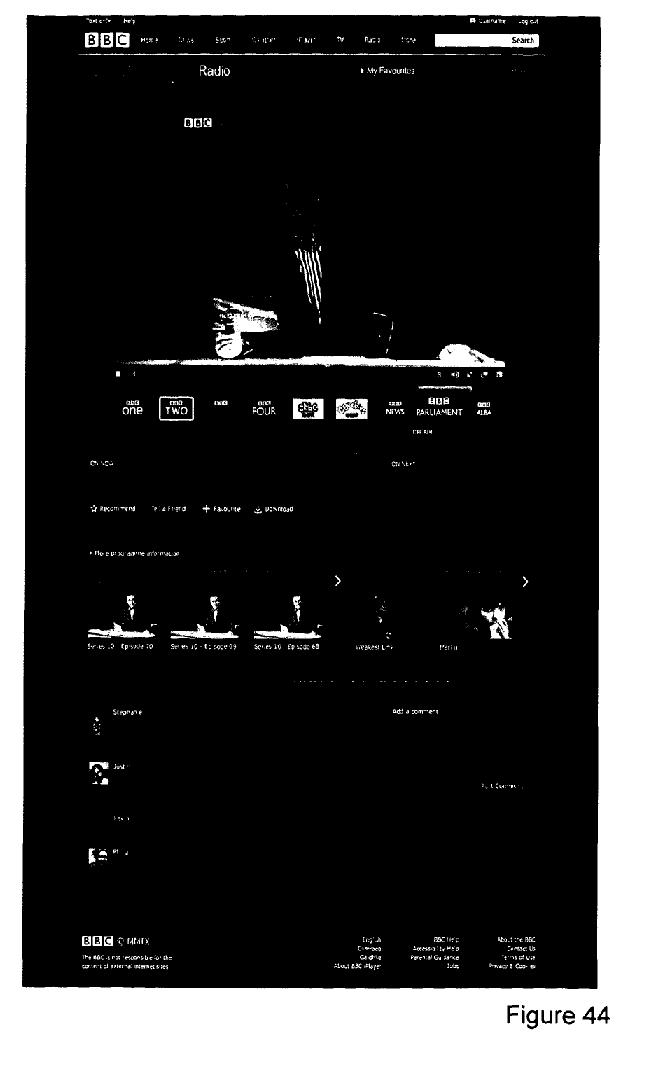

FIG. 44 shows further aspects of the ‘Watch Live’ page;

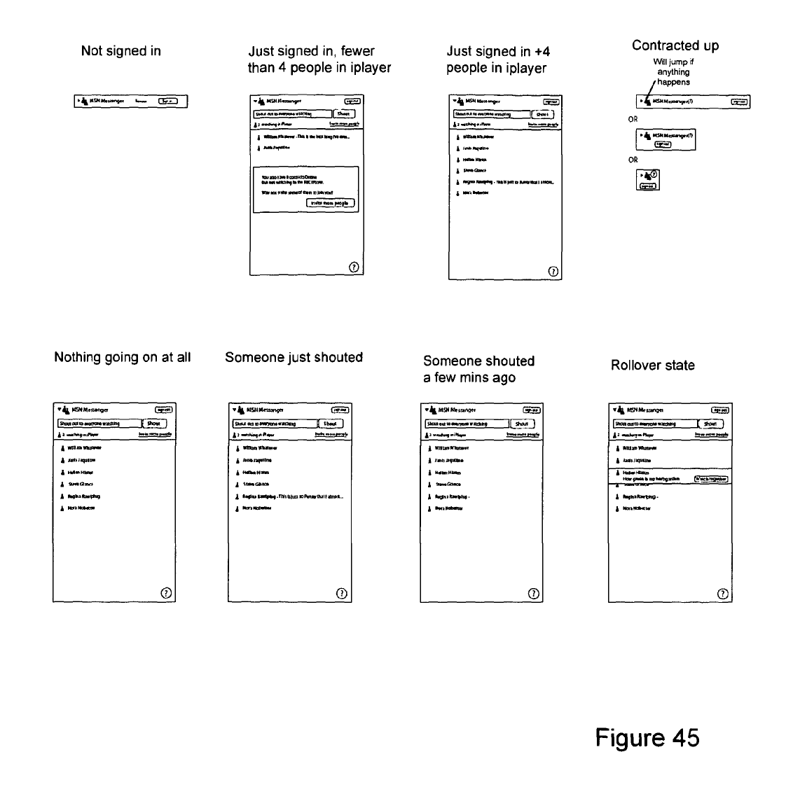

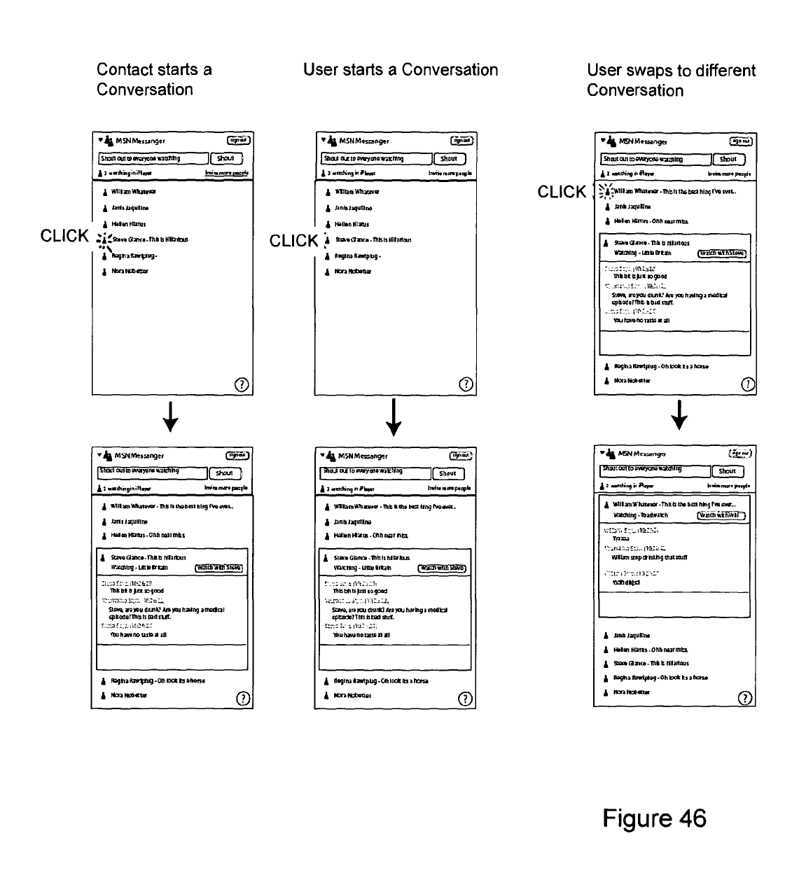

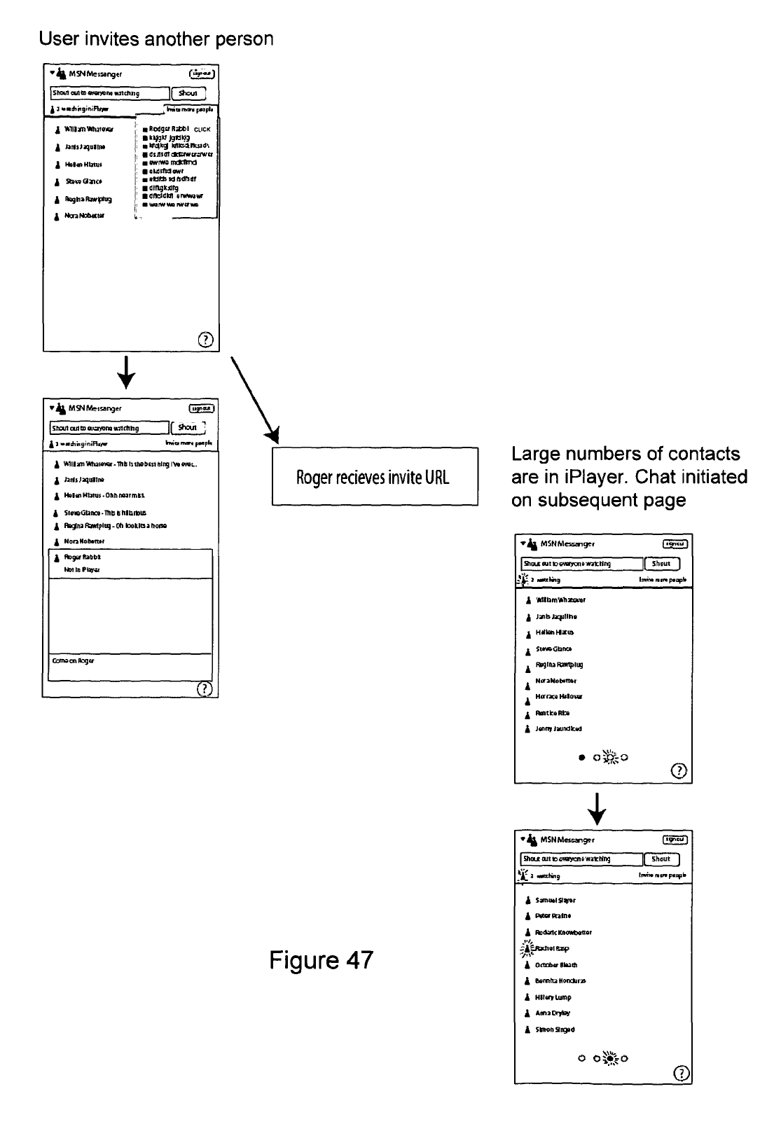

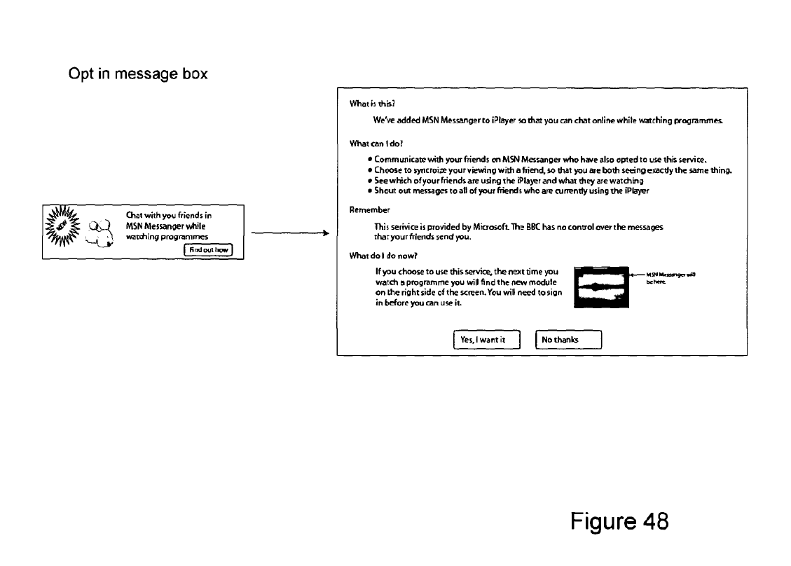

FIGS. 45 to 48 show various aspects of the instant messaging user interface;

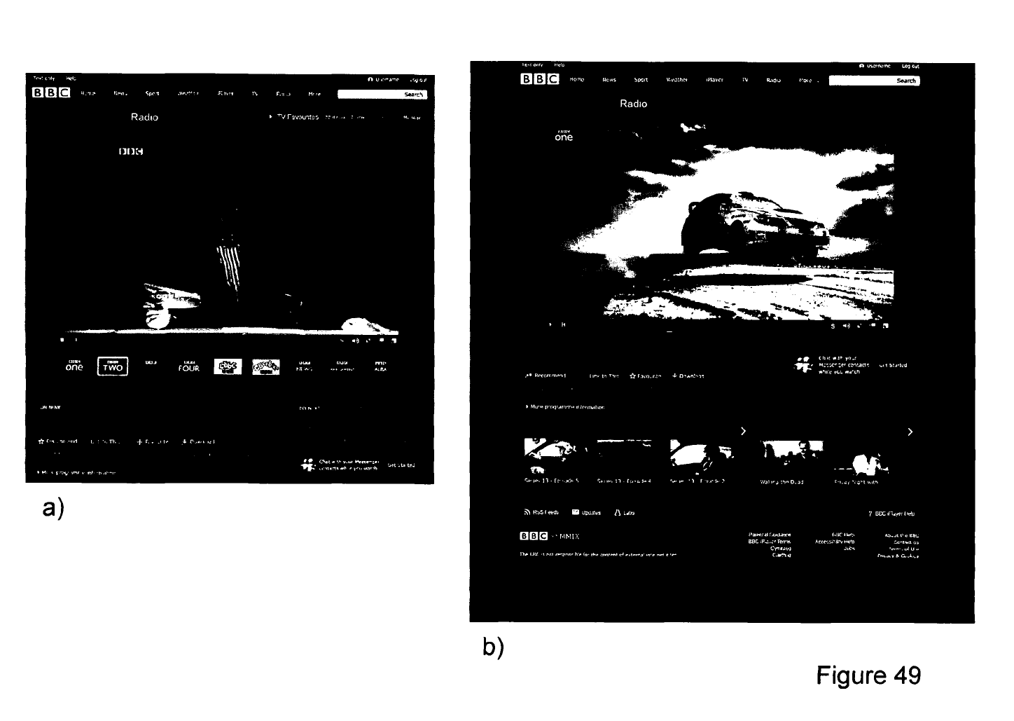

FIGS. 49 to 54 show various further aspects of the instant messaging service;

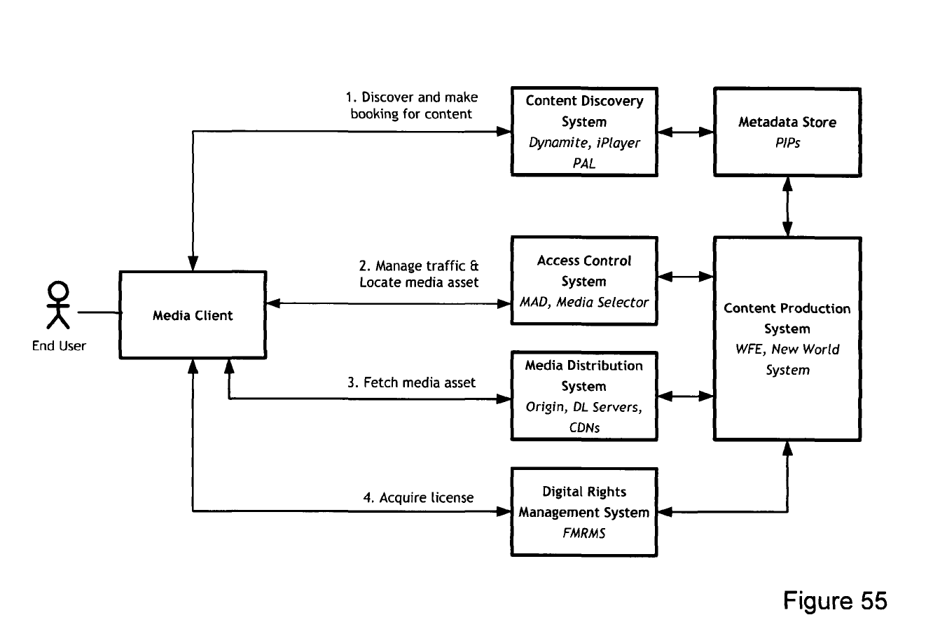

FIG. 55 shows an overview of the pre-booking feature of the interactive media player system; and

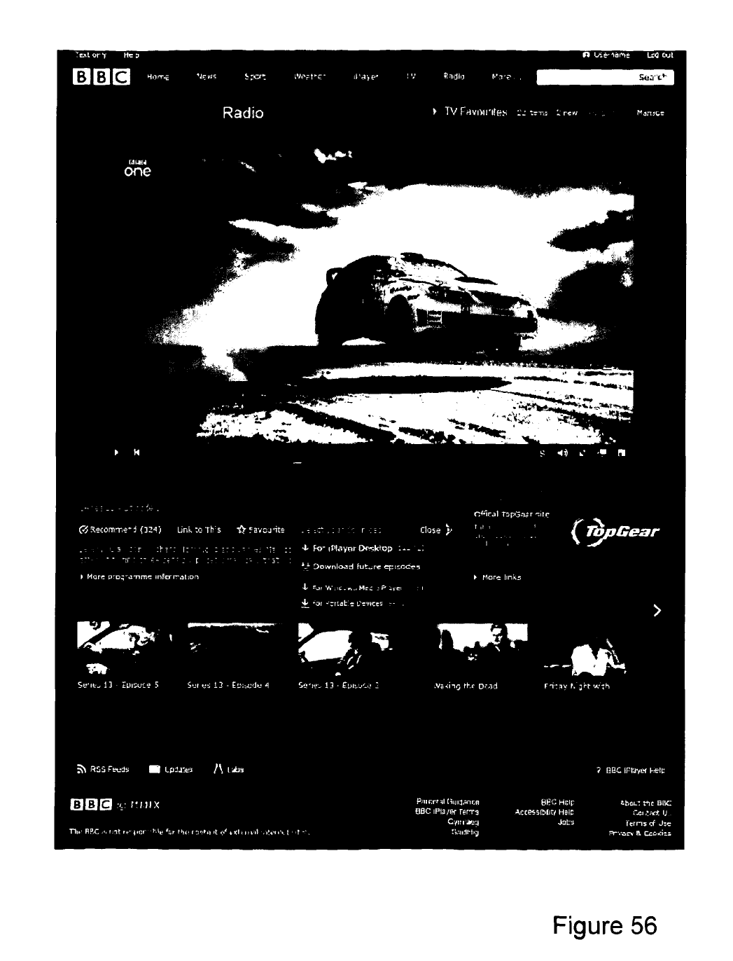

FIG. 56 shows an item page with a series pre-booking and download options.

### OVERVIEW

FIG. 1 shows a general overview of a content provision system in the form of an interactive media player system (for example, the BBC's iPlayer system) for providing audio/visual or media content from a media content broadcaster to a plurality of client devices. Examples of such audio/visual or media content may include (but are not limited to) any of the following: live television and/or radio broadcasts; earlier or pre-recorded video and/or audio content, including television programmes, news, films, music, speech or other recordings.

Media content broadcaster operates and/or has media content hosted on one or more content servers, preferably a plurality of servers further assisted by a content distribution network (CDN).

The client devices may include, for example, desktop PCs or laptops or other portable devices (which may receive content directly or via another device) such as mobile phones or personal digital assistants. In at least one example, the interactive media player system is implemented (at least in part) as software running on a client device.

The devices and the server are connectable to a network such as the internet, and the clients access the interactive media player service or website hosted on a server executing server-side software and provided by, or for, the broadcaster.

Each of the client devices and the server include at least one processor and an associated memory, in the form of RAM and ROM, user input devices such as a keypad, a touchscreen or keyboard and mouse, and a display.

In some embodiments the functionality of the server may be distributed or replicated amongst a plurality of separate servers connected to one another over the network, each adapted to perform a particular function.

The broadcaster's broadcasting equipment may be, as shown, a satellite (for example, for television or radio broadcasts), which is shown connected to the server. The server is also connected to a database and/or an archive to enable the server to provide access to audio/visual media content of various types.

In some embodiments the content may be distributed from the server to one or more content delivery networks (CDN) to allow devices to access the media content more conveniently and/or to ease the load on the broadcaster's server(s) and/or network.

Various types of media content may be provided, including streaming of live broadcast and pre-recorded content on-demand. Content may also be made available for downloading to a client device as one or more media files, or potentially transferred from one client to another (for example from PC to portable device) for subsequent viewing. User viewing of media content may require the client device to possess an appropriate licence. This licence may be specific to a particular item of media content (or associated media file) and/or to a particular user and/or to a particular client device and may be in the form of code obtainable from a licence server. The licence may be obtainable separately from the media content (or media file). In some embodiments the licence may permit the media content to be consumed only after a particular time, during a particular time interval and/or not after a particular time and/or only a particular number of times.

In use, the provision of content from a content provision system over a network to a user seeking to access the content from a client device typically comprises at least some of the following steps:
The user makes use of a user interface provided by the content server of the content provider at the client device to discover and/or navigate to content available from the content server. The content may originate from an archive or from other sources (for example, in the case of media content from broadcasting equipment). The discovery/navigation process may involve browsing, searching or making use of a recommendation.
The user then requests the content from the content server for either immediate (on-demand) or subsequent consumption.
If the content is available immediately or on-demand, it is provided by the content server (optionally, by means of a content distribution or delivery network) to the client device either as a data stream (for immediate playback whilst the data stream is being received) or as a data file (for playback once the entirety of the file has been downloaded).
If the content is not available immediately or on-demand, some embodiments allow for the content to be ‘pre-booked’, which is to say the content server allows the data file to be downloaded to the client device but only subsequently is a licence to consume the content made available to download from a licence server (and/or only subsequently does the licence become valid).
In some embodiments, downloaded data files may be loaded from a first client device to a second client device; the second client device may be a portable device.
The download and use of data files may be managed locally at the (first and/or second) client device by means of an application, such as the BBC iPlayer Desktop, run by the (first and/or second) client device; the application may be provided by the content provider.
Once the user has consumed the content, some embodiments allow for the user to comment on or recommend the content to other users. This may require the user signing-on to the content provision system and/or to a social network.
In some embodiments, use of the content may be restricted, for example the content may only be available to the user after a certain time and/or for a certain duration of time and/or no longer after a certain time and/or for only a certain amount of use.
In the case of content in the form of a downloaded data file the availability for use of the content may be governed by a licence which may be obtained from a licence server; the licence may be obtained separately from the data file.

FIG. 2 shows an overview of a user interacting with the media player system. The system can be seen to comprise the following elements (which will be described in more detail below):
media client
content discovery system
access control system
media distribution system
digital rights management (DRM) system
metadata store
content production system

The content discovery system can be seen to comprise subsystems such as Dynamite and PAL.

Dynamite is a service (optionally in the form of an application) that serves on-demand programme metadata. Data requests to Dynamite are handled by widgets which upon receiving a request or query—for example, all currently available cooking episodes on channel on tv—create in response a series of perl objects that satisfy the request; these then have perl templates applied to them to create html output.

The Page Assembly Layer (PAL) is responsible for assembling pages and rendering them for consumption by client applications—the most common being the web browser. The PAL uses the PHP scripting language and the Zend framework (an open-source object-orientated web application framework implemented in PHP) component library to fetch, render and display content.

The access control system can be seen to comprise of subsystems such as Media Selector and MAD.

The Media Selector is the front-end service application providing required media information to a user-facing client application such as Embedded Media Player (EMP) and iPlayer Desktop enabling them to access media assets. Media Selector enforces content access restrictions (GeoIP, time-expiring authentication tokens, client/device authentication, etc.) if required. The Media Selector also provides dynamic service configuration based on live traffic and performance statistics, and operational monitoring of streaming and/or download infrastructure, and of the Media Selector application itself.

The Media Availability Database (MAD) is used to manage media availability and service information. Meta data stored for media assets in MAD includes: availability time, media information (format, encoding, bitrate, width, height), CON/location information (server, protocol, path, file name, priority). MAD gets accessed by various application and services including WorkFlowEngine (WFE), content production systems (RBM ODPS, SIS CUS, RadioBridge, etc.), content provision systems (PIPS, CPE, Dynamite), content monitoring systems (iMonitor), reporting systems (iStats), and Media Selector.

The Media distribution system can be seen to comprise various subsystem for distributing media content within the broadcaster network, and also content delivery networks (CDNs) which assist in distributing media content externally to the various media clients.

The digital rights management (DRM) system may be implemented by means of systems such as Adobe Flash Media Rights Management System (FMRMS) or within Adobe AIR.

Generally, the system may be implemented in part using standard web services and database technologies such as Apache web server and SQL databases.

FIGS. 3 and 4 show the main user interface or ‘home page’ of the interactive media player system when accessed by a device, for example by means of a web browser.

FIG. 3 shows both TV and Radio modes. In this example, the user interface is a web page comprising a plurality of page elements arranged on the (single) page including elements described as ‘drawers’ and others described as ‘components’. The user interacts with the various page elements of the user interface in order to access the functionality of the interactive media player system and to consume media content. Links to media content items are presented in the form of thumbnail images representative of the media item eg. a screen shot where the item is a television programme, a logo where the item is a radio programme.

The use of separate elements assembled into a composite web page in this way allows for more efficient content provision as each element may be addressed by separate system calls. Individual components and drawers can fail whilst others (and therefore the player also) remain functioning. The same applies to the drawers themselves; each work as individual elements.

The elements (which will be discussed in more detail below) can be seen to comprise the following:
Featured, Most Popular (Drawers)
TV Channels (or alternatively, Radio channels)
Categories
Favourites

The general concept behind the interactive media player is essentially to provide an intuitive and comprehensive personalised television and radio experience. Key elements in this system include:
Category-based content discovery and navigation. The user of the system is provided with the ability to find content according to category, including content based on a personal profile of favourite categories, and the user is also provided with the ability to easily add (for example by a simple click-button on a web page) category-based preferences or other identifiers of content according to a specific to class or a grouping based on a theme
Favourites module. Extending the shopping basket metaphor into the media content sphere by enabling the user to add a series to a ‘Favourites’ listing which is then dynamically maintained with up-to-date content which is further re-organised according to novelty or viewing rights expiry and automatically updated when new episodes are available from subsequent series from the same ‘brand’ (ie. multiple series and special editions).
Recommendations from user behavioural footprint
Social elements including messaging via an in-tray populated with Friends that have been brought in from social networking sites such as Facebook and Twitter, and including the ability to accept and submit recommendations
Breaking down the distinction between the manner of consumption and the content by bringing live and downloadable content together

FIG. 4 shows the main user interface in more detail. In particular, the interface is shown when a user has been authenticated by the interactive media player system by means of a login process.

In one embodiment this is achieved by the setting and subsequent retrieval of a locally-stored cookie. That is, the user will have a cookie set at various stages throughout their lifecycle, that is, the user's interaction with the media player system (whether in a single interactive session or over subsequent sessions).

Alternative embodiments may identify the user by way of information associated with the user, the user's device, a network or geographical identifier or via authentication credentials provided by a third party.

The use of a user identity allows for persistent user preferences to be maintained between user sessions. It also allows for the provision further of user-specific features such as the facility to allow the user to maintain a listing of ‘Favourites’, providing the user with recommendations and the introduction of social elements across multiple PCs.

Three types of user status are defined:

New users. A user is classified as a ‘new user’ if they have never been to the iPlayer site before on that particular browser, or the user has flushed (ie. deleted) their cookies. A user that has browsed the site (in TV or radio mode) but not played any media is also classified as a ‘new user’.

Active users. An active user is defined as someone that has played media in the EMP (site or console). If a user is signed-on they are also classified as active.

Social users. A user that has friends (calculated by content in the ‘People’ drawer at any point, with the exception of flushed cookies) is defined as a social user.

Personalised recommendations are calculated regardless of media type—if a user has played a single TV or radio episode in the iPlayer site or console, personalized recommendations are triggered

Consequently there are effectively (at least) three versions of the media player system homepage (and Radio equivalents):
Default (iplayer-tv /iplayer-radio)
Active (iplayer-active)
Social (iplayer-social)

A locally-set cookie is used to determine to which page the user (strictly, the user's media client) is redirected; in the absence of a cookie the default is to direct the user to the TV homepage.

This may also allow for geographical restrictions to be implemented, for example, it is possible to differentiate between users based in the UK and overseas.

For a UK-based user, in one example, the cookie setting process is as follows:
1. For a new user with no existing cookie, when the user accesses/iPlayer he is redirected to /iplayer/tv
2. Once the user plays an item, recommendations become available
3. The user cookie is set to ‘active’ user
4. Subsequently when the user accesses /iplayer he is redirected to /iplayer/tv/active
5. If the user signs up for Identity, they can then follow people (that is, the user is prompted to log-in or create a user account and connect to their social network, a process known as ‘Flow’)
6. The user cookie is then set to ‘social’ user
7. Subsequently when the user accesses /iplayer he is redirected to the homepage with the ‘People’ drawer open
8. When the user logs out, the cookie is removed (alternative embodiments preserve the cookie)
9. User logs in, set cookie to ‘social’

For an international or overseas user, where the media playback rights may be restricted for video media content the process regarding user sign-in is the same, but the defaults to /iplayer/radio i.e. primarily an audio-only experience.

Various alternative embodiments may have one or more of the following features:
A cookie is set to determine whether the user has set up categories or added favourites. This may reduce the number of system calls required.
In order to ensure a user with an identity keeps their local cookie in sync, when a user signs into identity any existing cookies are ignored and the BBC ID cookie takes precedence.
If a user is signed in and considered ‘active’ but has not played any content then the ‘For You’ drawer backfills with BBC selected content.
Because there is no control over Identity interactions setting cookies on Identity events may in some cases be problematic. In one embodiment therefore, merely detecting the presence of an ‘Identity’ cookie is sufficient to direct the user to the ‘social’ page'—although this although may result in the possibility of having two empty drawers if the user is logged in to Identity but has never played any media content and has no Friends
A user that has Friends (as calculated by content in the ‘People’ drawer at any point) is identified as a social user.
If a user has opened the Friends/People drawer and clicks any link they need to be classified as a social user—this may require classifying the user as a social user prior to them seeing the drawer, for example by initial login or cookie detection. All users will get the drawer but only signed-in users that have a BBC ID and are either connected to Facebook and/or twitter will see their networks' activity

Referring back to FIG. 4 the main or ‘home’ page of the interactive media player system comprises the following elements:
A set of Drawers:
   1. Featured
   2. For You
   3. Most Popular
   4. People/(Friends)
A set of Components:
   5. TV Channels
   6. Categories
   7. ‘Promo’ or promotional panel (for advertising particular media content or media player features)
   8. Favourites

Table 1 indicates the data sources used to populate the various elements (drawers and components) of the user interface.

TABLE 1

| | | Data source |
|---|---|---|
| Drawers | | |
| 1 | Featured | Dynamite |
| 2 | For You | Data comes from Dynamite via the Recommenda- |
| | | tion Engine or backfills with BBC selected content |
| | | (including in cases of outage) |
| 3 | Most Popular | Dynamite |
| 4 | People | Data comes from SNeS Activity Service. Only |
| | | appears if user has iD account and follows other |
| | | users |
| Components | | |
| 5 | Channels | Dynamite |
| 6 | Schedule | Category data comes from Dynamite. My |
| | | Categories data is personalised and comes from |
| | | KV Store |
| 7 | Promo | Dynamite |
| 8 | Favourites | This is on every page |

These various elements respond to user interaction (for example mouse hover-over, click-selection and activation) as described in the following table (Table 2):

TABLE 2

| No. | Title | Action | Details |
|---|---|---|---|
| 1 | Discovery | None | Contains 2 (minimum), 3 or 4 (maximum) drawers, |
| | Module | | based on user's interaction with the iPlayer site; on |
| | | | first visiting the iPlayer, the user would only see |
| | | | “Featured” and “Most Popular” drawers; “For You” |
| | | | depends upon the user having interacted at least |
| | | | once with the iPlayer site; “Friends”/“People” |
| | | | depends upon the user having registered and |
| | | | signed in to the system, for example with an identity |
| | | | on BBC ‘Spaces’ |
| 2 | Featured | Click | Displays 1 large thumbnail in default state |
| | Drawer | | |
| 3 | For You | Click | Expands “For You” drawer to expose extended |
| | Drawer | | content; collapses other drawers to display drawer |
| | | | title (only) in vertical orientation |
| 4 | Most | Click | Expands “Most Popular” drawer to expose extended |
| | Popular | | content; collapses other drawers to display drawer |
| | Drawer | | title (only) in vertical orientation |
| 5 | Friends/ | Click | Expands “Friends”/“People” drawer to expose |
| | People | | extended content; collapses other drawers to |
| | Drawer | | display drawer title (only) in vertical orientation |
| 6 | TV | Click | Navigates to TV Schedule page with selected |
| | Channels | | channel active |
| | Module | | |
| | Title | | |
| 7 | TV | Click | Displays logos for all TV channels at all times; by |
| | Channels | | default, TV channels are not editable, whereas radio |
| | Logos | | channels are (other embodiments allow for either or |
| | | | both to be editable) |
| 7.1 | Selected TV | Click | Updates contents of module for selected TV |
| | Channel | | channel, including On Now and Schedule; selected |
| | | | channel is shown with white border/glow, while non- |
| | | | selected channel logos are dimmed-back slightly |
| 8 | On Now | Click | Navigates to Simulcast Item page with selected item |
| | | | playing |
| 9 | Up/Down | Click | Vertically scrolls TV schedule carousel |
| | Chevrons | | |
| 10 | Schedule | Click | Clicking on an individual show takes user to Item |
| | Detail | | page for selected show; available shows are |
| | | | distinguished as available in white text with |
| | | | available rollover state; shows that are unavailable |
| | | | are displayed in grey text |
| 11 | Show Full | Click | Navigates to TV Channel Full Schedule page with |
| | Schedule | | selected TV channel active |
| | Button | | |
| 12 | Categories | Click | As in Radio, with content specific to TV |
| | Module | | |
| 13 | Promo | Click | Optional in layout; can take up full width of column |
| | | | below Categories module |

FIG. 5 shows the (content) item page of the user interface. This page is presented to the user when a media item is selected, for example by the user clicking on the associated thumbnail. As can be seen, the item page presents a main image representing the media content being accessed and a number of subcomponents and drawers, including:
1. Embedded Media Player (EMP)
2. Episode detail and actions component
3. More/Elsewhere Component
4. More Episodes Drawer
5. For You/More Like This Drawer

Table 3 indicates the data sources used to populate the various elements of the item page. Reference is made to the following:
CTA are ‘calls to action’ ie. essentially user-activated processes
Fuse is a Java application running in the Forge Application Layer (api). Forge is a dynamic web application development platform under which applications can be developed various computer languages used for web development including Java, PHP, Perl and HTML.
‘Promotes’ are items a user has specifically recommended; the Promotes component can feed in recommendations from Friends onto an item page
SNes id the social networking service
The Recommendation Engine is a service which acts to improve the quality of recommendations; whenever a user adds a brand (ie. multiple series and special editions) to their favourites list the brand PID is passed to the Recommendation Engine so that it can be used to factor into producing recommendations with higher technical relevance to each user. Favourite programmes indicate affinity more strongly than plays.
A ‘brand’ refers to the entirety of media content under a particular programming banner, spanning series and including for example special editions.

TABLE 3

| | | Data source |
|---|---|---|
| 1 | EMP | Data to serve video comes from Dynamite. EMP is served from |
| | | broadcaster's servers. EMP configuration is served from iPlayer |
| | | PAL application itself. |
| 2 | Episode detail | Episode detail comes from Dynamite. |
| | and actions | Recommend button gets data and posts to the SNeS |
| | | Promotes Service, and posts comment data to DNA. |
| | | Favourite CTA posts data to Fuse. |
| | | Download and Download Future Episodes buttons post |
| | | information to the installed iPlayer Desktop. Download |
| | | windows media CTAs talk to Media Selector. |
| 3 | Elsewhere | Dynamite |
| 4 | ‘More’ | Dynamite |
| | Episodes | |
| | Drawer | |
| 5 | ‘For You’/ | Data is served from the Recommendation Engine via Dynamite |
| | ‘More Like | |
| | This’ Drawer | |

The item page presents the user with a number of possible (calls to) action(s) represented by icons of the following form:
[symbol] Recommend
‘Link to this’
[symbol] Favourite
[symbol] Download

As explained later, the ‘Favourite’ action is only available if the media item has not previously been made a ‘favourite’; if it has, the replacement action is appropriately:
X Delete from Favourites

Alternative embodiments may substitute alternative icons, for example ‘+’ for ‘ [symbol] ’.

Recommendations made by the ‘For You’/‘More like This’ drawer on the item page are based solely on the media item being viewed (ie. the media item's metadata). This contrasts with the ‘For You’ drawer associated with behavioural-based recommendations which appears on the main home page and is described in detail below.

FIG. 6 shows the components involved in generating the item page. The player front end component assembles the item page from data obtained from metadata associated with user-defined ‘favourites’, episode details, category information and social recommendations.

### User Interface Aspects

The following sections discuss various user interface aspects of the interactive media player relating to content discovery, navigation and access to functionality including:
Drawers elements
Categories component
Overlays
Pop-out media player (radio console)

Drawers

FIG. 7 shows the drawer elements (and specifically the ‘Featured’ drawer) of the user interface.

The drawers concept provides a more user-friendly alternative to the traditional drill-down menu structure. In particular, drawers present content in a significantly less hierarchical way, avoiding overwhelming the user with long lists of content and reducing the need for a user when browsing content to repeatedly be required to return to an originating position in order to get their bearings. Instead, drawers expand and contract bringing content in and out of user focus in a natural way for exploring a large volume of media content.

Generally, the drawers may be considered as content panes within a content selection region. Each content pane is capable of displaying thumbnail images (or other such indicium) representative of media content and by which means the content may be accessed (for example via a hyperlink).

When a user opens a drawer (for example by clicking an activation area of the drawer, such as the drawer label) it expands (or contracts) to reveal further (or fewer) thumbnail links to content; simultaneously, the other drawers contract from (or expand into) the space occupied (or vacated) by the expanded (contracted) drawer. A drawer has three states: fully-open, partially-open (the default state) and closed. A typical display for an open drawer comprises a single dominant thumbnail (selected for relevance, novelty or according to some other criteria) and several subsidiary thumbnails. Alternatively, all thumbnails may be similarly sized.

For the convenience of the user, drawers are marked with expansion/contraction indicators in the form of arrow indicators ‘>’ and ‘<’ to aid location of the drawer activation areas. Where the number of items available within a single window exceeds the available screen area, a multi-spot menu is also provided to allow easy navigation between successive screens of the single window.

Closing a drawer returns it (and all others) to the default partially-open state.

As a further feature to encourage content discovery, drawers are configured to present content in a ‘taster’ mode in their default partially-open state, presenting a sample of content (for example, content which may be available shortly or which is perceived to be generally popular or of interest. Once content is played additional content is exposed to users in individual drawers so that users can browse based on their mood.

Drawers import their constituents using PHP on the server or JavaScript on the client. This allows generic drawer content to be cached while personalised content is loaded dynamically.

In the example shown in FIG. 7, the following drawers are presented to the user:
‘Featured’—comprises editorial selections of media
‘For you’—comprises personal recommendations according to the user's media ‘footprint’
‘Most Popular’—self-evidently, the currently most popular items of media content
‘Friends’ (in some embodiments referred to as ‘People’)—social recommendations (from the user's friends), either received as an individual recommendation or as a broadcast from a friend via a social network

The number of drawers displayed to a user is based upon the user's state and behaviour:
A new user who has never played any of the available media content is presented with only two drawers: ‘Featured’ and ‘Most Popular’;
An Active user who has played at least some media content is presented with four drawers: ‘Featured’, ‘Most popular’, ‘For you’ and a generic social drawer ‘People’ drawer
An Active user signed-up to ‘flow’ (ie. logged-in to the media player system user database and to a social network) is presented with four drawers: ‘Featured’, ‘Most popular’, ‘For you’ and a personalised social elements ‘People’

Referring back to FIG. 7, the properties of the ‘Featured’ drawer are further described in Table 4.

TABLE 4

| No. | Title | Action | Details |
|---|---|---|---|
| 1 | Featured | Click | Displays a minimum of 5 editorialised/featured |
| | Drawer | | programmes; screen layout includes 1 larger thumbnail, |
| | (Expanded) | | 4 medium thumbnails and corresponding programme |
| | | | details, with further detail available in the hover state |
| 2 | Header Hit | Click | Top of module from left edge to right edge, including |
| | Area | | “Featured” title and arrow and space in-between; from |
| | | | default state, clicking arrow once expands drawer to state |
| | | | shown at left and collapses other drawers to display |
| | | | drawer title (only) in vertical orientation; clicking a second |
| | | | time collapses drawer to default state and returns other |
| | | | drawers to default states |
| 3 | Item | Mouse over | Displays hover state |
| | Thumbnail | | |
| 4 | Programme | Click | Includes thumbnail, programme title (up to 2 lines) and |
| | Detail | | episode title (1 line maximum, if longer it is truncated); |
| | (Medium | | both programme title and episiode title are clickable and |
| | Thumbnail) | | navigate to item page with selected item queued in play |
| | | | mode |
| 5 | Programme | Click | As above; additionally allows for up to 3 lines for |
| | Detail (Large | | programme summary, which is static text/not clickable |
| | Thumbnail) | | |
| 6 | Paging | None | Dots and arrows are used as paging mechanism and |
| | | | represent the number of pages of available content in this |
| | | | drawer; number of pages is varied and based on how |
| | | | many items BBC chooses to editorialise for this drawer |
| | | | (minimum of 1 screen is required, or 5 items); maximum |
| | | | 4 dots or 4 pages of content |
| 6.1 | | Click | When a paging dot is clicked, the existing content of the |
| | | | Featured drawer fades out replaced by the next ‘page’ of |
| | | | content which fades in |

FIG. 8 shows the components involved in generating the drawer elements. It can be seen that the ‘Featured’ (known as ‘Highlights’ in some embodiments), ‘For You’ and ‘Most Popular’ drawers are all generated from media content metadata stored in Dynamite; the ‘Friends’ (‘People’) drawer is distinct in taking its information feed from social networking activity,

FIG. 9 shows details of the ‘For You’ drawer; the properties of the ‘For You’ drawer are further described in Table 5.

TABLE 5

| No. | Title | Action | Details |
|---|---|---|---|
| 1 | For You | Click | Displays minimum of 8 programmes recommended by |
| | Drawer | | the Recommendation Engine; screen layout includes 8 |
| | (Expanded) | | medium thumbnails and corresponding programme |
| | | | details, with further detail available in the hover state |
| 2 | Header Hit | Click | Top of module from left edge to right edge, including For |
| | Area | | You title and arrow and space in between; from default |
| | | | state, clicking arrow once expands drawer to state shown |
| | | | at left and collapses other drawers to display drawer title |
| | | | (only) in vertical orientation; clicking a second time |
| | | | collapses drawer to default state and returns other |
| | | | drawers to default states |
| 3 | Item | Mouse over | Displays hover state |
| | Thumbnail | | |
| 4 | Programme | Click | Includes thumbnail, programme title (up to 2 lines) and |
| | Detail | | episode title (1 line maximum, if longer it is truncated); |
| | | | both programme title and episode title are clickable and |
| | | | navigate to item page with selected item queued in play |
| | | | mode |
| 5 | Paging | None | Dots and arrows are used as paging mechanism and |
| | | | represent the number of pages of available content in this |
| | | | drawer; number of pages is varied and based on how |
| | | | many items BBC chooses to recommend for this user; |
| | | | maximum 4 dots or 4 pages of content |
| 5.1 | | Click | When a paging dot is clicked, the existing content of the |
| | | | For You drawer fades out replaced by the next ‘page’ of |
| | | | content which fades in |

FIG. 10 shows the components involved in generating the ‘For You’ drawer.

FIG. 11 shows details of the ‘Most Popular’ drawer; the properties of the ‘Most Popular’ drawer are further described in Table 6.

TABLE 6

| No. | Title | Action | Details |
|---|---|---|---|
| 1 | Most | Click | Displays minimum and maximum of 15 programmes, |
| | Popular | | determined as top 15 most popular; screen layout |
| | Drawer | | includes 15 small thumbnails and corresponding |
| | (Expanded) | | programme details, with further detail available in the |
| | | | hover state the top ten most popular shows; content does |
| | | | not scroll/page |
| 2 | Header Hit | Click | Top of module from left edge to right edge, including |
| | Area | | Most Popular title and arrow and space in-between; from |
| | | | default state, clicking arrow once expands drawer to state |
| | | | shown at left and collapses other drawers to display |
| | | | drawer title (only) in vertical orientation; clicking a second |
| | | | time collapses drawer to default state and returns other |
| | | | drawers to default states |
| 3 | Item | Mouse over | Displays hover state |
| | Thumbnail | | |
| 4 | Programme | Click | Includes thumbnail, programme title (up to two lines) and |
| | Detail | | episode title (1 line maximum, if longer it is truncated); |
| | | | both programme title and episode title are clickable and |
| | | | navigate to item page with selected item queued in play |
| | | | mode |
| 5 | Paging | None | Does not exist in Most Popular; content does not scroll in |
| | (Missing) | | this drawer, so there is no need for paging mechanism to |
| | | | be presented to user |

FIG. 12 shows the ‘Friends’ or ‘People’ drawer of the user interface; the properties of the ‘People’ drawer are further described in Table 7.

TABLE 7

| No. | Title | Action | Details |
|---|---|---|---|
| 1 | Friends/ | Click | Displays activity stream from the user's friends |
| | People | | associated with ‘Spaces’, including media items and |
| | Drawer | | related activities including ratings, comments; time-based |
| | (Expanded) | | showing friend with latest activity at top of drawer; a |
| | | | minimum of one friend or activity is displayed (as this |
| | | | drawer does not appear until the user has a ‘Spaces’ |
| | | | account, a minimum of one friend, and said friend has |
| | | | begun an activity on iPlayer); screen layout can include |
| | | | up to five small thumbnails and corresponding |
| | | | programme details, with further detail available in the |
| | | | hover state |
| 2 | Header Hit | Click | Top of module from left edge to right edge, including |
| | Area | | Friends title and arrow and space in-between; from |
| | | | default state, clicking arrow once expands drawer to state |
| | | | shown at left and collapses other drawers to display |
| | | | drawer title (only) in vertical orientation; clicking a second |
| | | | time collapses drawer to default state and returns other |
| | | | drawers to default states |
| 3 | User Icon | Click | |
| 4 | Item | Mouse over | Displays hover state |
| | Thumbnail | | |
| 5 | Programme | Click | Includes thumbnail, programme title (up to 2 lines) and |
| | Detail | | episode title (1 line maximum, if longer it is truncated); |
| | | | both programme title and episiode title are clickable and |
| | | | navigate to item page with selected item queued in play |
| | | | mode |
| 6 | Paging | None | Dots and arrows are used as paging mechanism and |
| | | | represent the number of pages of available content in this |
| | | | drawer; number of pages is varied and based on how |
| | | | many items BBC chooses to recommend for this user; |
| | | | maximum 4 dots or 4 pages of content |
| 6.1 | | Click | When a paging dot is clicked, the existing content of the |
| | | | Friends drawer fades out replaced by the next ‘page’ of |
| | | | content which fades in |

In alternative embodiments, other user interface elements—such as the channel list—may also be presented in drawer form. Other embodiments may implement some or all features described herein as drawers as components and vice versa.

Categories

FIG. 13 shows the user interface to the ‘Categories’ module. This module enables a user to have media content filtered according to subject matter (as defined by categories and sub-categories) and displayed at the forefront of the user interface, thereby providing another way for the user to navigate and discover content in the interactive media player system. Generally, a mix of the most popular and the most recent content will ‘bubble to the surface’ of the category listing.

In the example shown, the Categories interface presents two larger thumbnails for the two most popular media items in the category, and five smaller thumbnails for the otherwise five most recent media items.

Initially, on first use, the Category module presents a pre-filtered ‘taster’ of latest media content sorted according to subject matter (eg. latest film/news/entertainment) in order to provide an example of how the interface may be used. By providing a large number of sub-categories, finely-tuned category preferences may be selected by a user. For example, the ‘Entertainment’ category comprises some 20 different sub-categories, with over 200 categories in total in the whole site. Categories may be specific to content, or be specific to particular themes or grouping of content. Some duplication is to be expected as some media items will span categories or otherwise prove difficult to categorise in a way which will ensure they nevertheless are found by a searching user.

The user is encouraged to build up a list of favourite categories; the pre-loaded taster categories are then pre-populated by these second level categories, the results of which are presented to the user on the home page. The user can identify favourite categories and assign them to a ‘My Categories’ menu so that when the user consults the Category pages the first categories seen are the user's favourite categories.

Category information may be stored locally (by a cookie) or remotely according to user ID.

Table 8 indicates the data sources used in the various elements of the Categories page.

TABLE 8

| | | Data source |
|---|---|---|
| 1 | Category navigation component | Dynamite |
| 2 | Add to My Categories CTA | data is posted to KV Store |
| 3 | Category Details | Dynamite |

FIGS. 14 and 15 show further views of the ‘Categories’ interface (including the full Category management interface, which includes the option for a user to add a Category to the user's ‘My Categories’ list); the properties of the ‘Categories’ component are further described in Table 9.

TABLE 9

| No. | Title | Action | Details |
|---|---|---|---|
| 1 | Categories | Click | Loads the default view of this page with All Categories/Latest |
| | Page Title | | highlighted in the navigation |
| 2 | All TV | Click | Displays dropdown menu for user to filter the selected |
| | Channels | | category by TV channel |
| 3 | Add to My | Click | Combines selected category and sub-category and saves as |
| | Categories | | custom category to user's “My Categories” (This is populated |
| | | | across TV and radio but does not use channel/station as a |
| | | | filter); as feedback, My Categories label in left hand navigation |
| | | | and the label of this button flashes pink, a tick replaces the |
| | | | plus symbol and the label reads “Added to My Categories”; |
| | | | button now fades to a state where the label reads “Remove |
| | | | from My Categories” and the tick symbol becomes an “x” - |
| | | | this whole process takes 1-3 seconds |
| 4 | My | None | Only visible and available if the user has added a category to |
| | Categories | | My Categories |
| 4.1 | | Click | Expands in an accordion effect to reveal the full list of |
| | | | categories the user has made favourite; favourite categories |
| | | | can be top-level (e.g. Comedy), secondary level (e.g. |
| | | | Comedy/Satire) |
| 5 | All | Click | Accordion header that expands contents, including: Latest, |
| | Categories | | Children's, Comedy, Documentaries, Drama & Soaps, |
| | | | Entertainment, Films, Learning, Lifestyle and Leisure, Music, |
| | | | News & Current Affairs, Religion & Ethics, Sport; first item in |
| | | | All Categories, “Latest” is a smart default to be shown as |
| | | | selected when a user lands on the categories page without the |
| | | | page having a selected category to display |
| 6 | Top-Level | None | May or may not have sub-categories |
| | Categories | | |
| 6.1 | | Click | Toggles expanded and collapsed states to reveal sub- |
| | | | categories (if available) using a slide-up and slide-down |
| | | | animation style |
| 7 | Sub- | None | Sub-categories are indented and are suffixed with the number |
| | Categories | | of items in that category; this number does not change when |
| | | | the user engages the TV Channel selector (bullet point 2) |
| 8 | Accessibility | Click | Accordion expands contents to reveal: Sign zone, Audio |
| | | | described |
| 9 | Regional | Click | Accordion header that expands contents, including: Northern |
| | | | Ireland, Scotland, Wales |
| 10 | Most popular | Click | Three images for the 3 most popular images in this |
| | thumbnails. | | category/subcategory. If all 3 images cannot be provided (eg. if |
| | | | there are not enough programmes) then this page contents |
| | | | below should move up to fill this space. |
| 11 | Order By | Click | Sorts item list Alphabetically or Chronologically with Most |
| | | | Recent at top of list |
| 12 | Paging | Click | Pages directly to specific page or use “Next” or “Previous”; |
| | | | appears at top and bottom of list |
| 13 | Most Popular | Click | |
| 14 | Title Rules | None | In collapsed view, at brand level, 1 programme displays |
| | | | including programme title (allowed up to 2 lines), episode title |
| | | | (limited to 1 line) and summary (allowed up to 2 lines); in |
| | | | expanded view, reveals only episode title in white (clickable, |
| | | | limited to 1 line), as additional episodes are nested under the |
| | | | brand, so brand does not need to be repeated alongside every |
| | | | episode |
| 15 | Expand/ | None | Collapsed state displays 1 programme, including thumbnail |
| | Collapse | | and programme information, and how many more episodes |
| | Series | | there are, eg: “8 more” with arrow at left of the number, and |
| | | | pointing to the right (toward the number) |
| 15.1 | | Click | Toggles to expanded state, using slide-up and slide-down |
| | | | animation style, revealing full list of associated programmes; |
| | | | arrow turns arrow 90 degrees to point downward |
| 16 | List Item | None | Labels for list items to indicate when item is a FILM or |
| | Labels | | available in HD (identical to labels at newest version of: |
| | | | bbc.co.uk/tv/); these are labels only, not interactive |
| 17 | Item On Now | None | Label to indicate when an item is available in simulcast |
| | | Click | Navigates to Simulcast page with selected item playing |
| 18 | [Selected | Click | Takes user to Radio categories page for the selected category. |
| | Category] | | This box will not appear if there are no results. |
| | On Radio | | |

Overlays

FIG. 16 shows the overlay elements of the user interface. Overlays are mini contextual icon menus (implemented in a combination of Flash and HTML) which appear in the user interface when the user performs a ‘mouse-over’ action on a page element.

Typically, overlays are used directly on items of media content rather than on navigation items, and present to the user only a small subset of actions or functions (typically two to four) from all those possible, the intention being to present the most common actions in a non-hierarchical menu. For example, a media item overlay in drawers and list views provides the user in situ with the ability to play, (add to the) favourite (list), download and recommend the media item.

FIGS. 17 to 19 show the overlay elements in respectively the ‘Featured’, ‘For You’ and ‘Most Popular’ drawers and in FIG. 20 in the ‘TV Channels’ component.

Typical icons indicating the various functions available are as follows:
[symbol] Favourite

|> Play
[symbol] Recommend
[symbol] Download/Pre-book
X Delete from Favourites

Overlays appear for both collapsed and open drawers—in principle overlays could be added to almost all content list views.

Ideally, essentially the same overlay functions are provided for all similar media items (subject to the actions being possible, functionality and resources permitting).

Different overlay types are possible according to the size of the associated media item thumbnail.

In some instances overlays present multiple alternatives, for example for downloading media items different resolution or encoding versions (for example for desktop and portable device playback) are presented by separate download icons.

For certain media items particular overlay functions may be absent when the associated function is not possible. For example, the option to download a TV programme (or of a podcast for radio) may not be possible, for example for rights reasons; the overlay download symbol in that case is either greyed out (or similarly de-highlighted) or absent entirely. Similarly, the ‘Favourite’ icon is present and actionable (and the ‘Delete from Favourites’ is not) only until such time as an item is added by a user to the ‘Favourites’ list (at which point it is replaced by the ‘Delete from Favourites’ icon).

The operation of the overlay CTAs are described in detail in the following tables:

Table 10 describes the overlay CTAs generally:

TABLE 10

| No. | Title | Action | Details |
|---|---|---|---|
| 1 | Schedule CTA | None | Hover state includes up to 2 lines of text, programme |
| | Hover State | | broadcast time and CTAs to favourite or download item |
| | | Click | Clicking anywhere other than either on the Favourite or |
| | | | Download icon navigates to the item page with selected |
| | | | item queued in play mode |
| 2 | Add to | Click | Adds selected programme series to Favourites; if |
| | Favourites | | Favourites module is in collapsed state, feedback that |
| | | | item has been added is shown in total number of items |
| | | | increasing by 1 with animated glow; if Favourites module |
| | | | is in expanded state, validation that item has been added |
| | | | follows the above, as well as adding thumbnail to module |
| | | | at far left inside of carousel (new item pushes existing |
| | | | item thumbnails in Favourites tray to the right) |
| 3 | Download | Click | Downloads item to iPlayer Desktop (by default) or for |
| | | | device as defined by user in Settings |

Table 11 describes the CTAs for Drawers (small version)

TABLE 11

| No. | Title | Action | Details |
|---|---|---|---|
| 1 | Small CTA | Click | Clicking the item thumbnail or the title or episode name |
| | Hover State | | navigates to the item page with this item queued in play |
| | | | mode |
| 2 | Add to | Click | Adds selected programme series to Favourites; if |
| | Favourites | | Favourites module is in collapsed state, feedback that |
| | | | item has been added is shown in total number of items |
| | | | increasing by 1 with animated glow; if Favourites module |
| | | | is in expanded state, validation that item has been added |
| | | | follows the above, as well as adding thumbnail to module |
| | | | at far left inside of carousel (new item pushes existing |
| | | | item thumbnails in Favourites tray to the right) |
| 3 | Download | Click | Downloads item to iPlayer Desktop (by default) or for |
| | | | device as defined by user in Settings |
| 4 | Programme | None | Includes thumbnail, programme title (up to 2 lines), |
| | Information | | episode title (1 line maximum, if longer it is truncated), |
| | | | and up to 2 lines of programme summary; both |
| | | | programme title and episode title are clickable and |
| | | | navigate to item page with selected item queued in play |
| | | | mode |

Table 12 describes the CTAs for Drawers (medium version)

TABLE 12

| No. | Title | Action | Details |
|---|---|---|---|
| 1 | Medium CTA | Click | Clicking the item thumbnail or the title or episode name |
| | Hover State | | navigates to the item page with this item queued in play |
| | | | mode |
| 2 | Add to | Click | Adds selected programme brand to Favourites; if |
| | Favourites | | Favourites module is in collapsed state, feedback that |
| | | | item has been added is shown in total number of items |
| | | | increasing by 1 with animated glow; if Favourites module |
| | | | is in expanded state, validation that item has been added |
| | | | follows the above, as well as adding thumbnail to module |
| | | | at far left inside of carousel (new item pushes existing |
| | | | item thumbnails in Favourites tray to the right) |
| 3 | Download | Click | Downloads item to iPlayer Desktop (by default) or for |
| | | | device as defined by user in Settings |
| 4 | Programme | None | Includes thumbnail, programme title (up to 2 lines), |
| | Information | | episode title (1 line maximum, if longer it is truncated), |
| | | | and up to 2 lines of programme summary; both |
| | | | programme title and episode title are clickable and |
| | | | navigate to item page with selected item queued in play |
| | | | mode |
| 5 | Add to | Mouse over | Display hover state on item mouse over |
| | Favourites | | |
| | Feedback | | |
| 5.1 | | Mouse over | Cursor hovers the Favourites icon and the icon turns pink |
| 5.2 | | Click | User clicks Add to Favourites icon, icon changes to a |
| | | | tick, and remains pink while the cursor is hovering it |
| 5.3 | | Mouse out | Hover state disappears, the tick remains but is now white |

Table 13 describes the CTAs for Drawers (large version)

TABLE 13

| No. | Title | Action | Details |
|---|---|---|---|
| 1 | Large CTA | Click | Clicking the item thumbnail or the title or episode name |
| | Hover State | | navigates to the item page with this item queued in play |
| | | | mode |
| 2 | Add to | Click | Adds selected programme series to Favourites; if |
| | Favourites | | Favourites module is in collapsed state, feedback that |
| | | | item has been added is shown in total number of items |
| | | | increasing by 1 with animated glow; if Favourites module |
| | | | is in expanded state, validation that item has been added |
| | | | follows the above, as well as adding thumbnail to module |
| | | | at far left inside of carousel (new item pushes existing |
| | | | item thumbnails in Favourites tray to the right) |
| 3 | Download | Click | Downloads item to iPlayer Desktop (by default) or for |
| | | | device as defined by user in Settings |
| 4 | Programme | None | Includes thumbnail, programme title (up to 2 lines), |
| | Information | | episode title (1 line maximum, if longer it is truncated), |
| | | | and up to 3 lines of programme summary; both |
| | | | programme title and episode title are clickable and |
| | | | navigate to item page with selected item queued in play |
| | | | mode |

Pop-Out Media Player (Radio Console)

FIG. 21 shows the pop-out media player user interface. In this example the pop-out media console is implemented as a radio console, although in an alternative embodiment a similar pop-out media console for live and/or on-demand video content is provided.

The pop-out radio console provides a compact satellite module which the user can use to listen to audio content as a background or companion activity whilst doing other things, for example using other applications. Being fully-integrated with the interactive media player system website offers users much of the same functionality, (albeit in a smaller form factor) for example the ability to add favourites, to recommend and play programmes. In addition, the user can edit the radio stations and these changes are reflected on the main site.

The pop-out radio console makes use of overlays to provide roll-over channel/programme information.

As space for the pop-out console user interface is limited, quick access to different console views is provided by a series of user-selectable tabs (or alternatively, drawers). In this embodiment, four tabs are provided:
‘Playing’—which shows information regarding the currently selected media item; overlays provide additional options such as favourite, recommend and a ‘go to website’ link
‘Favourites’—provides a miniature interface to a feed from the favourites module including a list of favourite media items and the option to manage the favourites list.
‘For You’—recommended media content based on the metadata of the currently selected media item
‘Stations’—a list of available radio stations, overlays showing the ‘now playing’ information for each station and, on selection of a particular station, the console presenting a miniature ‘now/next’ programme listing

Data sources for the tabs are as shown in table 15

TABLE 15

| | Data source |
|---|---|
| ‘Playing’ | EMP data is fed via the page from Dynamite |
| | Currently playing episode data is fed from Dynamite |
| | Favourite CTA posts data to Fuse |
| | Recommend CTA posts data to SNeS Promotes service |
| ‘Favourites’ | Data is fed from Dynamite Favourites service. |
| ‘For You’ | Data is fed from Dynamite Recommendations feed |
| ‘Stations’ | Favourite stations are stored in KV Store. Station |
| | metadata is fed from Dynamite ION feed |

The ‘stations’ tab also presents an ‘Edit stations’ option. A post-code lookup application such as Postcoder to determine local radio stations for the user and these are offered as options for selection. The data for this form is fed from Dynamite and favourite stations are stored in KV.

### Favourites

FIG. 22 shows various aspects of the ‘Favourites’ user interface as provided by the ‘Favourites’ module or component, including the ‘Favourites’ toolbar, the toolbar in its expanded view, the ‘Favourites’ management page and an example of the ‘Favourite’ function in an overlay.

The ‘Favourites’ component allows for a user of the interactive media player system to personalise their experience by providing a way for them to store bookmarks to particular media items or content for later revisiting.

The system thus comprises means for enabling a user to add particular (media) content items to a user-defined content list, or ‘Favourites’ list (for example by the user executing a suitable CTA such as making use of the ‘Favourite’ icon in an overlay). The ‘Favourites’ module thus acts as a virtual shopping basket or playlist, that is, a companion module that discretely follows the user around the site and a console where favourite programmes are parked to be available to play later, effectively providing quick access for the user to their preferred media items by means of a ‘Favourites’ toolbar which is a persistent item in the user interface throughout the media player site (in the example as shown, in the top right hand corner of each media player page). The user is therefore never more than a click or two away from their preferred media content.

While there is no requirement a user is signed-in to the media system service, doing so allows the user's Favourites to follow them across different PCs, phones etc (otherwise a local cookie is set and the particular Favourites only apply to that specific device).

By marking a media item as a favourite, the user is effectively subscribed to that item and can be kept informed of relevant developments. For example, if the user subscribes to a series (or, more comprehensively, a ‘brand’ which includes multiple series and special editions), the Favourites module is automatically updated (and can notify the user) when new episodes of the same brand or series are made available. The Favourites module also allows users to bookmark content ahead of the time of transmission (commonly referred to as ‘TX’). Where rights restrictions impose media availability limitations (for example, on-demand access or download viewing permission only for a certain time window), the Favourites module can track the availability of the media item and notify the user of content that is about to expire from the availability window.

The ‘Favourites’ module presents two different views to the user according to whether it is in ‘compact’ or ‘expanded’ mode (a mouse click toggles between the two via suitable drop-down/pull-up animated effects).

In the compact state, the Favourites module provides the following summary information:
the total number of items on the Favourites list
the number of new items on the list
the number of items on the list about to expire

The Favourites module also generates a Favourites management page; a link to access this is provided from the Favourites toolbar.

FIG. 23 shows the ‘Favourites’ toolbar in its expanded state. This presents the user's Favourite playlist as a series of thumbnails in the form of a ‘carousel’ which the user can advance backwards and forwards in order to locate the desired content.

FIG. 24 shows the components involved in updating the user ‘Favourites’. In essence, information regarding ‘Favourites’ is stored on the Dynamite database (the index of all media content items) and the Favourites component interacts with Dynamite via Fuse. Favourites are stored against a user's BBC_UID or Identity ID by means of storing, for each available content item, the identity of a user that has added that particular content item to that user's Favourites or content item list. Updates to the Favourites playlist involve data being passed from the iPlayer front end (the client application or web browser) via Fuse to Dynamite.

FIG. 25 shows the components involved in generating the ‘Favourites’ playlist user interface. As previously, Favourites data is pulled from Dynamite. In addition, information regarding the most recently played media items is also obtained for inclusion on the playlist (potentially identified as ‘recently played’ items). Also shown are interactions with additional PHP libraries to support user identity and authentication services.

FIG. 26 shows the ‘Manage Favourites’ page of the user interface. This provides further detailed information and allows multiple operations to be performed by a user on their Favourites (TV/radio items being presented via separate tabs), including:
information on when an item was added
information on when an item is due to expire (an alert is triggered when less than 24 hours remain; alternative embodiments provide such an alert by, for example, email, IM or SMS)
adding brands or series determined from single items
removing favourites, either individually or at ‘brand’ level
sorting and filtering, including by brand, by series, individually and also according to novelty and/or expiry (including within a time window)
listing immediately available content only
downloading some or all items, including pre-booking

Subscribed to items are automatically added to the list when they become available; expired items are automatically removed.

FIG. 27 shows the components involved in generating the ‘Manage Favourites’ user interface.

Various further features of the Favourites module are described under the following heads:

Default Summary View/Closed State

For a new user that has never played content, has deleted cookies and/or is not signed-in, the carousel just below the top navigation bar is presented in its closed state.

In the closed default state visible attributes include:
Count of total items (zero), count of new items (zero), Count of expiring items (zero)
In open state an introductory video to be available upselling (ie. promoting to the user) the benefits of Favourites
Manage button takes user to manage favourites page
Favourites title—Clicking title opens carousel in situ
Optionally, a small “What's this?” flag is presented, which includes a tool-tip or lightbox explaining the benefits of Favourites

For an existing user with populated content, summary mode attributes include:
Count of total items—clicking link opens carousel in default view with last played episode in position 1 and the latest series (based on most recently available on demand series episode as opposed to longest availability) to the oldest availability. Total count is TV or radio centric depending on which page the carousel resides in
Count of new items clicking link opens carousel in new items view with position 1 being the latest episode in the latest series
Count of expiring items—clicking link opens carousel in expiring items mode with position 1 being the shortest availability
Manage button takes user to manage favourites page
Favourites title—Clicking title opens carousel in situ

Default Ordering
Last played item which still has rights availability is in first position which is at episode level, followed by the most recently added series with availability

Number of Items
Six items displayed per carousel. Clicking left and right arrows reloads six items at a time; Optionally, up to 1000 episodes can be made available (with current availability)

Series Level
All carousel views are at series level, with the episode level image of the highest numbered episode displayed. Where a programme does not have series level data available the brand is used for grouping

Multiple Episodes
Indicator shows where multiple episodes are available for the same brand/series.

Clicking more episodes unrolls all available episodes associated with that brand/series and filters out all other brands and series from the carousel. Closing the episodes reloads carousel to previous view.

Brand Level (Optional)
All rollups are at brand level as opposed to series

Last Played
Last played added into ‘Favourites’
Expired items will no longer appear in the favourites carousel
Only the last played asset which is currently available is displayed in the carousel. Clicking the item takes the user to the item page and plays item from the resumption point in page

Played Indicator (Optional)
In the carousel a played indicator is shown under the episode thumbnail

Reordering
No user reordering of the carousel positioning; alternative embodiments may allow user re-ordering.

Positioning on Site
Carousel is closed on page load.
Carousel closes upon clicking play CTA in the item page
Favourites carousel is available on TV homepage, radio homepage and item pages, search, categories, channel pages and full screen EMP in iPlayer

Full Screen Mode
The carousel is available in the EMP in full screen mode. This is in playlist mode showing the all series view. At the conclusion of playout of a programme in full screen mode, the carousel opens with the next programme brand highlighted ready to play; the last played programme is displayed in the first position as per the website functionality.

TV and Radio Modes
The Favourites playlist is displayed contextually depending on the type of page the user is currently accessing. For example, the Favourites playlist has both TV and Radio modes (for TV and Radio Favourites, respectively) and the appropriate mode is displayed according to whether the user is currently on a TV- or a radio-related page. For pages with mixed TV and radio content the mode is determined according to that last used according to a value stored in a cookie.
Episodes are separated in all views including the Manage Favourites page, with the option for users to add episodes and then refresh the page and context.

Syndication
Default position is within iPlayer only; alternatives. Alternatively, syndication of favourites.

CTAs from Favourites
Play—user can click play and plays item in item page
Download user can download the programme where available directly from the favourites carousel
More/less—expands and contracts series/brands and episodes
In an alternative embodiment, Manage—user can delete the individual episode or whole brand directly from the carousel, which in turn automatically updates the manage favourites page

Episode Availability
Only episodes with current on demand availability to be available in the carousel.
In an alternative embodiment, expired favourites to be available in manage favourites page, based on the container object added as a favourite.

Content Population
Only items played or added Favourites at brand (in alternative embodiments, at series or episode) level are to be added to the carousel (not personalized recommendations etc)

Content Availability (in Alternative Embodiments)
Only playable content available in carousels

Audio Described and Sign Zone
Favourites are displayed at episode level in the playlist and manage page. Clicking on the episode takes the user to the original version of the programme. User can then navigate to the signed or audio described version by clicking on the link in the item page.
A user can favourite on the AD or signed item page, the user however needs to be made aware that by default they are actually making a favourite of the original version in the user interface.
In an alternative embodiment, there is an option in settings page to favourite the AD or signed version by default on a best endeavours basis
In further alternative embodiments, Favourites exclude signed and audio described versions unless the user has explicitly added this version from the item page or accessibility category, or has set up a preference in manage preferences.

HD Format
User cannot favourite the HD version specifically unless the programme is not available or commissioned in any other format. Favourite CTA to be shown on HD assets, the user however is always directed to the SD where they can then link to the HD page by clicking the CTA.
In alternative embodiments, HD versions to be excluded unless a user has explicitly added the HD version from the BBC HD channel schedule list or item page.

Adding Favourites CTA
Favourites are stored on the server regardless of whether a user has an identity account.
If not registered a user will lose all their favourites if they delete cookies.
Identity—Users with identity will be able to access their favourites on multiple machines.
Users will be advised by upsell (ie. promotional) messages across the site to sign in.

New Items Rule
Any item will show in new items that has been added to the Favourites in the past 24 hours, regardless of whether or not a user has already visited the site in this timeframe.
In alternative embodiments, any item will show in new items that has been added to the favourites since the user last arrived at /iplayer on that particular PC, and include current session time. If a user is logged into identity favourites needs to be intelligent not to show the same items twice in the new state that has already been viewed whilst logged into another machine

Expiring Items Rule
Any item will show in expiring items that is due to expire in the next 24 hours, regardless of whether or not a user has already visited the site in this timeframe.
In alternative embodiments, any item will show in expiring items that is due to expire in the next 24 hours, that has been added to the favourites since the user last arrived at /iplayer on that particular PC. If a user is logged into identity favourites needs to be intelligent not to show the same items twice in the expiring state that has already been viewed whilst logged into another machine.

New Content
New content needs to be updated dynamically for expiring and newly added episodes.

Expired items
Expired episodes are excluded from the carousel.

Rollover States
Delete episode—allows user to delete episode from the carousel
Delete series/brand—allows user to delete all current and future episodes from the same series/brand. Automatically updates in manage favourites page
Display full container episode title and synopsis
Streaming window remaining availability
Download CTA
Play CTA

Images
Image thumbnail at brand or episode level (same image as displayed on item page)

Simulcast
When the episode is available in simulcast (ie. simultaneously available via another medium) for TV or Radio this should be indicated in the carousel. A different visual treatment is used to differentiate the simulcast episode from the on demand asset.

Favourites Repeats Rules
When adding all episodes the default rule is that all first run available episodes and future episodes are automatically added the carousel (optionally, and for auto downloads)

Table 16 describes the CTAs for the Favourites Module

TABLE 16

| No. | Title | Action | Details |
|---|---|---|---|
| 1 | My | Click | Arrow next to “My Favourites” title toggles expanded and |
| | Favourites | | collapsed states of the Favourites module - expanded |
| | Module | | reveals tray with media content and collapsed reveals |
| | | | only 1-5 as described here |
| 2 | Total Items | Click | Filters tray to display all items that have been added and |
| | | | not yet watched |
| 3 | New Items | Click | Filters tray to display only items that have been recently |
| | | | added |
| 4 | Expiring | Click | Filters tray to display only items that are expiring soon; |
| | Items | | displayed by expiry date/time in ascending order |
| 5 | Manage | Click | Navigates to the Manage Favourites screen |
| | Button | | |
| 6 | Last Played | Click | Always positioned at far left in tray when user has filtered |
| | Item | | tray to “Total Items” or if item is relevant when user filters |
| | | | “New” or “Expiring”; only 1 “Last Played” item displays at |
| | | | a time; takes user to Item Page with item queued in play |
| | | | mode from point at which last viewing ended |
| 7 | Brand Title | None | Brand title displays above each small item thumbnail |
| 8 | Episode | None | If more than 1 episode for a brand, there is an episode |
| | Stack | | stack |
| 8.1 | | Click | Expands the stack to view all episodes |
| 9 | Episode | None | Episode titles display below each small item thumbnail in |
| | Stack | | maximum of 1 line (exception to standard titling rules) |
| | Expanded | | |
| 10 | Close Stack | Click | Collapses stack to original state displaying only 1 small |
| | | | item thumbnail, hiding episode title and displaying the |
| | | | number of episodes in the stack |
| 11 | Item | Click | Navigates to the item page with the selected item queued |
| | Thumbnail | | in play mode |
| | | Mouseover | Hover state appears to provide further programme |
| | | | information (2 lines for title, up to 3 lines for the |
| | | | summary) and play button; favourites button removes the |
| | | | item from favourites, download button downloads the |
| | | | episode according to the default download format defined |
| | | | in settings; first use default download setting is iPlayer |
| | | | Desktop; clicking navigates user to the item page with |
| | | | item queued in play mode |
| 12 | Carousel | Click | Scrolls favourites thumbnails as a carousel on the |
| | Button | | horizontal axis; default action scrolls left or right in groups |
| | | | of 6 items; does not scroll in pixels or by single item; |
| | | | arrow disappears when user reaches end of list at left or |
| | | | right |
| | Default | New Visitor | If the user has not added any items to favourites or |
| | States for | | digested any content, the default state of the Favourites |
| | Favourites | | module is 1 item in the carousel - a thumbnail for an |
| | Module | | upsell or instructional video, which, on click, links user to |
| | | | the item page with item queued in play mode; optional to |
| | | | also have text in module for additional upsell |
| | | Repeat | If user has visited iPlayer repeatedly and digested |
| | | Visitor, No | content, they would have a last played item as their first |
| | | Favourites | item in the Favourites module; the second item in the |
| | | | carousel could continue to be the upsell/instructional |
| | | | video (space permitting, also the text upsell) |

### Social Recommendations

The following section discusses the various means by which a user of the interactive media player system can make and receive recommendations regarding media items.

Recommendations are calculated according to three different processes:
Contextual—based upon metadata and tagging of media items (which may involve editorial decisions and also business rules)
Behavioural—based upon the type of media items the user is playing (and hence the determined user interests)
Social—based upon recommendations from the user's social network (for example from the user's friends on social networking sites)

Contextual and behavioural recommendations have to some extent already been described with reference to the “For You” modules.

The distinction was drawn between recommendations made in the ‘For You/More Like This’ module on the item page (which are contextual, based on the item metadata) and those made in the ‘For You’ drawer on the home page (which are behavioural, and only appear once some media items have been played as the recommendation algorithm requires at least a modicum of data on which to base a recommendation). In this regard, the latter ‘For you’ algorithm is deliberately configured to produce recommendations which are more quirky, preferring programmes which have not already been seen/heard by the user (what might be termed hidden gems).

In summary, contextual recommendations concern the media item, not the user directly (hence ‘More’ may suggest more items from the same brand); recommendations based on behavioural traits are based on a user profile which has been built up, for example, from the user's favourite media item categories and the types of (other) programme usually associated with (this) programme (hence a user category ‘cars’ may suggest another category ‘boats’).

Regarding social aspects of recommendations, the ‘Most popular’ drawer may be considered effectively to provide anonymous recommendations.

However, the main source for social recommendations is the ‘People’ drawer, some aspects of which (such as its absence if the user is not signed-in, and its persistence across subsequent signed-in sessions) have been described previously.

There are two key aspects to social recommendations: generating and receiving.

Generating Social Recommendations

FIG. 28 shows examples of social recommendation generation interfaces, including:
a simple ‘Recommend’ button indicator (as found associated with a media item on its item page)
a recommendation comment entry box
a ‘Recommended’ status display
a ‘Link to this’ pop-up menu
a recommendation overlay

In order to make a recommendation the user has to be identifiable in some way (if not precisely, at least uniquely) and therefore requires a sign-in ID. The Promotes module (which handles recommendations received from the user) detects whether user has an appropriate ID—and if not, suggests the signs-up.

FIGS. 29 to 31 shows various aspects of the Comment Entry user interface. Comments are implemented as, for example, short messages not exceeding 140 characters. In the event that the interactive media player system provider does not run its own social networking site, comments require a further aspect of user sociability—that they have an account with a third party social network such as FaceBook or Twitter (a confluence described as ‘flow’). The user is prompted to select which social network he wishes to connect to and requested to provide an email address.

For a user being prompted to connect to their social network from within an interactive media player signed-in session for the first time, the user is shown most recent recommendations.

Once connected, use of for example FaceBook connect can then determine which of the user's friends from the social network also have a BBC ID and an editable list of these friends can be automatically created for the convenience of the user—or alternatively merely suggested with a veto option. By default, no email confirmation is issued (the connection to friends on the social network is assumed correct); alternative embodiments provide for confirmation.

The connected social user can then make recommendations and post comments directly to those his friends from the social network (either singly or in user-defined groups) who also possess a BBC ID, and these friends will see the results of these inputs in their media player interface.

When making a recommendation, a signed-in social user will be asked if they wish also to attach a message; if so, the recommendation message will be sent to all friends previously selected.

Social recommendations can be made pre-, post- or during a media item being consumed and are ‘pushed’ to user from friends, not passively read.

For privacy reasons no status updates of viewed media content are provided; alternative embodiments allow this with appropriate user permission.

FIGS. 32 and 33 show various aspects of the Recommend and Review interface in stages of a user signing-in and then connecting to their social network.

FIG. 34 shows the components involved in generating user recommendations, and comments including the interplay between the Promotes, Activity and DNA components, including:
1. The Promote component receiving a recommendation from a user's iPlayer client
2. A user comment being passed to DNA, a database store

Both recommendation and comment are fed back to a users' ‘People’ drawer via ‘Activity’ component.

Essentially, iPlayer will write Comments and Promotes messages to two different services; DNA will write an activity to the Activity service. A promotes message will be delivered to a queue feeding both the Promotes and Activity Service. These are aggregated and read from Activity. To build an item page for those without social network, all activity is read for a PID. iPlayer will link the comment and promote (recommendation) into one item, based on an inferred transaction id made up for identityID, pid and timecode. iPlayer gets total number of promotes for an episode from the Promotes service.

Recommendations may be specific to a media item version type (for example, a HD media file) not merely the media content (say, a particular programme).

Also provided is a ‘Link to this’ option. This allows a signed-in user to email a URL link to (the beginning of) a media item—optionally including a timecode to a particular place in the programme. The posting of actual media clips may not be possible in some embodiments because of rights issues.

Receiving Social Recommendations

The main interface for a user to receive social recommendations is via the ‘People’ drawer (called ‘Friends’ in some embodiments).

As described above, a user can connect with third party social networking providers such as FaceBook and Twitter and ‘seed’ their ‘People’ drawer with their friends (both social networks provide their own dashboards to edit a user's friends).

FIGS. 35 to 39 shows various aspects associated with the ‘People’ drawer, including:
the effect of different sign-in states
an overview of how the user friends appear in the user's People drawer
various options for selecting users and examining their recommendations

The ‘People’ drawer therefore acts as a social inbox on the user's homepage and provides a social barometer of programme recommendations based upon a users social network.

FIG. 40 shows the components involved in generating the ‘Friends’/‘People’ drawer.

### TV/Radio Channels Module

The interactive media player system provides the user several ways to access both live and on-demand media content via different interfaces, including:
TV/Radio channels component
EPG module
Watch Live page

The aim is to provide a unified experience, blending live and on-demand content into a single experience, thereby allowing users to browse and play on-demand and live television and radio programmes from a single destination

TV/Radio Channels Component

FIG. 41 shows the ‘TV/Radio Channels’ component. In the example shown, the component presents the following features:
selectable channel icons listed in a vertical column on the left-hand side
the currently-available live media stream is shown as a main thumbnail
a multi-day, vertically-scrollable programme guide (listing programmes by transmission time for the selected channel) occupies the central location.

Selecting a channel icon displays the vertically-scrollable programme guide for the selected channel. Programme guide for successive days are selectable from a tabbed menu for today and up to three previous days (the schedule is a feed from the Dynamite database). Selecting a media item directly redirects the user to the appropriate item page for the selected media item.

A button option allows the user access to the full electronic programme guide (EPG) or schedule for the selected channel—which is described below.

Examples of user actions for the Channel Changer component are shown in Table 17.

TABLE 17

| No. | Title | Action | Details |
|---|---|---|---|
| 1 | All TV | Click | Displays dropdown menu with all available channels and |
| | Channels | | selected option highlighted in pink |
| 1.1 | | Click | Dropdown menu disappears; selected channel displays |
| | | outside | in collapsed selector |
| 1.2 | | Mouse out | Dropdown menu remains visible until user clicks outside |
| | | | or selects an option. |

CTA's for the Channel Selector are shown in Table 18

TABLE 18

| No. | Title | Action | Details |
|---|---|---|---|
| 1 | Standard | Mouseover | Hover state for a list item; displays play icon over |
| | Item CTA | | thumbnail, brand title, episode title, and programme |
| | | | summary (not to exceed two lines) |
| 1.1 | | Click | Takes user to item page with selected item queued in |
| | | | play mode |
| 2 | On Now List | Mouseover | Hover state for On Now thumbnail; displays play icon |
| | Item CTA | | over thumbnail, brand title, episode title, and |
| | | | programme summary (not to exceed two lines), as well |
| | | | as On Now visual treatment and LIVE label over the |
| | | | item thumbnail |
| 2.1 | | Click | Takes user to simulcast page with selected item playing |

Further aspects include:
Live TV is offered in a single page with a channel changer available in multiple bit rates in page and full screen
70 radio stations available both live and on demand in a radio console which enables users to play, favourite and recommend programmes
UK and online rights restrictions are complied to and messaged to users

Referring back to FIG. 41, also shown is how the channel listing is editable. This is particularly useful when a large number of channels is available (currently especially the case with radio, although increasingly with television also). Channels (or stations) are editable via a widget-like press-and-edit method by means of a element (+) in the icon corner when the list is in edit mode. Up to 15 channels can be added to the list in any order (and can be re-ordered as required). Regional and national stations are provided as immediately selectable additions; other channels may be located via a search box, which includes the facility for locating local stations according to user address eg. postcode. The customised channel listing is stored as a local cookie or, if the user is signed-on, remotely.

EPG Module

FIG. 42 shows the Electronic Programme Guide (EPG) module. This presents a more comprehensive channel and programme schedule listing than the smaller ‘TV/Radio Channels’ component and includes programming for several days' worth of media content, including on-demand content (for streaming or download, subject to availability constraints), live content currently being broadcast and pre-booking of content to be released in the future (currently up to two days ahead). Overlays operate to provide the user with rapid access to common features such as adding to Favourites and downloading.

The EPG can be switched by the user to show the programming for different channels by selecting the channel from the selectable channel icons listed in a vertical column on the left-hand side. As for the ‘TV/Radio Channels’ component, this listing is user-configurable.

An ‘On Now’ thumbnail is also presented which directs the user to the ‘Watch Live’ (Siimulcast) page.

‘Watch Live’ Page (Simulcast)

FIG. 43 shows the ‘Watch Live’ page. The central embedded media player is bordered by a (optionally scrollable) list of television channel icons. As the user mouses-over (or points to, highlights or otherwise indicates) the channel icons a preview of ‘what's on now/next’ is presented. Clicking (or otherwise activating) a channel icon changes channel—thus the user can easily browse live content channel-by-channel.

A ‘For you’ module presents recommendations of on-demand programs which have consumption pattern links to current programme.

Table 19 shows examples of possible actions for Simulcast ON Air.

TABLE 19

| No. | Title | Action | Details |
|---|---|---|---|
| 1 | Channel | none | Enables the user to flip between BBC channels to view |
| | Navigation | | live broadcasts |
| 1.1 | | Click | Reloads page for selected channel |
| 2 | Channel On | Mouse over | Hover state for item “On Now” presents programme title |
| | Air | | (up to 2 lines) and episode title (limited to 1 line title) |
| | | | and up to 5 lines for summary; channel icon changes to |
| | | | the thumbnail for the live show |
| 2.1 | | Click | Reloads simulcast page for selected channel |
| 2.2 | | Mouse out | Hover state disappears |
| 3 | Programme | None | Displays On Now label and timeslot of show currently |
| | Information | | being broadcast, programme and episode title, |
| | (Collapsed) | | programme summary and actions; option for expanded |
| | | | view also displays complete programme synopsis; |
| | | | Broadcast on, First Broadcast on, Last Broadcast on, |
| | | | (related) Categories, Available until, Duration, Cast List |
| 4 | Programme | Various | As on standard item page: Recommend, Tell a Friend, |
| | Actions | | Favourite and Download; Favourite and download |
| | | | create a Pre-Download or Pre-Favourite state for the |
| | | | live item; HD is not available as an option in Simulcast |
| 5 | On Next | None | Programme information about the show playing next on |
| | | | selected channel |
| 6 | More of this | None | As in standard item page |
| 6.1 | | Click | Navigates to the item page for the selected item |
| 7 | Recommended | None | As in standard item page |
| 7.1 | | Click | Navigates to the item page for the selected item |
| 8 | Licence Notice | None | Text notice to remind viewers that a licence is required |
| | | | to watch live TV from the BBC |

Table 20 shows examples of possible actions for Simulcast OFF Air.

TABLE 20

| No. | Title | Action | Details |
|---|---|---|---|
| 1 | Channel Off | Mouse over | Channel icon remains in hover state; information |
| | Air | | occupies Title element stating when the channel will |
| | | | return to air. hover state presents channel logo, the label |
| | | | indicating channel is currently OFF AIR and text |
| | | | indicating when the channel will return to ON AIR state |
| 1.1 | | Mouse out | Hover state disappears |

FIG. 44 shows further aspects of the ‘Watch Live’ page, including the introduction of social aspects such as comments and recommendations.

### Instant Messaging Service

A further social aspect of the interactive media player system involves the integration with an instant messaging system (IMS) such as MSN Messenger or Windows Live Messenger provided by Microsoft® or some other instant messaging (IM) provider or facility (for example, that provided within FaceBook®).

FIGS. 45 to 48 show various aspects of the Instant Messaging Service messaging user interface; further aspects are shown in FIGS. 49 to 54.

Utilising the messaging backend as a plug-in into the iPlayer enables IM features (for example the messaging interface and the IM contacts list) to become an integral part of the media player client. This allows for features such as:
Collaborative viewing is enabled by users setting up an instant messenger network which follows the user around the site
Users can “shout” messengers to all users on their network (optionally, those currently using the iPlayer)—or a user-defined subset thereof—with comments and invitations to watch the same on-demand or live programme.
Each shout displays the currently played programme and the time-code so that friends can join and watch from the same point (the time-code may be provided as a text or direct link)
Separately, users can then open a one-on-one chat window to discuss the programme using the chat invitation
Ability to select a friend (or a group of friends) to see what they are viewing
Provision of a progress bar to indicate how much of the media item friends have watched already
Alerts to indicate a common interest of an individual friend or group of friends in a particular media item

In order to maintain privacy, some of these features are preferably limited by user-set restrictions and the messaging system is operated on an opt-in basis.

A further embodiment integrates the messaging system as a module pervasive across the media player interface, much like the Favourites module.

Various further aspects of the instant messaging service are now described with reference to FIGS. 49 to 54.

FIG. 49 shows the promotion or ‘up-sell’ of the instant messenger service to users for a) live streamed and b) on-demand content via a “Get started” (or similarly worded) button. In embodiments where the IM service pervades throughout the media player interface further promotions are presented elsewhere.

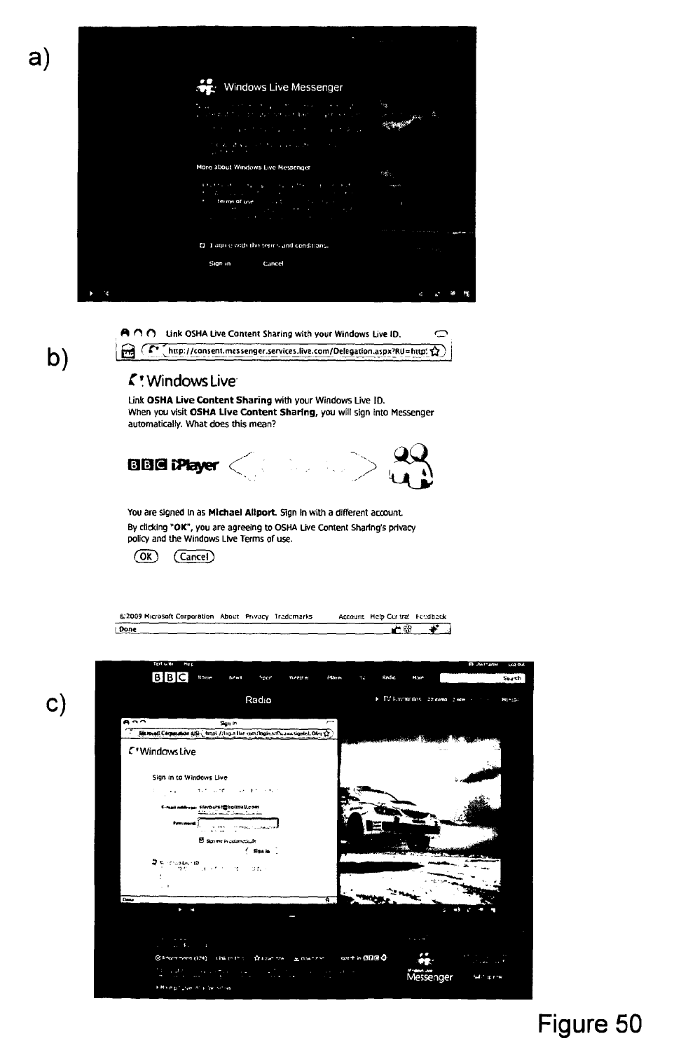

FIG. 50 shows various screens presented to the user during the IM sign-in process. In this embodiment, separate sign-in screens are presented in turn by each of the interactive media player system and the instant messaging service.

For a user who has not previously signed-in to the IM service preliminary information and agreement/consent screens are presented. Where the IM service is provided by a third party and not the entity which provides the interactive media player system, suitable disclaimers are presented to inform the user of the differing areas of responsibility.

FIG. 50 a) shows the IM service terms and conditions agreement screen. The user is required to agree to the terms and conditions before being allowed to proceed with the sign-in process.

FIG. 50 b) shows the information sharing consent screen. The user is alerted that information will be shared between the interactive media player system and the instant messaging service and is required to provide consent to this before proceeding with the sign-in process.

FIG. 50 c) shows the IM service sign-in screen presented once the user's agreement/consent has been received—or for a returning, previously signed-up user.

Once the user has signed-in to the IM service standard IM service facilities are provided, for example the facility for a user to report abuse via the IM service provider's report abuse page.

Access to the IM service (as for all media player functions including restricted play according to age- or content-related media categorisation) can be controlled via parental control mechanisms.

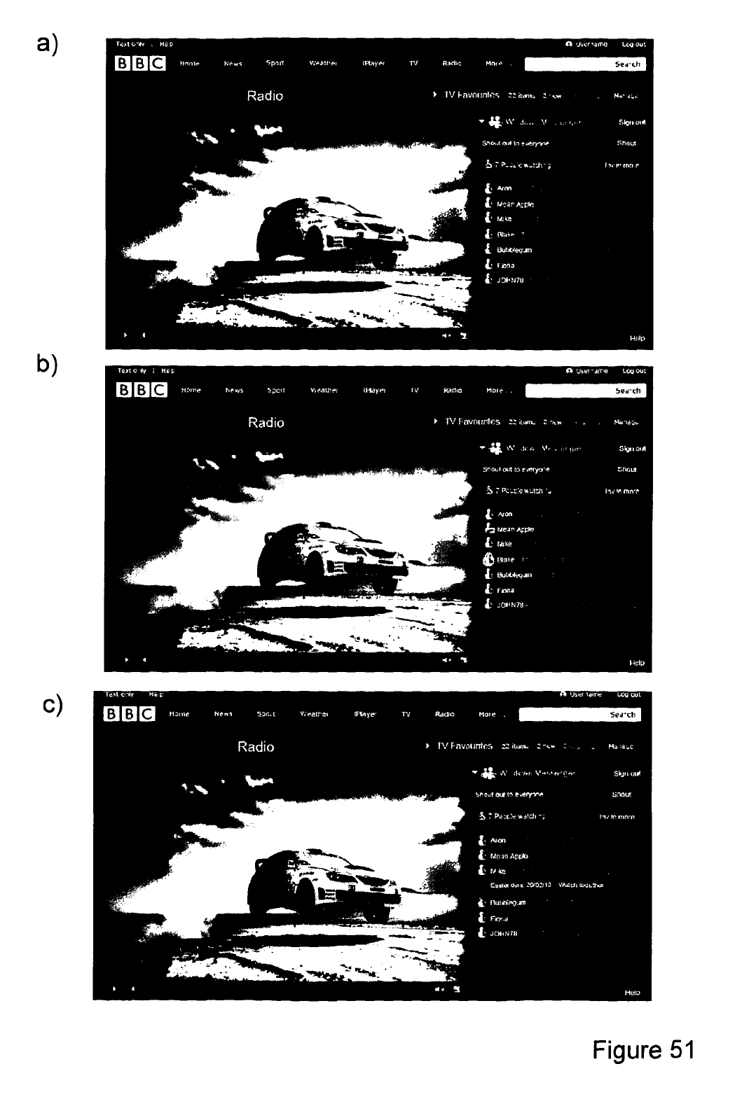

FIG. 51 show the instant messaging (IM) service interface in use. The IM system interface is integrated with the interactive media player system interface as an expandable panel, menu or drawer.

FIG. 51 a) shows the interface seen by a signed-in user. The display shows identifiers or icons representing those of the user's friends or IM contacts currently both signed into the interactive media player system and to the IM service. The IM contacts' most recent comments (or summary extracts thereof) are shown alongside their IM contact or user names. Recent comments are shown in bright or otherwise highlighted text; as comments age they fade or are otherwise de-highlighted so that the user's attention is drawn to the most recent comments. Options are provided (for example by means or a directly-accessible text entry box and ‘shout’ button) for the user to ‘shout’ or message all (or in, some embodiments, pre-defined subsets of) the currently listed contacts and/or to invite other users not currently signed-on to do so.

FIG. 51 b) shows the notification system which highlights most recent IM contacts comments. In this example, a user (Blake) has recently (within a predetermined time interval) posted a comment—or is in the process of commenting—and the accompanying IM contact identifier is itself highlighted in order to attract the attention of the user.

FIG. 51 c) shows additional detail presented to the user when the user ‘mouses-over’ or otherwise selects an active IM contact. In this example, subject to the IM contact having set the appropriate permissions, a programme identifier is presented to indicate the programme currently being watched by the selected IM contact (alternative embodiments also display how far through watching the programme the IM contact is). Adjacent the programme identifier is a ‘Watch together’ button which provides a link to the identified programme by means of an underlying URL of the form:
http://bbc.co.uk/i/7tr91/

The programme identifier and the underlying URL of the ‘Watch together’ button are updated either periodically or in response to a triggering event such as selection by the user of a different IM contact or the selected IM contact switching to watch a different programme. In some embodiments the updates form part of IM messages passed between IM contacts or be separate updates provided via the IM service.

The ‘Watch together’ button allows the user (by means of the underlying URL) to watch the same programme as the one or more selected IM contact(s).

In some embodiments, the programme identifier itself offers additional functionality, for example providing a separate link to the specific programme or to the home page of the programme series.

For live streamed or broadcast content, selecting ‘Watch together’ sets the user's media player to present the currently streamed or broadcast media content; for on-demand content, the user's media player is first synchronised with that of the selected IM contact so that the user and selected IM contact can watch the on-demand content simultaneously. This synchronisation process is described below.

‘Watch together’ may therefore be considered as a facility which reintroduces with on-demand media the communal media experience of the traditional broadcast era i.e. essentially provides synchronised video-on-demand.

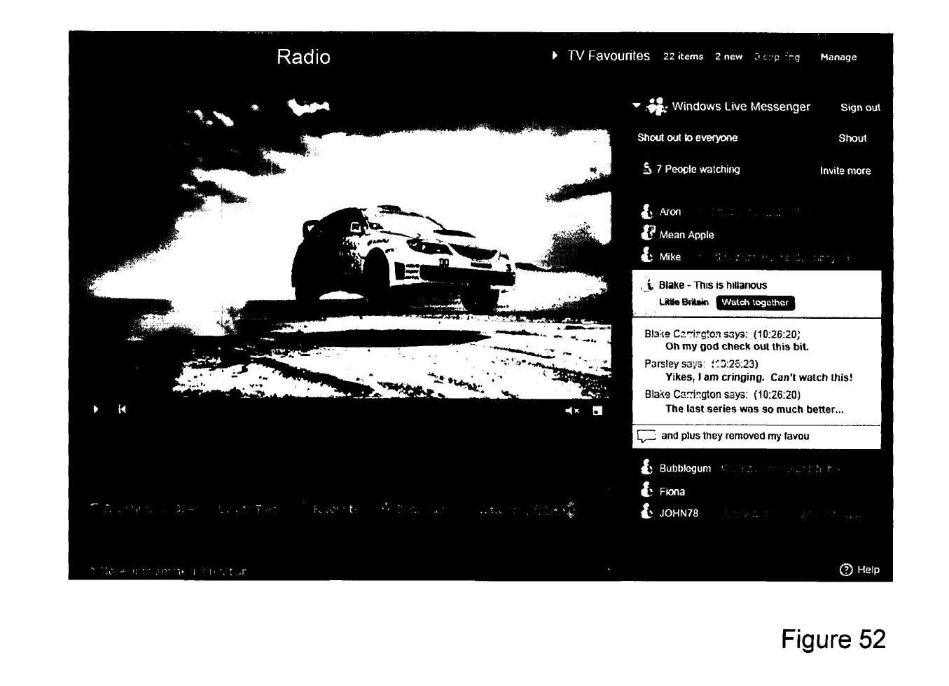

FIG. 52 shows the IM interface being used for a two-way IM session between the user and a selected IM contact. The IM session proceeds in a standard way with alternate messages from user and IM contact being displayed in sequence.

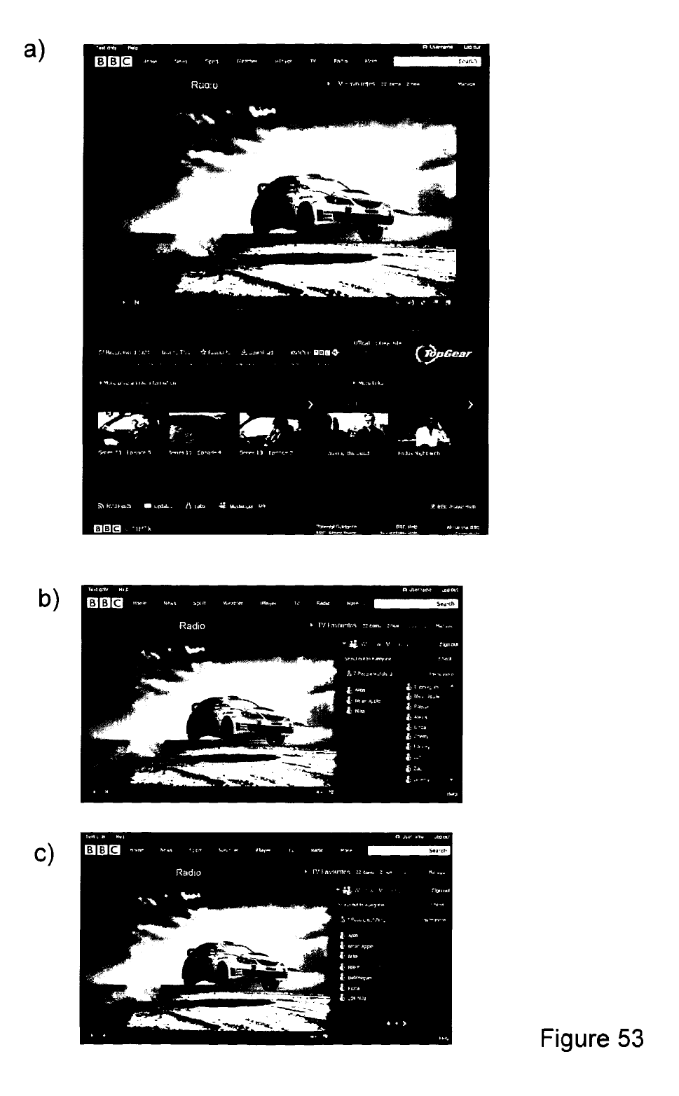

FIG. 53 shows various other aspects of the IM interface.

FIG. 53 a) shows an IM status bar located at the interface footer. This provides a quick sign-on/off activation facility to allow ease of access to the IM service during a user session and/or throughout the media player system website or application. Alternative embodiments provide information such as, for example, the number of the user's IM contacts currently signed-in and notifications.

FIGS. 53 b) and c) show examples of alternative methods (respectively, a scrollable menu and a dot-paging mechanism <•o•>) for providing user access to a plurality of signed-in IM contacts when their number exceeds the amount of available display area to display them all simultaneously.

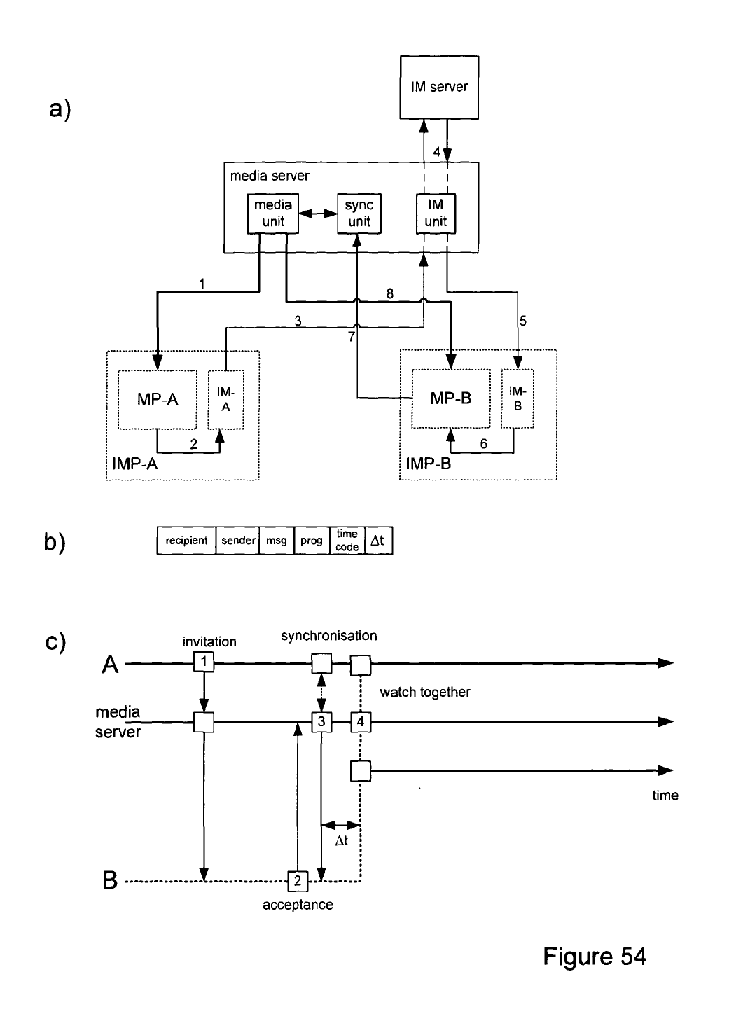

FIG. 54 show an example of synchronisation in the ‘Watch together’ feature. Users A and B of the interactive media player system are both signed-on to the IM service. Their interactive media player interfaces (IMP-A and IMP-B respectively), which may be presented via a website accessed from or an application running on a user device, each comprise a media player interface (MP-A and MP-B, respectively) and an IM interface (IM-A and IM-B, respectively).

FIG. 54 a) shows an overview of the process when user B activates the ‘Watch together’ feature:
1. User A is currently watching via media player IMP-A an on-demand programme streamed from the media unit of a media server of the interactive media player system
2. User A comments on the programme via the IM interface IM-A
3. The IM message is relayed via the IM unit of the server of the interactive media player system to the IM server.
4.1M server processes the IM message for delivery from user A to user B
5. The IM message is relayed from the IM server via the IM unit of the media server to the IM interface IM-B of user B. The IM interface of user B (IM-B,), displays an icon for user A together with, when user B selects user A, a programme identifier to indicate the programme user A is watching and a ‘Watch together’ button.
6. When user B selects ‘Watch together’, the underlying URL and (optionally) a timecode and (also optionally) offset Δt are passed to the media player IMP-B of user B.
7. Media player IMP-B of user B requests the appropriate programme media from the media unit of the media server (optionally via the sync unit of the media server).
8. The appropriate programme media is streamed to media player MP-B of user B (optionally, for on-demand media, synchronised to the media content being enjoyed by user A)

The programme identifier is in the form of a URL link to (the beginning of) the programme or media item—optionally (for example for on-demand programmes) including a timecode (for example a numerical value representing elapsed seconds) appended to this URL to provide a link directly to a particular place in the programme. A possible form for the programme identifier and timecode is:
http://bbc.co.uk/i/7tr91/?t=8s
indicating a point 8 seconds (t=8s) into the programme.

The (optional) offset Δt is to allow for a delayed synchronisation to account for network timing delays to ensure users A and B watch the programme simultaneously. Rather than attempt to have user B immediately attempt synchronised viewing of the programme with user A, joint viewing is arranged to commence at a time Δt in the future to allow, for example, for sufficient buffering of streamed content at user B to occur. For low latency networks, for example, Δt will tend to zero and synchronised viewing can begin effectively immediately.

In alternative embodiments, the IM unit of the server of the interactive media player system is absent and IM messages are transmitted ‘directly’ between users A and B i.e. via the IM server rather than relayed via the media server.

FIG. 54 b) shows elements which make up the IM message payload at various stages when also being used to provide programme information, including:
recipient—user address identifier (in the example, user B)
sender—user sender identifier (in the example, user A)
msg—IM message text
prog—programme identifier, for example a URL
timecode (optional)—time elapsed of the media programme currently being watched by user A
Δt (optional)—offset for synchronisation of media streaming to users A and B

FIG. 54 c) shows a timeline of the ‘Watch together’ process showing users A and B with respect to the media server:
1. invitation—user A invites (for example, by means of an IM message) user B to ‘Watch together’
2. acceptance—user B accepts user A's invitation and activates the ‘Watch together’ button
3. synchronisation—user B's acceptance of the invitation triggers a synchronisation process
4. watch together—users A and B watch the programme together

The acceptance of step 2 may occur some time after the initial invitation has been sent, hence the need for a following synchronisation step.

As shown, two options are possible for the synchronisation of step 3. The first involves synchronisation being accomplished entirely at the media server. The second requires polling of user A's media player MP-A, for example to the ascertain time elapsed of the media programme currently being watched by user A.

In some embodiments, information is provided via each user's media player and/or IM interface regarding the status of the other users participating in a ‘Watch together’ session, for example, whether users have paused or terminated their ‘watch together’ session. A user who has paused their ‘watch together’ session may subsequently re-activate the session by means of the ‘watch together’ button thereby re-synchronising with the other users participating in the ‘watch together’ session.

In some embodiments, user B's activation of the ‘Watch together’ option essentially cedes control of user B's media player for the duration of the programme (or until user B disengages from the ‘Watch together’ session) to user A. Thus, for example, when watching together an on-demand programme were user A to pause, play, fast-forward or rewind the corresponding operations would be carried out (where possible) by user B's media player.

Further embodiments provide the IM messaging facility and ‘Watch together’ option for other types of media, for example audio (where the latter option may be called ‘Listen together’).

Media Selector/Pre-Booking Traffic management

The interactive media player system is provided with a pre-booking feature, an implementation of which will now be described, by way of example only, with reference to FIG. 55, which illustrates the pre-booking feature in overview.

The pre-booking feature is a function of the interactive media player system which allows a user to download (media) content in advance of transmission ‘TX’ (i.e. in advance of the time/date when the content is to be transmitted, broadcast or aired), and to store it locally to the equipment used to access the interactive media player system, without allowing that content to be played until after it has been transmitted.

This feature is particularly beneficial for scenarios in which a user would find it more convenient to download a content item in advance of it being aired, for example to avoid the need to download it later via a more expensive and/or technically limited connection (e.g. if the user wishes to watch the item whilst travelling in another country). The feature is also particularly useful for scenarios where a user would wish to download a series of related content items (e.g. episodes in a series of programmes) as and when each content item become available for download.

As seen in step 1 on FIG. 55, in order to pre-book (or ‘pre-download’) content a user first locates the content, using the media client to find the content by means of the content discovery system and metadata store (e.g. substantially as described previously). The user then makes a request to pre-book the located content. This effectively initiates transmission of a request to download the located content to the access control system. FIG. 56 shows the associated user interface in terms of an item page with a series pre-booking (“Download future episodes”) and download options.

As seen in step 2 on FIG. 55, in response to the request, the media selector of the access control system assesses whether the request is valid (e.g. whether it is syntactically correct), whether the requested content is available, and whether the request should be allowed or denied based on traffic management needs at the time the request is received. If the request is valid, the content is available, and the request is deemed to be allowable then the media selector of the access control system locates a suitable media asset associated with the requested content in the content distribution network (CDN), generates a link (for example a URL) to that media asset and provides the generated link to the media client of the user making the request.

It will be appreciated that each item of content may have any suitable number of media assets associated with it, for example, a low definition media asset, a hi definition media asset etc.

If the media selector determines that the pre-booking request should be denied then the download request is rejected, optionally with an indication of a time after which the media client can re-attempt making a request for pre-downloading the same content. The media client may re-attempt making this request automatically (for example in accordance with a pre-defined polling cycle) or may make this request when the user initiates it.

As seen in step 3 on FIG. 55, once the media asset has been located and the link provided, the media client fetches (downloads) the media asset to the user's equipment (ie. the client device). At this stage, however, the user's equipment does not have a license to play the downloaded media asset (to view the associated media content) and, accordingly, until that license is acquired, the media asset cannot be played on the user's equipment.

When a user wishes to view the content with which the media asset is associated, the media client determines whether a suitable licence is held and, if not, it requests the licence from the licence server. As seen in step 4 on FIG. 55, when the licence request is made the digital rights management system determines whether the licence request should be allowed or denied and respectively issues or withholds a license to play the content on the media client accordingly. For example, if the licence request is made before transmission (i.e. ‘TX’) of the content with which the media asset is associated the licence request will generally be denied and the license withheld. Similarly, if the licence request is made after the content with which the media asset is associated has been transmitted the licence request will generally be allowed and the license issued.

It will be appreciated that, once downloaded, the media asset can beneficially be transferred to a different piece of user equipment (e.g. from a computer having a high speed internet link to a mobile communications device potentially having an inferior, or simply more expensive, internet link) and the licence request may be made via a version of the media client on that different piece of user equipment (as shown in FIG. 1). The license can then be obtained later (typically requiring only a small data transfer compared to download of the media asset itself) after it becomes available.

Operation of the media selector: to assess the availability of the content, and the validity and allowability of the request; and to notify the media client accordingly will now be described in more detail.

In response to a pre-booking request, the media selector determines the allowability of the request using a predetermined formula based on configurable weighting factors which represent traffic management requirements for different times of day on a given date (as described below). If the request is allowed the media selector returns a media asset location for a requested content item. If the request is denied based on the predetermined formula, the media selector returns a response to the media client, indicating a time period which the media client is required to wait before reattempting the request. The media client is required to wait until this time period has elapsed before requesting the same resource again.

The communication with the media client is made in accordance with a pre-booking application programming interface.

In this implementation, a predetermined weighting factor representing a traffic management requirement at each time of day on a particular date is stored in a table. The granularity of this table is 15 minutes (although it could be higher or lower independence on requirements—e.g. between 5 minutes and 30 minutes). Accordingly, for each 24 hours there are 96 values each representing the traffic management requirement for a respective 15 minute period, and there are 672 values representing the traffic management requirements for the 672 15 minute periods in a given week. It will be appreciated that the granularity may, in itself, vary in dependence on the time of day and/or date.

The weighting factor is a percentage value which effectively indicates the likelihood that a download request within that period will be allowed (i.e. will result in a response providing the download location for an appropriate media asset associated with the requested content). Thus, the value of the weighting factor can be between 0 and 100 with a value of 0 for a given time period indicating that all pre-booking requests made during that time period should be denied (e.g. because it is expected that demand will be so high that pre-booking downloads should be prevented to maximise the bandwidth available for other users). The weighting factors are reconfigurable and, in this example have a default value of 100 (although it will be appreciated that they may have default of any suitable value).

A global flag ('global_disable_flag) is also provided which, if set (e.g. has a value of ‘1’ or ‘TRUE’), disables pre-booking requests completely (e.g. by causing the media selector to deny all requests). The global flag is reconfigurable and, in this example, is by default not set (e.g. has a value of ‘0’ or ‘FALSE’).

The media selector uses the following traffic management algorithm to determine if the media client's pre-booking request will be allowed or denied:

```
if ( global_disable_flag = true )
  then
  deny
  else
    if ( weighting_factor(time_of_day) = 0 )
    then
    deny
  else
    if ( random(100) <= weighting_factor(time_of_day) )
    then
      allow
    else
      deny
    fi
  fi
fi
```

Thus, when pre-booking is enabled and the weighting factor is not zero, after each pre-booking request, the media selector generates a random (or pseudo-random) number and compares this to a weighting factor retrieved for the time of day (on a particular date) at which the request is received. If the generated number is less than (or equal to) the retrieved weighting factor the media selector deems that the request should be allowed and returns the associated media asset location accordingly.

Otherwise, if pre-booking is disabled, the weighting factor is zero, or the generated number is greater than the retrieved weighting factor, the media selector deems that the request should be denied and returns a response indicating this to the media client. The response indicating that the request has been denied includes an indicator that no bandwidth is available (no_bandwidth) and a time stamp offset (in a recheck_after parameter) defining how long the media client has to wait before being allowed to request the same content resource again.

The time stamp value is reconfigurable and, in this example, has a default value of 60 minutes (although it will be appreciated that this may be any suitable value). The timestamp may, for example, be an ISO 8601 timestamp using the universal coordinate (UTC) system—for example, in the format 2009-12-31T23:42Z). Preferably, the time stamp indicates an offset at least 5 minutes after the time the pre-booking request was received. To avoid a proliferation of non-allowable pre-booking requests, the time stamp value is advantageously set to coincide with the start of a time period (e.g. the next time period) for which the weighting factor is non-zero. For example, if the current, and the next two 15-minute time periods are configured with a weighting factor of zero, the time stamp is set to indicate that a pre-booking re-attempt should be made at least 30 minutes (and possibly as much as 45 minutes) in the future.

The media selector is also operable to allow a request if it is made within a predetermined ‘grace’ period before transmission (‘TX’) of the content to which it relates. The grace period is reconfigurable and, in this example, has a default value of three hours (although it will be appreciated that this may be any suitable value). Similarly, the media selector is also operable to allow a request if it is made after transmission (‘TX’) of the content to which it relates.

The weighting factors may be stored in any suitable form, for example in a dedicated document in a key-value store, in a database or the like. It will be appreciated that there may be an algorithm for calculating the weighting factor, for example, based on a known or estimated current demand (e.g. live traffic and/or performance statistics). Similarly, the grace period and/or the time stamp offset may be stored in any suitable form, for example in a key-value store, a database or the like.

The media selector is also operable to issue various error responses in the event that the pre-booking request is deemed to be invalid or the content to which the request relates is found to be unavailable or not to exist. These responses include, for example:
An error response indicating the content to which the pre-booking request relates is unavailable when the content does not exist or is unavailable. This may, for example, be because a license to play the content will not be made available in the geographical location from which the pre-booking request is made—in which case this error response is sent to the media client, effectively blocking the download.
An error response indicating the pre-booking is invalid if the pre-booking request is found to be syntactically incorrect.
An error response indicating the pre-booking is invalid if a counter in the pre-booking request is found to be outside a predetermined range.

In the event that a media client continues to make many repeated pre-booking request for the same content which are then denied based on the traffic management algorithm, the media selector eventually allows the request without requiring the traffic management algorithm to be passed. This may be achieved by any suitable means for example by reference to a counter which records the number of unsuccessful requests made for the same content via a particular media client.

It will be appreciated that, media assets may be available for download up to several days before broadcast and one of the intentions of the pre-booking support is to assist management of the traffic in relation to downloading these assets.

In one specific example, the media selector is configured to use managed token issue service (MTIS) responses to implement the above, for example, the various possible responses may be issued, and the associated parameters configured, as follows:
A ‘normal’ MTIS response (allowing download) is returned if the request is to be allowed or if the time at which the pre-booking request is processed is TX minus 3 hours or later (e.g. if the availability start time is less than 3 hours in the future or already in the past).
An MTIS error response with the ID notavailable is returned if the requested media asset does not exist or is not available (e.g., because of the GeoIP check, or because the PID is not in the cache).
An MTIS error response with the ID invalid_auto_request is returned if the request was syntactically incorrect.
An MTIS error response with the ID invalid_auto_counter is returned if the counter value in the request is outside of the range 1-65536, or not an integer value.
An MTIS error response with the ID no_bandwidth and a recheck_after parameter is returned if the request was valid and for an available media asset, but denied based on the traffic management formula.
   The time stamp of the recheck_after parameter is a standard ISO 8601 timestamp using the UTC time zone, e.g., 2009-12-31T23:42 Z.
   The time stamp is in the UTC time zone.
   The time stamp is at least 5 minutes after the request time.
   The time stamp indicates the start of a time period for which the weighting factor is not zero. For example, as mentioned above, if the current, and the next two 15-minute time periods are configured with a weighting factor of zero, the time stamp in the response should be at least 30-45 minutes in the future.
The weighting factors are configurable and are stored as a dedicated document in the key-value store. The default value for each time slot is 100.
The grace period within which a normal MTIS response should be returned is configurable and is stored in the key-value store. The default value is 3 hours.
The global disable flag and time stamp offset are configurable and are stored in the key-value store. The default value for the flag is false, and the default value for the time stamp offset is 60 minutes.

Accordingly, the media client is advantageously able to request pre-downloading (or pre-booking) of a particular media asset associated with content of interest, based on user preferences. The success of this request is determined, in part, by the traffic manage requirements at the time the request is made. For example, in a time period during the interactive media player system is (or is expected to be) subject to a high level of traffic (e.g. during or soon after transmission of a major sporting event), the probability of a pre-booking request being allowed in that time period may be reduced by reducing the weighting factor(s) for that time period. The pre-booking request may also be effectively blocked by setting the weighting factor(s) for that time period to zero. Contrastingly, at times of low usage, the probability of a pre-booking request being allowed in that time period may be increased by increasing the weighting factor(s) for that time period or may be effectively guaranteed by setting the weighting factor(s) to (or leaving them at) 100. Thus, the media selector is beneficially able to effectively manage the download traffic by only allowing a certain percentage of requests at a given time. If a request is rejected the client is given a time when the media asset may be requested again. Allowance or denial of a request can advantageously be based on pre-configured settings (e.g. pre-stored weighting factors) and/or live traffic and performance statistics.

In summary, a content delivery system in the form of an interactive media player system has been presented. In particular, different forms of content discovery have been shown which enable a user of the system to discover content in alternative ways:
drawers, which provide a way to push new content towards the user according to novelty, personal or social recommendation
a channel changer, which provides a way to find content according to broadcast schedules and availability
a category module, which provides content according to subject matter and user interests

Also provided is a Favourites module, which enables the user to bookmark and keep track of content across all these forms of discovery.

It will be appreciated that where the examples are shown in respect of television or video media content, aspects are also applicable to radio or audio content.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals and/or titles appearing in the claims are by way of illustration only and shall have no limiting effect on the scope of the claims.

The following GB Patent Application filed on 29 Apr. 2010 is hereby incorporated herein by reference:
UK Patent Application No. 1007195.9 (Agent reference: P34980 GB/PDC/DK) Any feature in this document may be combined with any feature described herein in any appropriate combination.

1. A system for providing users access to audio/visual content, the system comprising means for enabling a plurality of users to connect to the system, means for enabling users to browse available content items; means for receiving a message from at least one user connected to the system, and means for transmitting said message to at least one further user connected to the system.

2. The system according to claim 1, wherein the system is connectable to a communications network, such as the Internet, and wherein each of the users are connectable to the system via user terminal equipment connectable to said communications network, and preferably wherein the terminal equipment is in the form of at least one or more of the following devices: a personal computer; a laptop; a PDA; an Internet television; a tablet computing device; and a mobile telephone.

3. (canceled)

4. The system according to claim 1, wherein the means for enabling users to browse available content items includes a website accessible via the Internet.

5. The system according to claim 1, further comprising a signing in module, thereby to enable users to sign in to the system.

6. The system according to claim 1, further comprising means for connecting at least two users to one another thereby to form at least one user group, and preferably wherein the connecting means is adapted to connect a new user to one or more existing user groups, and preferably where the system further comprises means for enabling a user to connect to at least one existing user group.

7. (canceled)

8. (canceled)

9. The system according to claim 6, further comprising means for enabling a user to invite other users to sign in to the system.

10. The system according to claim 6, further comprising means for enabling a user to transmit a message to a particular user and/or to all the users within one or more user groups, and preferably further comprising means for enabling a user to broadcast a message to a plurality of users.

11. (canceled)

12. The system according to claim 1, wherein the receiving means is adapted to receive text-based messages, and preferably wherein the system comprises an instant messaging module, preferably in the form of MSN Messenger or Windows Live Messenger, which is adapted to handle the receipt and transmission of instant messages between users.

13. (canceled)

14. The system according to claim 1, further comprising a media player for enabling users to consume audio/visual content items.

15. The system according to claim 1, further comprising means for publishing information relating to a content item that has been consumed and/or accessed by a user to one or more other users.

16. The system according to claim 15, wherein the publishing means is adapted to publish information relating to a content item that is presently being played or consumed by a user to one or more other users.

17. The system according to claim 15, wherein said information is only made available to a restricted set of users, and preferably wherein said information is only made available to other users within a user's user group or groups, and preferably only to selected users within said group or groups.

18. (canceled)

19. The system according to claim 15, wherein said information includes the title of the content item, and preferably wherein said information provides an indication of a user's progress through said content item.

20. (canceled)

21. The system according to claim 1, further comprising means for transmitting, together with each user message, information relating a content item currently being accessed and/or consumed by that user.

22. The system according to claim 21, wherein the information includes a link to said content item.

23. The system according to claim 22, wherein the information includes an index to a user's present location within the content item.

24. The system according to claim 22, further comprising means for enabling one or more other users to access said content item being consumed by said user via said link, thereby to enable users to synchronise their consumption of a particular content item.

25. The system according to claim 1, further comprising means for enabling users to consume at least certain of the available content items in an on-demand fashion, and preferably further comprising means for streaming available content items to users, and preferably wherein the streaming means is adapted to stream on demand content and/or live-broadcast content.

26. (canceled)

27. The system according to claim 1, further comprising means for enabling a user to request access to a particular content item, and more preferably a particular location within said content item.

28. The system according to claim 1, further comprising means for enabling users to synchronise consumption of available content items.

29. A system for providing users access to audio/visual content, the system comprising means for enabling a plurality of users to connect to the system; (optionally) means for enabling users to browse available content items; and means for enabling connected users to synchronise consumption of available content items.

30. The system according to claim 28, further comprising means for enabling a connected user to send a synchronisation invitation to one or more other connected users to consume a particular content item.

31. The system according to claim 28, further comprising means for streaming a particular content item to at least two users at a time specified by those users, thereby to enable synchronised viewing of a particular content item.

32. The system according to claim 1, wherein the system further comprises a graphical user interface for displaying available content items, and means for generating a display window for displaying to a user one or more user groups to which the user is connected.

33. The system according to claim 32, wherein the generating means is adapted to display the window on all screens or pages of the graphical user interface, and preferably alongside a media player window, and preferably wherein the generating means is adapted generate a display which includes a list of users within a user's user group.

34. (canceled)

35. The system according to claim 33, wherein the generating means is adapted to generate a display which includes information relating to the content item currently being consumed by each user, and preferably wherein the information includes at least one or more of the following: the title of the content item; a programme identifier for the content item; a link to the content item; user comments relating to the content item; and a progress bar indicating a user's progress through the content item.

36. (canceled)

37. The system according to claim 35, wherein the generating means is adapted to generate a graphical indication, preferably in the form of a selectable button, which provides a link to a content item currently being consumed by user, and preferably wherein the selectable button provides an index to a user's present location within the content item.

38. (canceled)

39. The system according to claim 32, wherein the generating means is adapted to generate a display which includes messages transmitted by each user in the displayed user group.

40. A system for determining whether a content item should be provided to user equipment, the system comprising:
means for receiving, at a time and/or date, a download request from the user equipment to download the content item;
means for determining if said download request is to be allowed or denied in dependence on a traffic management requirement for said time and/or date at which the download request is received; and
means for providing, to said user equipment, information identifying a download location of said content item when it is determined that said download request is to be allowed.

41. The system as claimed in claim 40 further wherein said determining means is operable to determine a transmission time and/or date for the content item at which the content item is to be (or has been) transmitted, and preferably wherein said providing means is operable to provide, to said user equipment, information identifying a download location of said content item if said time and/or date at which the download request is received is within a predetermined time period (for example, a ‘grace’ period) prior to said transmission time and/or date.

42. (canceled)

43. The system as claimed in claim 41, wherein said predetermined time period is reconfigurable and, is (optionally) stored in at least one of a key-value store, a database, and/or the like, and is (optionally) configured with a default value (e.g. three hours).

44. The system as claimed in claim 41, wherein said providing means is operable to provide, to said user equipment, information identifying a download location of said content item if said time and/or date at which the download request is received is at or after said transmission time and/or date.

45. The system as claimed in claim 41 further comprising means for receiving a request to play the content item from the user equipment, and means for issuing a licence for playing the content item, to the user equipment, if said time and/or date at which the request to play the content item is received is after (for example a predetermined period such as a duration of the content item after) said transmission time and/or date.

46. The system as claimed in claim 40 wherein said providing means is operable to provide information indicating that said download request has been denied when it is determined that said download request is to be denied, and preferably wherein said information indicating that said download request has been denied comprises an indicator that the download request has been denied as the result of limited bandwidth availability.

47. (canceled)

48. The system as claimed in claim 46 wherein said information indicating that said download request has been denied comprises information indicating a time and/or date for the user equipment to retry requesting download of said content item.

49. The system as claimed in claim 48 wherein the information indicating a time and/or date for the user equipment to retry requesting download of said content item comprises a time stamp (for example, an ISO 8601 timestanmp).

50. The system as claimed in claim 49 wherein the time stamp indicates a standardised time and/or date (for example, a standardised time and/or date based on Universal Coordinated Time (UTC)).

51. The system as claimed in claim 48, wherein the time and/or date for the user equipment to retry requesting download of said content item is at a pre-determined minimum time period (or time ‘offset’) after the time and/or date of the download request.

52. The system as claimed in claim 51 wherein the pre-determined minimum time period is re-configurable, is (optionally) stored in at least one of a key-value store, a database, and/or the like, is (optionally) configured with a default value (e.g. 60 minutes), and is (optionally) limited to a minimum value (e.g. 5 minutes).

53. The system as claimed in claim 48 wherein the time and/or date for the user equipment to retry requesting download of said content item is a time at which download is potentially allowable based on the traffic management requirement for the time and/or date for the user equipment to retry requesting download.

54. The system as claimed in claim 40 wherein said traffic management requirement is determined for a predetermined granularity period including said time and/or date at which said download request is received, and preferably wherein said predetermined granularity period remains substantially the same period (e.g. 15 minutes) regardless of the time and/or date at which said download request is received, and preferably wherein said predetermined granularity period varies (e.g. between 5 minutes and 30 minutes) in dependence on the time and/or date at which said download request is received.

55. (canceled)

56. (canceled)

57. The system as claimed in claim 40 wherein said traffic management requirement for said time and/or date is represented by a weighting factor for the time and/or date at which the download request is received.

58. The system as claimed in claim 57 wherein said weighting factors for various times and/or dates are stored in at least one of a dedicated document, a value in a key-value store, a database, and/or the like, and preferably wherein said weighting factors for various times and/or dates are calculated using a predetermined algorithm for determining them in dependence on demand at a particular time and/or date to which the respective weighting factor relates.

59. (canceled)

60. The system as claimed in claim 57 wherein said determining means is operable to determine that said download request should be denied if said weighting factor is equal to a predetermined number (for example zero, a number greater than 100, any number not in a predetermined range representing a traffic management requirement at which said download is potentially allowable, or the like).

61. The system as claimed in claim 57 wherein said determining means is operable: to generate a random (or pseudo-random) number (for example, between 1 and 100); to determine that said download request should be allowed if said random (or pseudo-random) number does not exceed said weighting factor; and to determine that said download request should be denied if said random (or pseudo-random) number exceeds said weighting factor.

62. The system as claimed in claim 57 wherein said weighting factor comprises a percentage value, which value (optionally) indicates a likelihood that a download request will succeed.

63. The system as claimed in claim 40 wherein said determining means is operable to determine if said download request is to be allowed or denied based on a traffic management formula.

64. The system as claimed in claim 40 wherein said determining means is operable to determine if the download request is valid or invalid, and wherein said providing means is operable to provide information to the user equipment indicating that an error condition has arisen if said download request is determined to be invalid.

65. The system as claimed in any claim 40 wherein said determining means is operable to determine if the requested content item is available or unavailable, and wherein said providing means is operable to provide information to the user equipment indicating that an error condition has arisen if the requested content item is determined to be unavailable.

66. A method of determining whether a content item should be provided to user equipment, the method comprising: receiving, at a time and/or date, a download request from the user equipment to download the content item; determining if said download request is to be allowed or denied in dependence on a traffic management requirement for said time and/or date at which the download request is received; and providing, to said user equipment, information identifying a download location of said content item when it is determined that said download request is to be allowed.

67.-69. (canceled)
